(19) United States
(12) Patent Application Publication
(10) Pub. No.: US 2012/0002410 A1
(43) Pub. Date: Jan. 5, 2012

(54) LIGHT SOURCE, LIGHT SOURCE DEVICE AND DISPLAY DEVICE

(75) Inventor: Ryuhei Kishimoto, Osaka-shi (JP)

(73) Assignee: SHARP KABUSHIKI KAISHA, Osaka-shi, Osaka (JP)

(21) Appl. No.: 13/255,971

(22) PCT Filed: Dec. 24, 2009
(86) PCT No.: PCT/JP2009/071440

§ 371 Date: Sep. 15, 2011

(30) Foreign Application Priority Data
Mar. 13, 2009 (JP) 2009-060894

(51) Int. Cl. F21S 2/00

(52) U.S. Cl. 362/224; 362/223

(57) ABSTRACT

A light source capable of emitting light of which intensity is uniform throughout its length. A light source (1a) includes a fluorescent lamp (2) including a tube body (21) having a substantially linear shape and discharging electrodes (221, 222) disposed at both ends in an axial direction of the tube body, and a light guiding member (11a) having a substantially transparent color, a length in an axial direction shorter than a length in the axial direction of the tube body, and a linear shape, wherein the light guiding member is attached on an outer surface of the tube body at a section closer to one end in the axial direction of the tube body of the fluorescent lamp such that one end of the light guiding member is disposed close to the discharging electrode 222 at the one end of the fluorescent lamp.

### TECHNICAL FIELD

The present invention relates to a light source, a light source device and a display device, and specifically relates to a light source that includes a discharge lamp, a light source device including the light source, and a display device including the light source device.

### BACKGROUND ART

Some liquid crystal display devices have a configuration that includes a transmissive or transflective liquid crystal display panel and a light source device (also referred to as a “backlight unit”), where the liquid crystal display panel is disposed in front of the light source device. Those liquid crystal display devices are arranged such that light is emitted from the light source devices, with which the back surfaces of the liquid crystal display panels are illuminated, and the emitted light passes through the liquid crystal display panels, whereby an image is displayed visible on the front surfaces of the liquid crystal display panels.

FIG. 47 is an exploded perspective view showing a schematic configuration of a conventional light source device for a display device. A light source device 9 includes a chassis 91, a plurality of light sources 92 capable of emitting light with a given wavelength, optical sheets 93 capable of controlling the properties of light transmitted therethrough, a light source driving circuit board 94 and other predetermined members as shown in FIG. 47. The light sources 92 are arranged substantially parallel to each other in front of the chassis 91. The optical sheets 93 are disposed in front of the light sources 92. The light source driving circuit board 94 is disposed behind the chassis 91. Having the configuration described above, the light source device 9 is capable of controlling the properties of the light emitted from the light sources 92 with the use of the optical sheets 93, and emitting the light of which the properties are controlled to the outside.

Fluorescent lamps (e.g., cold cathode fluorescent tubes and hot cathode fluorescent tubes) are used for the light sources 92. A generally-used fluorescent tube includes a tube body preferably made from glass, and discharging electrodes provided at both ends in an axial direction of the tube body. Mercury is sealed in the tube body, by which a layer of fluorescent material is formed on an inner surface of the tube body. When fluorescent lamps are used for the light source 9, inverter circuits that generate high-tension alternating-current voltages are incorporated in the light source driving circuit board 94. The discharging electrodes at one ends of the fluorescent lamps are electrically connected to the light source driving circuit board 94, and the discharging electrodes at the other ends are grounded.

If intensity distribution in a plane direction of light emitted from a light source device is nonuniform, luminance unevenness is produced in an image a liquid crystal display panel displays, which could lower display quality of the liquid crystal display device. Therefore, in order that the liquid crystal display device may display a high quality image, the intensity distribution in the plane direction of the light emitted from the light source device needs to be uniform. For this purpose, fluorescent lamps that define light sources need to emit light of which intensity is almost uniform throughout the length of tube bodies of the fluorescent lamps. However, sometimes it is hard for the fluorescent lamps to emit light of which intensity is almost uniform throughout the length of the tube bodies.

The light intensity of the fluorescent lamps depends on the amounts of currents passing through the tube bodies. In order that the fluorescent lamps emit light of which intensity is almost uniform throughout the length of the tube bodies, the amounts of the currents passing through the tube bodies need to be almost uniform throughout the length of the tube bodies. However, a parasitic capacitance is formed between the fluorescent lamps and a chassis of the light source device if the chassis is made from a conductor such as a metal plate, which causes leaks of the currents passing through the tube bodies. The current leaks change the amounts of the currents passing through the tube bodies along axial directions of the tube bodies, and thus the amounts of the currents passing through the tube bodies are made nonuniform. Consequently, the light intensity of the fluorescent lamps is made nonuniform along the axial directions of the tube bodies.

In the fluorescent lamps having the configuration that discharging electrodes at one ends of the fluorescent lamps are connected to a light source driving circuit board and alternating-current voltages are applied thereto while discharging electrodes at the other ends are grounded, the amounts of the currents passing through the tube bodies become smaller by degrees from a section closer to the discharging electrodes connected to the light source driving circuit board to a section closer to the grounded discharging electrodes. Accordingly, the light intensity of the fluorescent lamps also becomes smaller by degrees from the section closer to the discharging electrodes connected to the light source driving circuit board to the section closer to the grounded discharging electrodes. When all the fluorescent lamps incorporated in the light source device emit light of which the intensity is nonuniform as above, the image the display device displays has luminance that is higher on one side and lower on the other side as a whole image.

In order to make the light intensity of each fluorescent lamp uniform along the axial direction, alternating-current voltages in opposite phases are preferably applied to the discharging electrodes at both the ends of each fluorescent lamp. Thus, the amounts of the currents passing through both end sections of each tube body are made almost equal, which can reduce the nonuniformity in the amounts of the currents passing through each tube body as a whole. However, two light source driving circuit boards are required to generate the alternating-current voltages in opposite phases. In addition, the two light source driving circuit boards need to be driven in synchronization with each other. Thus, the number of parts required for the light source device increases and the configuration of the light source device becomes complicated, which causes an increase in cost.

If a current leak occurs, the current passing through a center section in the axial direction of each tube body becomes smaller than the currents passing through both the end sections of each tube body (the currents passing closer to the discharging electrodes). Accordingly, the light amount at the center section in the axial direction of each tube body becomes smaller than the light amounts at both the end sections of each tube body. Thus, even if the alternating-current voltages in opposite phases are applied to the discharging electrodes at both the ends of each fluorescent lamp, the nonuniformity in the light amounts cannot be always eliminated.

The configuration of such a fluorescent lamp is described in PTL 1, for example, of which a discharging electrode at one end is connected to a light source driving circuit board and an alternating-current voltage is applied thereto while a discharging electrode at the other end is grounded, by which the light intensity of the fluorescent lamp can be made uniform. To be specific, described in PTL 1 is the configuration to eliminate the nonuniformity in the amount of the current passing through the tube body by lowering the impedance of the grounded discharging electrode and making the current easily reach the grounded discharging electrode to reduce a current leak. For this purpose, the fluorescent lamp has a configuration that the grounded discharging electrode has a larger area than the discharging electrode at the other end to which the alternating-current voltage is applied, and the tube body has a tapered shape such that the internal diameter of the tube body closer to the grounded discharging electrode is made larger than the internal diameter of the tube body closer to the discharging electrode at the other end to which the alternating-current voltage is applied.

However, because the discharging electrodes at the high voltage side and at the low voltage side of the fluorescent lamp having this configuration are required to be different in size and shape, the kind of parts increases, which causes an increase in cost. In addition, the tube body needs to be shaped into the tapered shape, which is complicated compared with a simple cylindrical shape, and could cause an increase in cost. Thus, the price of the fluorescent lamp rises, and the prices of alight source device and a display device including this fluorescent lamp could accordingly rise.

### CITATION LIST

### Patent Literature

PTL 1: JP2008-34112

### SUMMARY OF INVENTION

### Technical Problem

In order to overcome the problems described above, one prefer red embodiment of the present invention provides a light source that is capable of emitting light of which intensity is uniform along an axial direction substantially throughout the length of the light source, or a light source that is capable of minimizing nonuniformity in light intensity at each section in an axial direction of the light source. Another preferred embodiment of the present invention provides a light source device that is capable of making intensity distribution in a plane direction of light emitted therefrom uniform, or a light source device that is capable of minimizing nonuniformity in intensity distribution in a plane direction of light emitted therefrom. Another preferred embodiment of the present invention provides a display device that is capable of preventing or minimizing occurrence of luminance unevenness to be produced in an image the display device displays.

### Solution to Problem

Preferred embodiments of the present invention provide a light source that includes a discharge lamp including a tube body having one of a substantially linear shape and a substantially U shape and discharging electrodes disposed at both ends in an axial direction of the tube body, and a light guiding member that has a substantially transparent color, a length in an axial direction that is shorter than a length in the axial direction of the tube body of the discharge lamp, and a linear shape, wherein the light guiding member is attached on an outer surface of the tube body of the discharge lamp at a section closer to one end in the axial direction of the tube body of the discharge lamp.

It is preferable that the light guiding member has one of a substantially round shape in cross section and a substantially oval shape in cross section, and includes a through-hole inside along the axial direction, wherein the light guiding member is attached on the outer surface of the tube body of the discharge lamp such that the tube body of the discharge lamp is inserted in the through-hole of the light guiding member.

It is also preferable that the light guiding member has one of a substantially round shape in cross section and a substantially oval shape in cross section, and includes a groove on its lateral side along the axial direction, wherein the light guiding member is attached on the outer surface of the tube body of the discharge lamp such that the tube body of the discharge lamp is inserted in the groove of the light guiding member.

It is preferable that the light guiding member has a tapered shape such that surface areas per unit length of the light guiding member become larger by degrees from one end in the axial direction to the other end, wherein the light guiding member is attached on the outer surface of the tube body of the discharge lamp such that the end of the light guiding member that has the larger surface area per unit length is disposed close to the discharging electrode disposed at the one end of the discharge lamp.

It is preferable that the length in the axial direction of the light guiding member is substantially half the length in the axial direction of the tube body of the discharge lamp, wherein the light guiding member is attached on the outer surface at a section from the one end of the tube body of the discharge lamp to a substantial center in the axial direction of the tube body of the discharge lamp.

It is preferable that the discharge lamp is a fluorescent lamp.

In another aspect of the present invention, alight source includes a discharge lamp including a tube body having a substantially linear shape and discharging electrodes disposed at both ends in an axial direction of the tube body, and a light guiding member that has a substantially transparent color, a length in an axial direction that is substantially same as a length in the axial direction of the tube body of the discharge lamp, and a tapered shape such that surface areas per unit length of the light guiding member become larger by degrees from one end in the axial direction to the other end, wherein the light guiding member is attached on an outer surface of the tube body of the discharge lamp throughout the substantial length of the tube body of the discharge lamp.

It is preferable that the light guiding member has one of a substantially round shape in cross section and a substantially oval shape in cross section, and includes a through-hole inside along the axial direction, wherein the light guiding member is attached on the outer surface of the tube body of the discharge lamp such that the tube body of the discharge lamp is inserted in the through-hole of the light guiding member.

It is also preferable that the light guiding member has one of a substantially round shape in cross section and a substantially oval shape in cross section, and includes a groove on its lateral side along the axial direction, wherein the light guiding member is attached on the outer surface of the tube body of the discharge lamp such that the tube body of the discharge lamp is inserted in the groove of the light guiding member.

It is preferable that the discharge lamp is a fluorescent lamp.

In another aspect of the present invention, alight source includes two discharge lamps, each of which includes a tube body having a substantially linear shape and discharging electrodes disposed at both ends in an axial direction of each tube body, and two light guiding members, each of which has a substantially transparent color, a length in an axial direction that is shorter than a length in the axial direction of the tube body of each discharge lamp, and a linear shape, wherein the discharging electrodes at one ends of the two discharge lamps are electrically connected to each other, wherein the light guiding members are attached on outer surfaces of the tube bodies of the discharge lamps at sections closer to the electrically-connected discharging electrodes at the one ends of the tube bodies of the discharge lamps.

It is preferable that each of the light guiding members has one of a substantially round shape in cross section and a substantially oval shape in cross section, and includes a through-hole inside along the axial direction, wherein the light guiding members are attached on the outer surfaces of the tube bodies of the discharge lamps such that the tube bodies of the discharge lamps are inserted in the through-holes of the light guiding members.

It is also preferable that each of the light guiding members has one of a substantially round shape in cross section and a substantially oval shape in cross section, and includes a groove on its lateral side along the axial direction, wherein the light guiding members are attached on the outer surfaces of the tube bodies of the discharge lamps such that the tube bodies of the discharge lamps are inserted in the grooves of the light guiding members.

It is preferable that each of the light guiding members has a tapered shape such that surface areas per unit length of each light guiding member become larger by degrees from one end in the axial direction to the other end, wherein the light guiding members are attached on the outer surfaces of the tube bodies of the discharge lamps such that the ends of the light guiding members that have the larger surface areas per unit length are disposed close to the electrically-connected discharging electrodes.

It is preferable that the length in the axial direction of each of the light guiding members is substantially half the length in the axial direction of each of the tube bodies of the discharge lamps, wherein the light guiding members are attached on the outer surfaces at sections from the one ends of the tube bodies of the discharge lamps where the discharging electrodes are electrically connected to each other to substantial centers in the axial directions of the tube bodies of the discharge lamps.

It is preferable that the discharge lamps are fluorescent lamps.

In another aspect of the present invention, alight source includes two discharge lamps, each of which includes a tube body having a substantially linear shape, and discharging electrodes disposed at both ends in an axial direction of each tube body, and two light guiding members, each of which has a substantially transparent color, a length in an axial direction that is substantially same as a length in the axial direction of the tube body of each discharge lamp, and a tapered shape such that surface areas per unit length of each light guiding member become larger by degrees from one end in the axial direction to the other end, wherein the discharging electrodes at one ends of the two discharge lamps are electrically connected to each other, wherein the light guiding members are attached to the tube bodies of the discharge lamps such that the ends of the light guiding members that have the larger surface areas per unit length are disposed close to the electrically-connected discharging electrodes.

It is preferable that each of the light guiding members has one of a substantially round shape in cross section and a substantially oval shape in cross section, and includes a through-hole inside along the axial direction, wherein the light guiding members are attached on the outer surfaces of the tube bodies of the discharge lamps such that the tube bodies of the discharge lamps are inserted in the through-holes of the light guiding members.

It is also preferable that each of the light guiding members has one of a substantially round shape in cross section and a substantially oval shape in cross section, and includes a groove on its lateral side along the axial direction, wherein the light guiding members are attached on the outer surfaces of the tube bodies of the discharge lamps such that the tube bodies of the discharge lamps are inserted in the grooves of the light guiding members.

It is preferable that the discharge lamps are fluorescent lamps.

In another aspect of the present invention, alight source includes a discharge lamp including a tube body having a substantially linear shape and discharging electrodes disposed at both ends in an axial direction of the tube body, and a light guiding member that has a substantially transparent color, a length in an axial direction that is shorter than a length in the axial direction of the tube body of the discharge lamp, and a linear shape, wherein the light guiding member is attached on an outer surface of the tube body of the discharge lamp at a center section in the axial direction of the tube body of the discharge lamp.

It is preferable that the light guiding member has one of a substantially round shape in cross section and a substantially oval shape in cross section, and includes a through-hole inside along the axial direction, wherein the light guiding member is attached on the outer surface of the tube body of the discharge lamp such that the tube body of the discharge lamp is inserted in the through-hole of the light guiding member.

It is also preferable that the light guiding member has one of a substantially round shape in cross section and a substantially oval shape in cross section, and includes a groove on its lateral side along the axial direction, wherein the light guiding member is attached on the outer surface of the tube body of the discharge lamp such that the tube body of the discharge lamp is inserted in the groove of the light guiding member.

It is preferable that the light guiding member has a tapered shape such that surface areas per unit length of the light guiding member become larger by degrees from both the ends to the center in the axial direction.

It is preferable that the discharge lamp is a fluorescent lamp.

In another aspect of the present invention, alight source includes a discharge lamp including a tube body having a substantially U shape and discharging electrodes disposed at both ends in an axial direction of the tube body, and two light guiding members, each of which has a substantially transparent color, a length in an axial direction that is half or less than half a length in the axial direction of the tube body of the discharge lamp, and a linear shape, wherein the light guiding members are attached on an outer surface of the tube body of the discharge lamp at sections closer to a substantially U-shaped section of the tube body of the discharge lamp.

It is preferable that each of the light guiding members has one of a substantially round shape in cross section and a substantially oval shape in cross section, and includes a through-hole inside along the axial direction, wherein the light guiding members are attached on the outer surface of the tube body of the discharge lamp such that the tube body of the discharge lamp is inserted in the through-holes of the light guiding members.

It is also preferable that each of the light guiding members has one of a substantially round shape in cross section and a substantially oval shape in cross section, and includes a groove on its lateral side along the axial direction, wherein the light guiding members are attached on the outer surface of the tube body of the discharge lamp such that the tube body of the discharge lamp is inserted in the grooves of the light guiding members.

It is preferable that each of the light guiding members has a tapered shape such that surface areas per unit length of each light guiding member become larger by degrees from one end in the axial direction to the other end, wherein the light guiding members are attached to the tube body of the discharge lamp such that the ends of the light guiding members that have the larger surface areas per unit length are disposed close to the substantially U-shaped section of the tube body of the discharge lamp.

It is preferable that the length in the axial direction of each of the light guiding members is substantially half the length in the axial direction of the tube body of the discharge lamp, wherein the light guiding members are attached on the outer surface at sections from the ends of the tube body of the discharge lamp to the substantially U-shaped section of the tube body of the discharge lamp.

It is preferable that the discharge lamp is a fluorescent lamp.

Yet, in another aspect of the present invention, a light source device includes the light source and a light source driving circuit board arranged to generate an alternating-current voltage, wherein the alternating-current voltage generated by the light source driving circuit board is applied to the discharging electrode at the one end of the discharge lamp, the one end being closer to a section of the tube body where the light guiding member is attached, whereby the light source emits light.

It is preferable that the discharging electrode at the other end of the discharge lamp is grounded, the other end being closer to a section of the tube body where no light guiding member is attached.

Yet, in another aspect of the present invention, a light source device includes the light source and a light source driving circuit board arranged to generate an alternating-current voltage, wherein the alternating-current voltage generated by the light source driving circuit board is applied to the discharging electrode at the one end of the discharge lamp, the one end being closer to the end of the light guiding member that has the smaller surface area per unit length, whereby the light source emits light.

It is preferable that the discharging electrode at the other end of the discharge lamp is grounded, the other end being closer to the end of the light guiding member that has the larger surface area per unit length.

In another aspect of the present invention, alight source device includes the light source and a light source driving circuit board arranged to generate alternating-current voltages in opposite phases, wherein the alternating-current voltages in opposite phases generated by the light source driving circuit board are applied to the discharging electrodes other than the electrically-connected discharging electrodes.

In another aspect of the present invention, alight source device includes the light source and a light source driving circuit board arranged to generate alternating-current voltages in opposite phases, wherein the alternating-current voltages in opposite phases generated by the light source driving circuit board are applied to the discharging electrodes of the light source, whereby the light source emits light.

Yet, in another aspect of the present invention, a display device includes the light source device and anon-self-emissive flat panel display disposed in front of the light source device, wherein the light source device emits light with which a back surface of the flat panel display is illuminated, whereby an image is displayed on a front surface of the flat panel display.

It is preferable that the flat panel display is a liquid crystal display panel.

### Advantageous Effects of Invention

According to the preferred embodiments of the present invention, the attachment of the light guiding member on the outer surface of the tube body of the discharge lamp can increase an area of the light source that is capable of emitting light to the outside (hereinafter, referred to as a “light emission area”. Thus, even if the amount of current passing through the tube body is made nonuniform, the attachment of the light guiding member to a section of the tube body where the current passing through is small can increase a light emission area in the section, completing the amount of light emitted to the outside. Therefore, the nonuniformity in the light amount that occurs in the axial direction of the tube body can be minimized or eliminated.

In using the light source while the alternating-current voltage is applied to the discharging electrode at the one end of the discharge lamp and the discharging electrode at the other end is grounded, the light amount of the tube body becomes larger at a section closer to the discharging electrode to which the alternating-current voltage is applied while the light amount becomes smaller at a section closer to the grounded discharging electrode, which especially makes the light amount of the tube body of the discharge lamp nonuniform. This is because if a leak occurs in the current passing through the tube body of the discharge lamp, the current passing closer to the discharging electrode to which the alternating-current voltage is applied becomes larger while the current passing closer to the grounded discharging electrode becomes smaller. Thus, in order to complete the amount of light emitted to the outside, the light emission area is increased by the attachment of the light guiding member on the outer surface at the section closer to the grounded discharging electrode. Therefore, the nonuniformity in the amount of light emitted from the light source can be minimized or eliminated.

In addition, the attachment of the light guiding member, of which the surface areas per unit length become larger by degrees from the one end to the other end, on the outer surface of the tube body can easily make the amount of the light that the light source emits to the outside uniform throughout the length of the tube body of the discharge lamp. The reason for this is as follows. If a leak occurs in the current passing through the tube body of the discharge lamp, the current becomes smaller by degrees from the discharging electrode to which the alternating-current voltage is applied to the grounded discharging electrode. Accordingly, the light amount becomes smaller by degrees from the discharging electrode to which the alternating-current voltage is applied to the grounded discharging electrode. Hence, the light guiding member, of which the surface areas per unit length become larger by degrees from the discharging electrode to which the alternating-current voltage is applied to the grounded discharging electrode, is attached on the outer surface of the tube body such that a section of the light guiding member of which the surface area per unit length is smaller (i.e., a section of the light guiding member which gives a smaller increase of the light emission area) corresponds to a section of the tube body where the light amount of the discharge lamp is larger, while a section of the light guiding member of which the surface area per unit length is larger (i.e., a section of the light guiding member which gives a larger increase of the light emission area) corresponds to a section of the tube body where the light amount of the discharge lamp is smaller. Therefore, the attachment of the light guiding member having the above-described configuration can easily make the amount of the light that the light source emits to the outside uniform throughout the length of the tube body of the discharge lamp.

In addition, in the configuration that the alternating-current voltages in opposite phases are applied to the discharging electrodes at both the ends of the discharge lamp, because the currents passing through both the end sections of the tube body become larger while the current passing through the center section in the axial direction of the tube body becomes smaller if a current leak occurs, the light amount accordingly becomes smaller at the center section of the tube body, which makes the light amount of the discharge lamp nonuniform. The attachment of the light guiding member on the outer surface at the center section of the tube body of the discharge lamp (at the substantially U-shaped section of the tube body of the discharge lamp if the tube body has the U shape) can increase the light emission area, allowing the amount of light emitted to the outside to be completed. Therefore, the nonuniformity in the amount of light emitted from the light source can be minimized or eliminated.

In this configuration, the attachment of the light guiding member, of which the surface areas per unit length become larger by degrees from both the ends to the center in the axial direction, on the outer surface of the tube body can easily make the amount of the light that the light source emits to the outside uniform throughout the length of the tube body of the discharge lamp for the reason described above.

When the light source has the configuration that the discharging electrodes at one ends of the two discharge lamps are electrically connected to each other, and the alternating-current voltages in opposite phases are applied to the discharging electrodes other than the electrically-connected discharging electrodes, the light amounts become smaller at sections closer to the electrically-connected discharging electrodes while larger at sections closer to the discharging electrodes to which the alternating-current voltages in opposite phases are applied. The attachment of the light guiding members on the outer surfaces at the sections closer to the electrically-connected discharging electrodes can complete the light amounts at the sections of the discharge lamps to which the light guiding members are attached. Therefore, the nonuniformity in the amount of light emitted from the light source can be minimized or eliminated.

According to some of the preferred embodiments of the present invention, because the light source device has the configuration that the light guiding member is attached on the outer surface at a section closer to the grounded discharging electrode of the discharge lamp of the light source, the amount of light at the section closer to the grounded discharging electrode can be completed. Thus, a difference between the amount of light emitted to the outside at the section closer to the grounded discharging electrode and the amount of light emitted to the outside at the section closer to the discharging electrode to which the alternating-current voltage is applied can be reduced, or eliminated. Therefore, the light source device ac cording to the preferred embodiments of the present invention can make intensity distribution in a plane direction of the light emitted therefrom uniform as a whole.

Because the light source device according to the preferred embodiments of the present invention has the configuration that the alternating-current voltage is applied to the discharging electrode at the one end of the discharge lamp and the discharging electrode at the other end is grounded, the number of parts required for the light source device can be reduced and the configuration of the light source device can be simplified in comparison with a light source device having a configuration that alternating-current voltages in opposite phases are applied to discharging electrodes at both ends of a light source. In other words, while two light source driving circuit boards are required to generate the alternating-current voltages in opposite phases and to be driven in synchronization with each other in the configuration that the alternating-current voltages in opposite phases are applied to the discharging electrodes at both the ends of the light source, required in the configuration of the light source device according to the preferred embodiments of the present invention is only one light source driving circuit board, where no circuit for synchronized driving is required.

According to some of the preferred embodiments of the present invention, the light source device has the configuration that the light guiding member is attached on the outer surface at the center section in the axial direction of the tube body of the discharge lamp (at the substantially U-shaped section of the tube body of the discharge lamp if the tube body has the U shape) and the alternating-current voltages in opposite phases are applied to the discharging electrodes at both the ends of the discharge lamp. With this configuration, the amount of light emitted to the outside can be completed by the light guiding member while the current passing through the center section in the axial direction of the tube body of the discharge lamp is smaller, which allows the amount of the light emitted to the outside to be uniform throughout the length of the tube body of the discharge lamp. Therefore, the light source device according to the preferred embodiments of the present invention can make intensity distribution in a plane direction of the light emitted therefrom uniform as a whole.

The light source used in the light source device according to some of the preferred embodiments of the present invention has the configuration that the discharging electrodes at the one ends of the two discharge lamps are electrically connected to each other and the light guiding members are attached on the outer surfaces at sections closer to the one ends of the tube bodies of the discharge lamps where the discharging electrodes are electrically connected to each other, where the alternating-current voltages in opposite phases generated by the light source driving circuit board are applied to the discharging electrodes other than the electrically-connected discharging electrodes. With this configuration, while the currents passing through the tube bodies of the discharge lamps and the light amounts become smaller at the sections closer to the electrically-connected discharging electrodes, the amounts of light emitted to the outside can be completed by the light guiding members, and is thus made uniform throughout the length of the tube body of the discharge lamp. Therefore, the light source device according to the preferred embodiments of the present invention can make intensity distribution in a plane direction of the light emitted therefrom uniform as a whole. Therefore, the light source device according to the preferred embodiments of the present invention can make intensity distribution in a plane direction of the light emitted therefrom uniform as a whole.

A generally-used fluorescent lamp can be used as the discharge lamp of the light source according to the preferred embodiments of the present invention. The light guiding member has the simple shape, and can be made from an easily-available low-cost material (e.g., glass and various kinds of resins). Thus, the light source can be produced at low cost, and a rise in price of the light source device ac cording to the preferred embodiments of the present invention can be prevented or minimized in comparison with a discharge lamp including a tube body having a special shape.

According to the preferred embodiment of the present invention, the display device can display a high quality image without luminance unevenness.

### BRIEF DESCRIPTION OF DRAWINGS

FIG. 1 is an exploded perspective view showing a schematic configuration of a light source according to a first preferred embodiment of the present invention.

FIG. 2 is an external perspective view showing the schematic configuration of the light source according to the first preferred embodiment of the present invention.

FIG. 3 is an exploded perspective view showing a schematic configuration of a light source device according to a first preferred embodiment of the present invention.

FIGS. 4A and 4B are external perspective views showing a schematic configuration of a light guiding member used for a light source according to a second preferred embodiment of the present invention, where shown in FIG. 4A is the light guiding member seen from the side of its one end in an axial direction, and shown in FIG. 4B is the light guiding member seen from the side of the other end.

FIG. 5 is an external perspective view showing a schematic configuration of the light source according to the second preferred embodiment of the present invention.

FIGS. 6A and 6B are external perspective views showing a schematic configuration of a light guiding member used for a light source according to a third preferred embodiment of the present invention, where shown in FIG. 6A is the light guiding member seen from the side of its one end in an axial direction, and shown in FIG. 6B is the light guiding member seen from the side of the other end.

FIG. 7 is an external perspective view showing a schematic configuration of the light source according to the third preferred embodiment of the present invention.

FIG. 8 is an exploded perspective view showing a schematic configuration of a light source device according to a second preferred embodiment of the present invention.

FIG. 9 is an exploded perspective view showing a schematic configuration of a light source according to a fourth preferred embodiment of the present invention, and a cross-sectional view showing a cross section structure of a light guiding member.

FIG. 10 is an external perspective view showing the schematic configuration of the light source according to the fourth preferred embodiment of the present invention.

FIG. 11 is a cross-sectional view schematically showing a cross section structure of alight source device according to a third preferred embodiment of the present invention.

FIGS. 12A, 12B and 12C are views showing a schematic configuration of a light guiding member used for a light source according to a fifth preferred embodiment of the present invention, where FIG. 12A is an external perspective view showing the light guiding member seen from the side of its one end in an axial direction, FIG. 12B is an external perspective view showing the light guiding member seen from the side of the other end, and FIG. 12C is a cross-sectional view of the light guiding member.

FIG. 13 is an external perspective view showing a schematic configuration of the light source according to the fifth preferred embodiment of the present invention.

FIGS. 14A, 14B and 14C are views showing a schematic configuration of a light guiding member used for a light source according to a sixth preferred embodiment of the present invention, where FIG. 14A is an external perspective view showing the light guiding member seen from the side of its one end in an axial direction, FIG. 14B is an external perspective view showing the light guiding member seen from the side of the other end, and FIG. 14C is a cross-sectional view of the light guiding member.

FIG. 15 is an external perspective view showing a schematic configuration of the light source according to the sixth preferred embodiment of the present invention.

FIG. 16 is an exploded perspective view showing the schematic configuration of the light source according to the first preferred embodiment of the present invention, where the light guiding member consists of two components.

FIGS. 17A and 17B are external perspective views showing a schematic configuration of a light guiding member used for a light source according to a seventh preferred embodiment of the present invention, where shown in FIG. 17A is the light guiding member seen from one lateral side around the light guiding member, and shown in FIG. 17B is the light guiding member seen from the opposite lateral side.

FIG. 18 is an external perspective view showing a schematic configuration of the light source according to the seventh preferred embodiment of the present invention.

FIGS. 19A and 19B are external perspective views showing a schematic configuration of a light guiding member used for a light source according to an eighth preferred embodiment of the present invention, where shown in FIG. 19A is the light guiding member seen from the side of its one end in an axial direction, and shown in FIG. 19B is the light guiding member seen from the side of the other end.

FIG. 20 is an external perspective view showing a schematic configuration of the light source according to the eighth preferred embodiment of the present invention.

FIGS. 21A and 21B are external perspective views showing a schematic configuration of a light guiding member used for a light source according to a ninth preferred embodiment of the present invention, where shown in FIG. 21A is the light guiding member seen from the side of its one end in an axial direction, and shown in FIG. 21B is the light guiding member seen from the side of the other end.

FIG. 22 is an external perspective view showing a schematic configuration of the light source according to the ninth preferred embodiment of the present invention.

FIGS. 23A, 23B and 23C are views showing a schematic configuration of a light guiding member used for a light source according to a tenth preferred embodiment of the present invention, where FIG. 23A is an external perspective view showing the light guiding member seen from the side of its one end in an axial direction, FIG. 23B is an external perspective view showing the light guiding member seen from the side of the other end, and FIG. 23C is a cross-sectional view of the light guiding member.

FIG. 24 is an external perspective view showing a schematic configuration of the light source according to the tenth preferred embodiment of the present invention.

FIGS. 25A, 25B and 25C are views showing a schematic configuration of a light guiding member used for a light source according to an eleventh preferred embodiment of the present invention, where FIG. 25A is an external perspective view showing the light guiding member seen from the side of its one end in an axial direction, FIG. 25B is an external perspective view showing the light guiding member seen from the side of the other end, and FIG. 25C is a cross-sectional view of the light guiding member.

FIG. 26 is an external perspective view showing a schematic configuration of the light source according to the eleventh preferred embodiment of the present invention.

FIGS. 27A, 27B and 27C are views showing a schematic configuration of a light guiding member used for a light source according to a twelfth preferred embodiment of the present invention, where FIG. 27A is an external perspective view showing the light guiding member seen from the side of its one end in an axial direction, FIG. 27B is an external perspective view showing the light guiding member seen from the side of the other end, and FIG. 27C is a cross-sectional view of the light guiding member.

FIG. 28 is an external perspective view showing a schematic configuration of the light source according to the twelfth preferred embodiment of the present invention.

FIG. 29 is an external perspective view showing a schematic configuration of a light source including a fluorescent lamp including a tube body that has a substantially U shape.

FIG. 30 is an external perspective view showing a schematic configuration of a light source including a fluorescent lamp including a tube body that has a substantially U shape.

FIG. 31 is an exploded perspective view showing a schematic configuration of a light source device including the light sources including the fluorescent lamps that have the tube bodies having the substantially U shape.

FIG. 32 is an external perspective view showing a schematic configuration of a light source according to a thirteenth preferred embodiment of the present invention.

FIG. 33 is an external perspective view showing a schematic configuration of a light source according to a fourteenth preferred embodiment of the present invention.

FIG. 34 is an external perspective view showing a schematic configuration of a light source according to a fifteenth preferred embodiment of the present invention.

FIG. 35 is an exploded perspective view showing a schematic configuration of a light source device according to a fourth preferred embodiment of the present invention.

FIG. 36 is a plan view schematically showing a connecting structure of light sources in the light source device according to the fourth preferred embodiment of the present invention and a light source driving circuit board.

FIG. 37 is an external perspective view showing a schematic configuration of a light source according to a sixteenth preferred embodiment of the present invention.

FIG. 38 is an external perspective view showing a schematic configuration of a light source according to a seventeenth preferred embodiment of the present invention.

FIG. 39 is an external perspective view showing a schematic configuration of a light source according to an eighteenth preferred embodiment of the present invention.

FIG. 40 is an exploded perspective view showing a schematic configuration of a light source device according to a fifth preferred embodiment of the present invention.

FIG. 41 is an external perspective view showing a schematic configuration of a light source according to a nineteenth preferred embodiment of the present invention.

FIG. 42 is an external perspective view showing a schematic configuration of a light source according to a twentieth preferred embodiment of the present invention.

FIG. 43 is an external perspective view showing a schematic configuration of a light source according to a twenty first preferred embodiment of the present invention.

FIG. 44 is an exploded perspective view showing a schematic configuration of a light source device according to a sixth preferred embodiment of the present invention.

FIG. 45 is an exploded perspective view showing a schematic configuration of a display device according to a preferred embodiment of the present invention.

FIG. 46 is an exploded perspective view showing a schematic configuration of a television receiver including the display device according to the preferred embodiment of the present invention.

FIG. 47 is an exploded perspective view showing a schematic configuration of a conventional light source device for a display device.

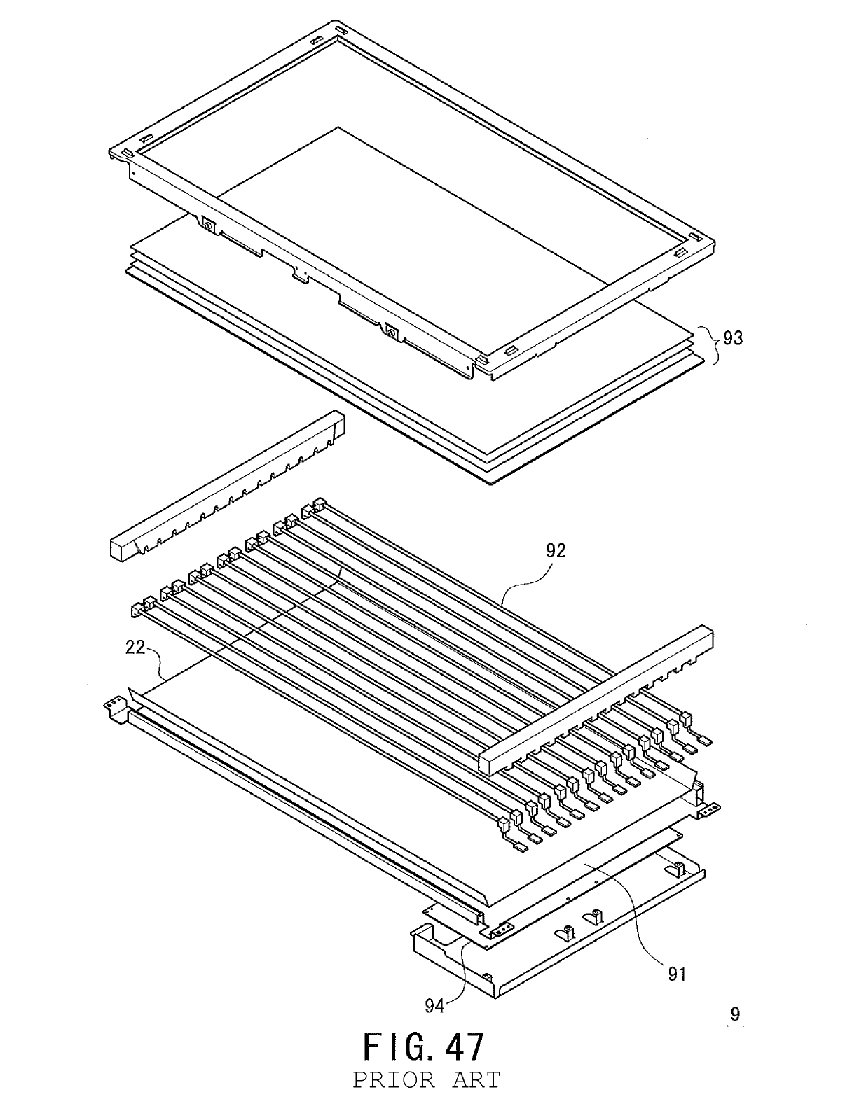

### DESCRIPTION OF EMBODIMENTS

A detailed description of preferred embodiments of the present invention will now be provided with reference to the accompanying drawings.

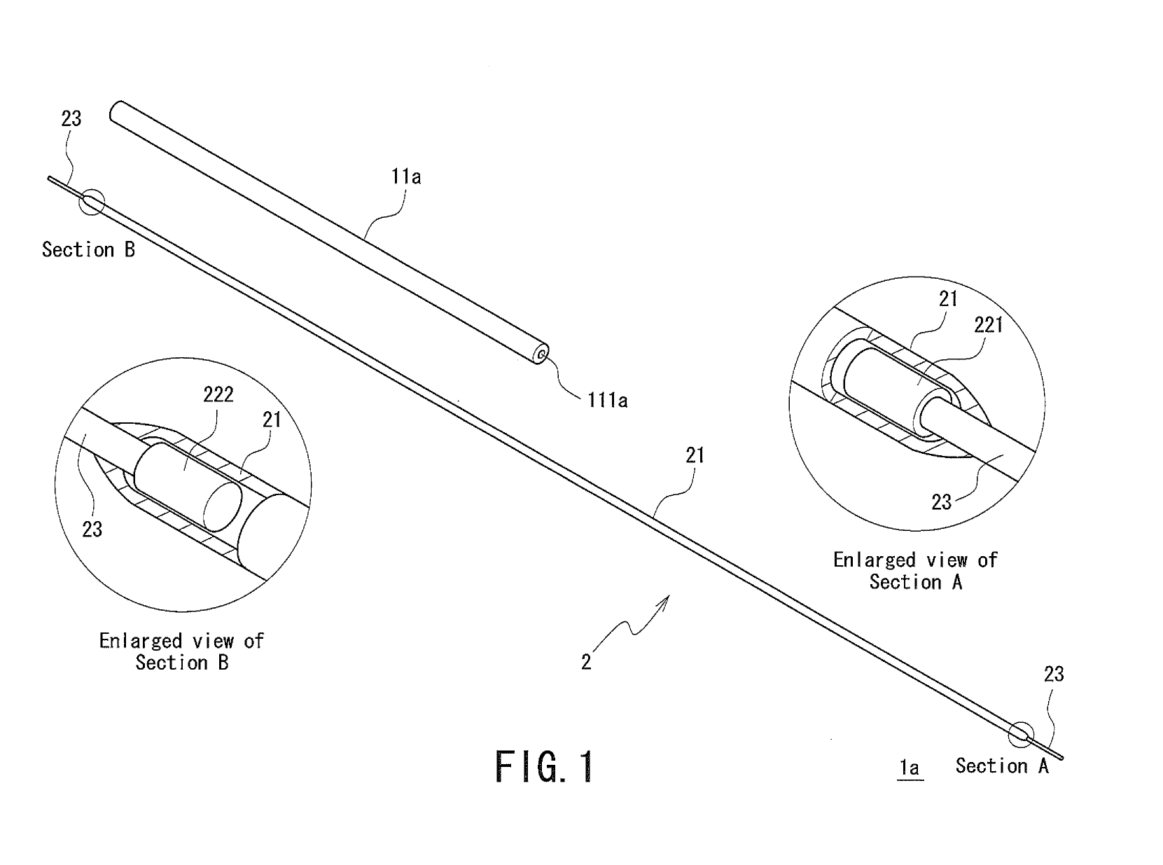

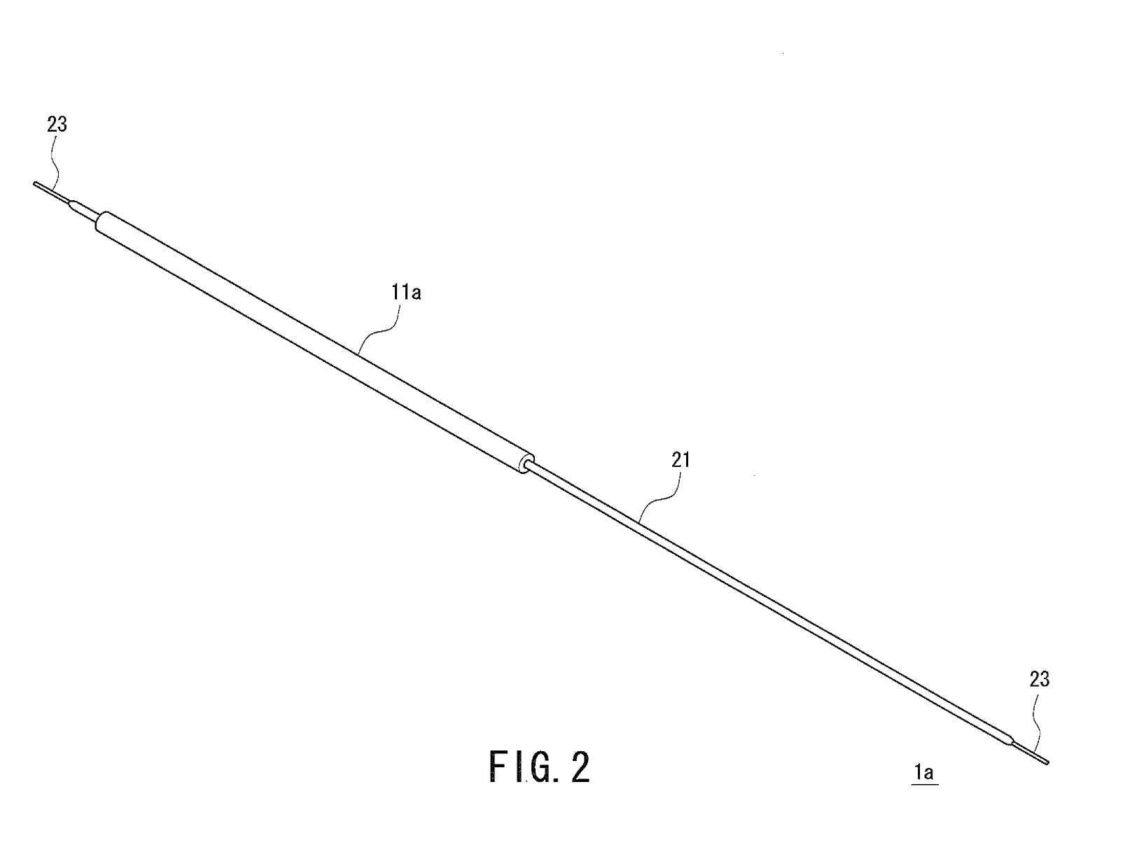

First, a light source 1a according to a first preferred embodiment of the present invention will be described. FIG. 1 is an exploded perspective view showing a schematic configuration of the light source 1a according to the first preferred embodiment of the present invention. FIG. 2 is an external perspective view showing the schematic configuration of the light source 1a according to the first preferred embodiment of the present invention.

The light source 1a according to the first preferred embodiment of the present invention includes a fluorescent lamp 2 that defines a discharge lamp, and a light guiding member 11a as shown in FIGS. 1 and 2.

A conventional linear fluorescent lamp is used as the fluorescent lamp 2. A simple explanation of the fluorescent lamp 2 will be provided. The fluorescent tube 2 includes a tube body 21 that is preferably made from glass and has a linear shape, and discharging electrodes 221 and 222 that are provided at both ends in an axial direction of the tube body 21 (see especially the enlarged views of the sections A and B in FIG. 1). A predetermined kind of noble gas (e.g., an argon gas) and mercury are sealed in the tube body 21, by which a layer of fluorescent material is formed on an inner surface of the tube body 21. Shown in FIGS. 1 and 2 is a fluorescent lamp that includes inner electrodes (a fluorescent lamp having a configuration that discharging electrodes 221 and 222 are disposed inside a tube body 21, and copper wires 23 are drawn from the discharging electrodes 221 and 222 to the outside of the tube body 21); however, the fluorescent lamp is not limited to this configuration. For example, a fluorescent lamp that includes outer electrodes (a fluorescent lamp having a configuration that discharging electrodes 221 and 222 are disposed outside a tube body 21) may be used.

The light guiding member 11a is used attached on an outer surface of the tube body 21 of the fluorescent lamp 2. The attachment of the light guiding member 11a on the outer surface of the tube body 21 of the fluorescent lamp 2 increases an area of the outer surface of the light source 1a according to the first preferred embodiment of the present invention (i.e., an area that emits light to the outside, which is hereinafter referred to as a “light emission area”). The increase of the light emission area increases the amount of light emitted to the outside in a section of the light source 1a to which the light guiding member 11a is attached (or completes the amount of light).

As shown in FIG. 1, the light guiding member 11a has a linear substantially-cylindrical shape. To be specific, the light guiding member 11a has a substantially round shape in cross section, and includes a through-hole 111a inside that runs in the substantial center from one end to the other end in an axial direction of the light guiding member 11a. The through-hole 111a has a configuration such that the tube body 21 of the fluorescent lamp 2 is inserted therein. The through-hole 111a has a size and shape such that an inner surface of the through-hole 111a is brought into substantially intimate contact with the outer surface of the tube body 21 of the fluorescent lamp 2 when the tube body 21 is inserted in the through-hole 111a. As shown in FIGS. 1 and 2, when the tube body 21 of the fluorescent lamp 2 has a substantially round shape in cross section, the light guiding member 11a is formed to have a substantially round shape in cross section. The internal diameter of the through-hole 111a is set to be substantially same as or larger a small amount than the outer diameter of the tube body 21 of the fluorescent lamp 2.

The length in the axial direction of the light guiding member 11a is shorter than the length in the axial direction of the tube body 21 of the fluorescent lamp 2, and is set based on the length of the section of which the amount of light emitted to the outside is to be increased (i.e., completed). For example, when the amount of light is to be increased in a section of about half the length in the axial direction of the tube body 21, the length in the axial direction of the light guiding member 11a is set to be about half the length in the axial direction of the tube body 21 of the fluorescent lamp 2. It is to be noted that the length of the light guiding member 11a is not limited specifically, and may be set to be about one third or one fourth, for example, of the length in the axial direction of the tube body 21 of the fluorescent lamp 2. In FIGS. 1 and 2, shown is the configuration of the light guiding member 11a having the length in the axial direction that is set to be about half the length in the axial direction of the tube body 21 of the fluorescent lamp 2.

As shown in FIG. 2, the tube body 21 of the fluorescent lamp 2 is inserted in the through-hole 111a of the light guiding member 11a, where the light guiding member 11a is attached on the outer surface at a section closer to one end in the axial direction of the tube body 21 of the fluorescent lamp 2. To be specific, one end in the axial direction of the light guiding member 11a is attached so as to be disposed close to the discharging electrode 222 at the one end of the fluorescent lamp 2. Thus, in the configuration that the light guiding member 11a has the length in the axial direction that is set to be about half the length in the axial direction of the tube body 21 of the fluorescent lamp 2, a section from one end to the center in the axial direction on an outer surface of the tube body 21 of the fluorescent lamp 2 is covered with the light guiding member 11a, while a section from the other end to the center on the outer surface of the tube body 21 of the fluorescent lamp 2 is uncovered and exposed. This configuration increases the light emission area at the section from the one end to the center of the tube body 21 of the fluorescent lamp 2, which can increase (or complete) the amount of light emitted to the outside.

In the configuration that the light guiding member 11a has a length in the axial direction that is set to be about one third of the length in the axial direction of the tube body 21 of the fluorescent lamp 2, a section from one end of the tube body 21 to the one third of the entire length on the outer surface of the tube body 21 is covered with the light guiding member 11a, while a section from the other end to the two thirds of the entire length on the outer surface of the tube body 21 is uncovered and exposed. As described above, when the light guiding member 11a is attached on the outer surface of the tube body 21 of the fluorescent lamp 2, a section from the one end to a given position on the outer surface of the tube body 21 is covered with the light guiding member 11a, while the other section is uncovered and exposed. Thus, alight emission area of the tube body 21 is increased at the section where the light guiding member 11a is attached, which can increase (or complete) the amount of light emitted to the outside.

The light guiding member 11a is made from a substantially transparent material such as glass and various kinds of transparent resin materials. Examples of the resin materials include an acrylate resin, an epoxy resin and a polyurethane resin.

The light source 1a according to the first preferred embodiment of the present invention has the configuration that even if the amount of current passing through the tube body 21 is made nonuniform, attachment of the light guiding member 11a to a section of the tube body 21 where the current passing through is small can increase a light emission area in the section, completing the amount of light emitted to the outside. Therefore, the nonuniformity in the light amount that occurs in the axial direction of the tube body 21 can be minimized or eliminated.

To be specific, the light amounts at each section in the axial direction of the fluorescent lamp 2 depend on the amounts of currents passing through the each section. When the current that passes through the tube body 21 of the fluorescent lamp 2 is uniform throughout the length of the tube body 21 of the fluorescent lamp 2, the fluorescent lamp 2 emits light of which the light amount is uniform throughout the length of the fluorescent lamp 2. However, when the current that passes through the tube body 21 of the fluorescent lamp 2 is nonuniform, the light amount is smaller at a section where the current passing through is smaller than a section where the current passing through is larger. For example, if a conductor exists close to the fluorescent lamp 2, a parasitic capacitance is formed between the fluorescent lamp 2 and the conductor, which causes a leak of the current. Consequently, the amount of the current passing through the tube body 21 of the fluorescent lamp 2 is made nonuniform, and the light amount is accordingly made nonuniform.

In order to solve this problem, the light guiding member 11a is attached on the outer surface of the tube body 21 of the fluorescent lamp 2 at the section where the current passing through is small. Attaching the light guiding member 11a produces almost the same effect as increasing the area of the outer surface of the tube body 21 of the fluorescent lamp 2. Thus, the light emission area of the tube body 21 is increased at the section where the light guiding member 11a is attached, which can increase (or complete) the amount of light emitted to the outside. Because the amount of light emitted to the outside can be completed, the nonuniformity in the light amount that occurs in the axial direction of the tube body 21 can be minimized or eliminated.

To be specific, the light source 1a has the configuration that an alternating-current voltage is applied to the discharging electrode 221 at the one end of the fluorescent lamp 2, the one end being closer to the section where the light guiding member 11a is not attached, while the discharging electrode 222 at the other end is grounded, the other end being closer to the section where the light guiding member 11a is attached. In this configuration, if a leak occurs in the current passing through the tube body 21 of the fluorescent lamp 2, the current passing closer to the grounded discharging electrode 222 becomes smaller while the current passing closer to the discharging electrode 221 to which the alternating-current voltage is applied becomes larger. Thus, the light amount of the tube body 21 of the fluorescent lamp 2 is smaller at a section closer to the grounded discharging electrode 222 than a section closer to which the discharging electrode 221 to which the alternating-current voltage is applied. In order to solve this problem, the light guiding member 11a is attached on the outer surface of the tube body 21 of the fluorescent lamp 2 at the section closer to the grounded discharging electrode 222. Thus, the light emission area of the tube body 21 is increased at the section where the light guiding member 11a is attached, which can complete the amount of light emitted to the outside. Therefore, the nonuniformity in the amount of light emitted to the outside can be minimized or eliminated.

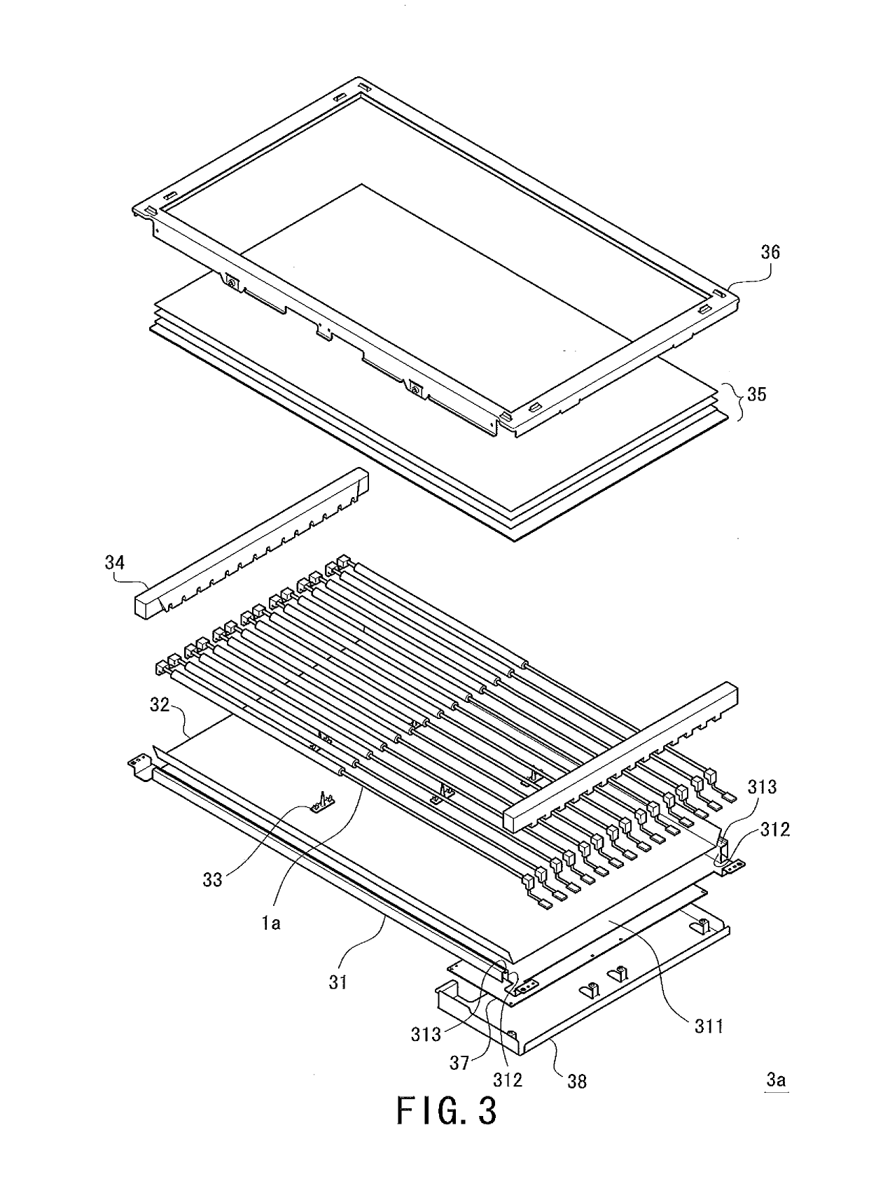

Next, a light source device 3a according to a first preferred embodiment of the present invention will be described. The light source device 3a according to the first preferred embodiment of the present invention includes the light sources 1a according to the first preferred embodiment of the present invention. FIG. 3 is an exploded perspective view showing a schematic configuration of the light source device 3a according to the first preferred embodiment of the present. In FIG. 3, the front sides of the light source device 3a and its components face toward the top of FIG. 3, and the back sides face toward the bottom of FIG. 3.

The light source device 3a according to the first preferred embodiment of the present invention includes a chassis 31, a reflection sheet 32, the light sources 1a according to the first preferred embodiment of the present invention, light source holders 33, side holders 34, optical sheets 35, a frame 36, a light source driving circuit board 37, and a light source driving circuit board cover 38.

The chassis 31 has the shape of a tray of low height. The chassis 31 includes a bottom face 311, side walls 312, and support faces 313. The bottom face 311 has a substantially square planer shape. The bottom face 311 may include through-holes at given positions, in which the light source holders 33 are to be engaged (the through-holes are omitted and not shown in FIG. 3). The side walls 312 are each provided along the longer sides of the bottom face 311 so as to be raised toward the front side. The support faces 313 are provided at top ends of the side walls 312. The support faces 313 has a planer shape substantially parallel to the bottom face 311, on which a border portion of the optical sheets 35 is placed. The chassis 31 is preferably made of a metal plate, and subjected to press working.

The reflection sheet 32 has a sheet, film or plate shape, and has a surface property of diffusely reflecting light. The reflection sheet 32 is preferably expanded PET (polyethylene terephthalate) having a sheet, film or plate shape. The reflection sheet 32 may include through-holes at given positions, in which anchors (described later) of the light source holders 33 are to be inserted (the through-holes are omitted and not shown in FIG. 3).

The light source holders 33 are arranged to hold the light sources 1a according to the first preferred embodiment of the present invention to fix to the front face of the chassis 31 while supporting the optical sheets 35. Each light source holder 33 includes clips for holding the light sources 1a according to the first preferred embodiment of the present invention, a supporting pin for supporting the optical sheets 35, and the anchor for engaging the light source holder 33 with the chassis 31. The clips, the supporting pin and the anchor of each light source holder 24 are of a monolithic construction preferably made of a resin material. The light source holders disclosed in Japanese Patent Application Laid-Open Publication No. 2000-327449 (referred to as “lamp holders” therein) can be used for the light source holders 33.

The side holders 34 have a substantially bar shape, and are arranged to support the optical sheets 35 and to protect both end portions of the light sources 1a according to the first preferred embodiment of the present invention. The side holders 34 are of a monolithic construction preferably made of a resin material.

The optical sheets 35 have a sheet or plate shape, and are arranged to control the properties of light transmitted therethrough. Examples of the optical sheets 35 include a diffusion plate, a diffusion sheet, a lens sheet, and a reflective polarizing sheet.

The diffusion plate and diffusion sheet are arranged to randomly diffuse (scatter) light transmitted therethrough, allowing intensity distribution in a plane direction of the light to be uniform. The diffusion plate is made from a nearly clear resin material that is a base material, in which fine particles having a property of reflecting light, or fine particles made of a material having a refractive index different from the base material are mixed. The nearly clear base material is preferably PET (polyethylene terephthalate).

The lens sheet is arranged to gather light transmitted therethrough, allowing enhancement of brightness of the light. The lens sheet has a layer structure made up of a base layer, and a layer of a given cross-sectional shape that has a light-gathering function. The base layer is preferably made from PET (polyethylene terephthalate). The layer having the light-gathering function is preferably made from an acrylic resin.

The reflective polarizing sheet (also referred to as a brightness enhancement sheet) is arranged to effectively use light. The reflective polarizing sheet is arranged to transmit light that is polarized in a given direction (i.e., light that vibrates in a given direction), and reflect light other than the polarized light. The reflective polarizing sheet is preferably a DBEF film (DBEF is a registered trademark of 3M COMPANY).

The frame 36 has a substantially square shape with an opening. The frame 36 may be of a monolithic construction made of a resin material, may be of a multi-component assembled construction made of a resin material, may be of a monolithic construction made of a metal plate that is subjected to press working, or may be of a multi-component assembled construction made of a metal plate that is subjected to press working.

The light source driving circuit board 37 incorporates electronic circuits and/or electric circuits for driving the light sources 1a according to the first preferred embodiment of the present invention. Because the light sources 1a include the fluorescent lamps 2, the light source driving circuit board 37 incorporates electric circuits (e.g., inverter circuits) that generate high-tension alternating-current voltages. The light source driving circuit board cover 38 is disposed so as to protect the light source driving circuit board 37, and arranged to prevent unnecessary radiation from the light source driving circuit board 37. For this purpose, the light source driving circuit board cover 38 is made from a conductor such as metal.

A description of assembly of the light source device 3a according to the first preferred embodiment of the present invention will be provided.

The reflection sheet 32 is laid on the front side of the bottom face 311 of the chassis 31. A given number of the light sources 1a according to the first preferred embodiment of the present invention are arranged in parallel on the front side of the reflection sheet 32. The light sources 1a are oriented in a direction such that the sections where the light guiding members 11a are attached are brought to a same side (shown in FIG. 3 is the configuration that the sections where the light guiding members 11a are attached face the top left side of FIG. 3). The light sources 1a are held by the light source holders 33 and fixed to the front side of the bottom face 311 of the chassis 31.

The side holders 34 are disposed along the shorter sides of the chassis 31 so as to cover both the end portions of the light sources 1a.

The optical sheets 35 are layered in a given order in front of the chassis 31 and the side holders 34. Examples of the optical sheets 35 include a diffusion plate, two lens sheets, a diffusion sheet and a reflective polarizing sheet, where the diffusion plate, the first lens sheet, the diffusion sheet, the second lens sheet and the reflective polarizing sheet are layered in this order from the back side of the light source device 3a. The border portion of the optical sheets 35 is placed on the support faces 313 of the chassis 31 and the front sides of the side holders 34. The center portion of the optical sheets 35 (i.e., the portion that is not placed on the support faces 313 of the chassis 31 nor the front sides of the side holders 34) is supported by the supporting pins of the light source holders 33.

The kind and combination of the optical sheets 35 are not limited to the ones described above. The kind and combination of the optical sheets 35 are preferably determined according to the kinds or requirements of the light source device 3a or a display device including the light source device 3a.

The frame 36 is attached to the front side of the chassis 31, whereby the border portion of the optical sheets 35 is sandwiched to be held between the support faces 313 of the chassis 31 and the frame 36, and between the front sides of the side holders 34 and the frame 36.

The light source driving circuit board 37 is disposed behind the chassis 31. The light source driving circuit board 37 is electrically connected to the light sources 1a according to the first preferred embodiment of the present invention. To be specific, the light source driving circuit board 37 is connected to the light sources 1a such that the alternating-current voltages generated by the light source driving circuit board 37 are applied to the discharging electrodes 221 at the one ends of the light sources 1a closer to the sections where the light guiding members 11a are not attached. Meanwhile, the discharging electrodes 222 at the other ends of the light sources 1a closer to the sections where the light guiding members 11a are attached are grounded.

With the configuration described above, the alternating-current voltages generated by the light source driving circuit board 37 are applied to the discharging electrodes 221 at the one ends of the light sources 1a closer to the sections where the light guiding members 11a are not attached, whereby light is emitted. The light emitted from the light sources 1a is transmitted through the optical sheets 35 with the properties of the light being controlled during the transmission, and is projected toward the front side.

Because the light sources 1a according to the first preferred embodiment of the present invention can make the amounts of light emitted to the outside uniform along the axial direction of the tube bodies 21 of the fluorescent lamps 2, the light source device 3a according to the first preferred embodiment of the present invention can emit light of which intensity distribution in a plane direction is uniform as a whole.

To be specific, the light sources 1a according to the first preferred embodiment of the present invention have a problem that because the light sources 1a are laid on the front side of the bottom face 311 of the chassis 31 and a parasitic capacitance is formed between the fluorescent lamps 2 and the bottom face 311 of the chassis 31 if the chassis is made from a conductor such as a metal plate, leaks occur in the currents passing through the tube bodies 21 of the fluorescent lamps 2 of the light sources 1a, whereby the amounts of the currents along the axial directions of the tube bodies 21 of the fluorescent lamps 2 are made nonuniform. In other words, the currents passing closer to the discharging electrodes 221 to which the alternating-current voltages are applied are larger while the currents passing closer to the grounded discharging electrodes 222 are smaller.

Because the light guiding members 11a are attached on the outer surfaces of the tube bodies 21 of the fluorescent lamps 2 of the light sources 1a at the sections closer to the grounded discharging electrodes 222, the light emission areas of the tube bodies 21 are larger at the sections closer to the grounded discharging electrodes 222 than the sections closer to the discharging electrodes 221 to which the alternating-current voltages are applied, which can complete the light amounts at the sections closer to the grounded discharging electrodes 222. Consequently, a difference between the amounts of light emitted to the outside at the sections closer to the grounded discharging electrodes 222 and the amounts of light emitted to the outside at the sections closer to the discharging electrodes 221 to which the alternating-current voltages are applied can be reduced, or eliminated, which allows the light sources 1a to emit light of which the light amounts are uniform throughout the length of the tube bodies 21 of the fluorescent lamps 2. Therefore, the light source device 3a according to the first preferred embodiment of the present invention can emit light of which intensity distribution in a plane direction is uniform as a whole.

In addition, because the light source device 3a according to the first preferred embodiment of the present invention has the configuration that alternating-current voltages are applied to the discharging electrodes 221 at the one ends of the light sources 1a according to the first preferred embodiment of the present invention while the discharging electrodes 222 at the other ends are grounded, the number of parts required for the light source device 3a can be reduced and the configuration of the light source device 3a can be simplified in comparison with a light source device having a configuration that alternating-current voltages in opposite phases are applied to discharging electrodes at both ends of light sources. In other words, in the configuration that the alternating-current voltages in opposite phases are applied to the discharging electrodes at both the ends of the light sources, two light source driving circuit boards are required to generate the alternating-current voltages in opposite phases, and the two light source driving circuit boards need to be driven in synchronization with each other. In contrast, required in the configuration of the light source device 3a according to the first preferred embodiment of the present invention is the only one light source driving circuit board 37, where no circuit for synchronized driving is required.

In addition, because conventional generally-used fluorescent lamps can be used as the fluorescent lamps 2 of the light sources 1a according to the first preferred embodiment of the present invention, and the light guiding members 11a have the simple shape and can be made from an easily-available low-cost material (e.g., glass and various kinds of resins), the light sources 1a can be produced at low cost, and a rise in price of the light source device 3a can be prevented or minimized in comparison with fluorescent lamps including tube bodies having a special shape.

A brief description of configurations of various light sources will be provided because the configuration is not limited to the configuration of the light source 1a according to the first preferred embodiment of the present invention described above. The light sources according to other preferred embodiments of the present invention to be described below each include fluorescent lamps 2 that define discharge lamps, and light guiding members having predetermined configurations. For these fluorescent lamps 2, the fluorescent lamps 2 of the light source 1a according to the first preferred embodiment of the present invention are used. The light guiding members are, like the light guiding members 11a used in the light sources 1a according to the first preferred embodiment of the present invention, made from a substantially transparent material such as glass and various kinds of transparent resin materials. Examples of the resin materials include an acrylate resin, an epoxy resin and a polyurethane resin.

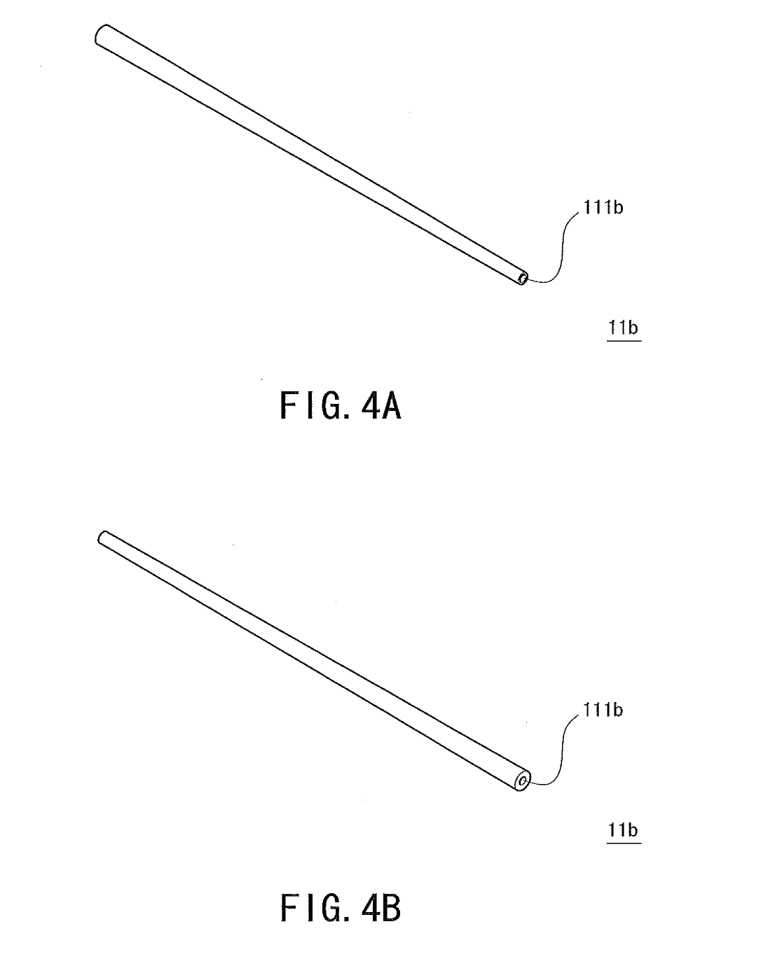

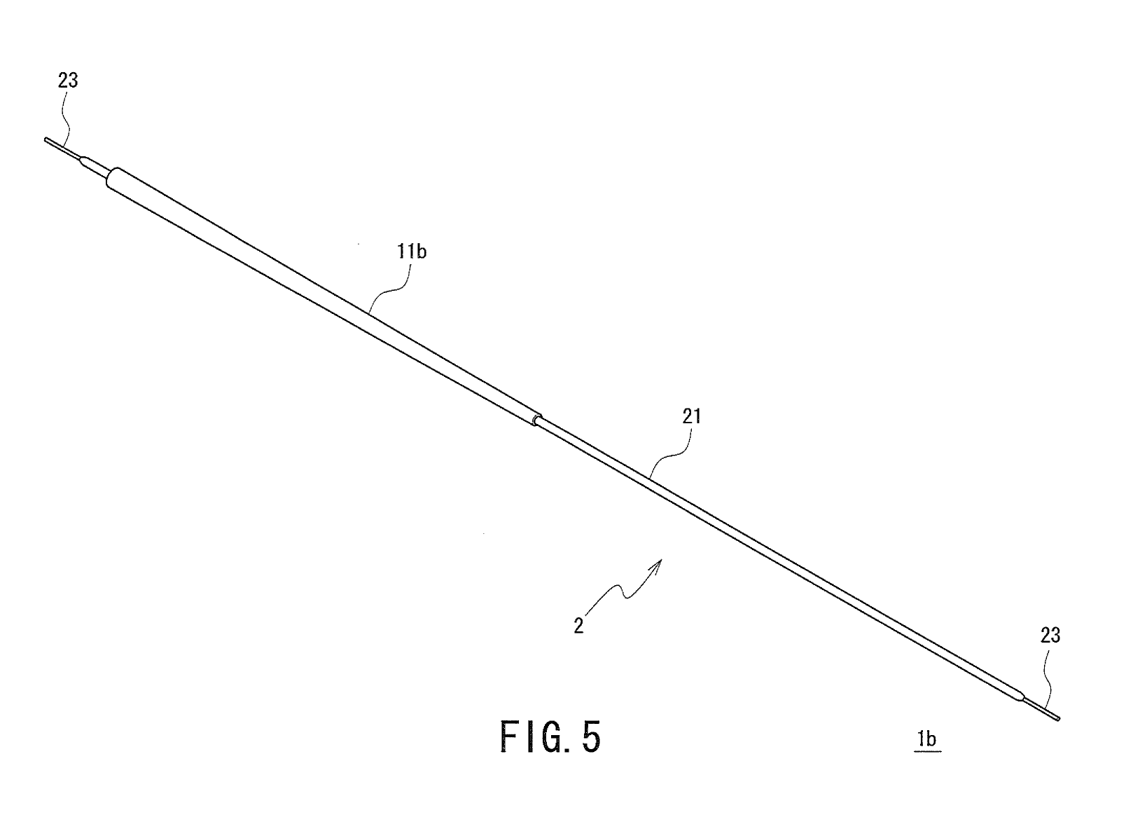

A description of a light source 1b according to a second preferred embodiment of the present invention will be provided. FIGS. 4A and 4B are external perspective views showing a schematic configuration of a light guiding member 11b used for the light source 1b according to the second preferred embodiment of the present invention, where shown in FIG. 4A is the light guiding member 11b seen from the side of its one end, and shown in FIG. 4B is the light guiding member 11b seen from the side of the other end. FIG. 5 is an external perspective view showing a schematic configuration of the light source 1b according to the second preferred embodiment of the present invention, where the light guiding member 11b is attached to the tube body 21 of the fluorescent lamp 2.

As shown in FIGS. 4A and 4B, the light guiding member 11b used for the light source 1b according to the second preferred embodiment of the present invention has a tapered cylindrical shape such that the outer diameter at one end in an axial direction is smaller and the outer diameter at the other end is larger. To be specific, the light guiding member 11b has a shape such that its surface areas (i.e., “light emission areas”) per unit length become larger by degrees from the one end in the axial direction to the other end. The light guiding member 11b includes a through-hole 111b inside that runs from the one end to the other end in the axial direction. The internal diameter of the through-hole 111b is same as that of the through-hole 111a of the light guiding member 11a used in the light sources 1a according to the first preferred embodiment of the present invention. In addition, the length in the axial direction of the light guiding member 11b is same as that of the light guiding member 11a used in the light sources 1a according to the first preferred embodiment of the present invention. In FIGS. 4A, 4B and 5, shown is the configuration of the light guiding member 11b having the length in the axial direction that is set to be about half the length in the axial direction of the tube body 21 of the fluorescent lamp 2.

As shown in FIG. 5, the tube body 21 of the fluorescent lamp 2 is inserted in the through-hole 111b of the light guiding member 11b, where the light guiding member 11b is attached at a section closer to one end in the axial direction of the tube body 21 of the fluorescent lamp 2. To be specific, the light guiding member 11b is attached such that its one end of which the outer diameter is larger is disposed close to the discharging electrode 222 at the one end of the fluorescent lamp 2. Thus, in the configuration that the light guiding member 11b has the length in the axial direction that is set to be about half the length in the axial direction of the tube body 21 of the fluorescent lamp 2, the light guiding member 11b is attached to the tube body 21 of the fluorescent lamp 2 at a section from the one end to the center in the axial direction of the tube body 21. Thus, the one end of the light guiding member 11b of which the outer diameter is smaller is disposed almost at the center of the tube body 21 of the fluorescent lamp 2 while the other end of the light guiding member 11b of which the outer diameter is larger is disposed at the one end of the tube body 21 of the fluorescent lamp 2.

The same action and effect as those obtained by the light source 1a according to the first preferred embodiment of the present invention can be obtained by the light source 1b according to the second preferred embodiment of the present invention.

Especially in the configuration that an alternating-current voltage is applied to the discharging electrode 221 while the discharging electrode 222 is grounded, the amount of the current passing through the tube body 21 is smaller by degrees from the section closer to the discharging electrode 221 to which the alternating-current voltage is applied to the section closer to the grounded discharging electrode 222. Accordingly, the light amount of the fluorescent lamp 2 is smaller by degrees from the section closer to the discharging electrode 221 to which the alternating-current voltage is applied to the section closer to the grounded discharging electrode 222.

The attachment of the light guiding member 11b, which has the configuration that the surface areas per unit length become larger by degrees toward the section closer to the grounded discharging electrode 222, to the fluorescent lamp 2 of the light source 1b according to the second preferred embodiment of the present invention increases the light emission area by degrees from the section closer to the discharging electrode 221 to which the alternating-current voltage is applied to the section closer to the grounded discharging electrode 222. Accordingly, the amount of light emitted to the outside can be increased by degrees from the section closer to the discharging electrode 221 to which the alternating-current voltage is applied to the section closer to the grounded discharging electrode 222, which allows the light source 1b to emit light of which the amount emitted to the outside is uniform throughout the length.

The light sources 1b according to the second preferred embodiment of the present invention are incorporated to be used in a light source device having a same configuration as the light source device 3a according to the first preferred embodiment of the present invention. In other words, the light source device including the light sources 1b has a configuration such that the light sources 1a according to the first preferred embodiment of the present invention are replaced with the light sources 1b according to the second preferred embodiment of the present invention in the light source device 3a according to the first preferred embodiment of the present invention, an explanation of which is accordingly omitted.

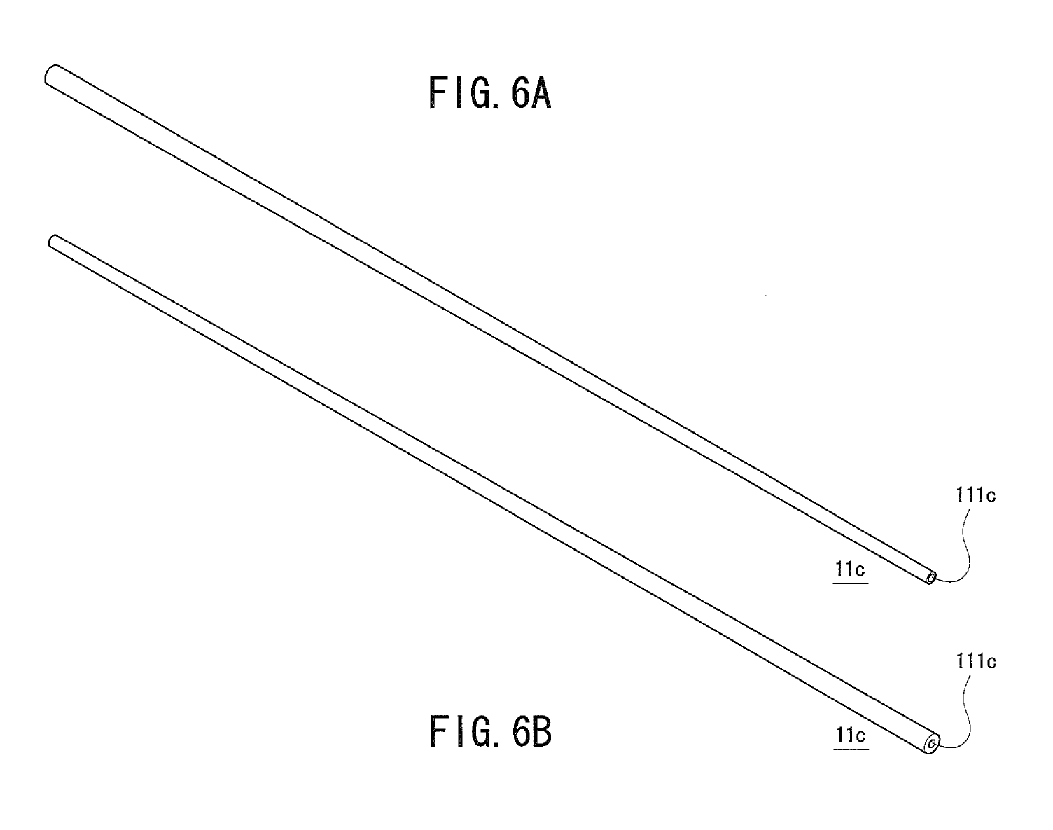

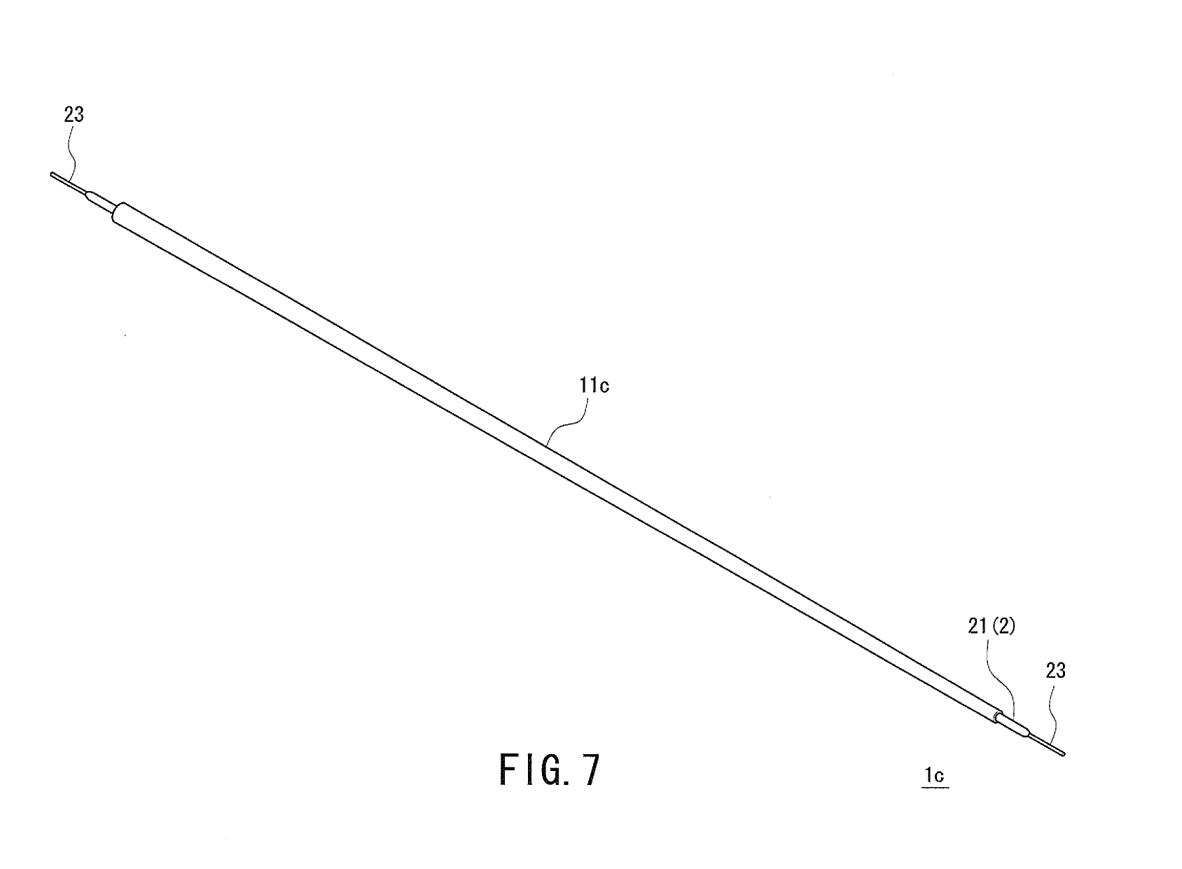

Next, a description of a light source 1c according to a third preferred embodiment of the present invention will be provided. FIGS. 6A and 6B are external perspective views showing a schematic configuration of a light guiding member 11c used for the light source 1c according to the third preferred embodiment of the present invention, where shown in FIG. 6A is the light guiding member 11c seen from the side of its one end, and shown in FIG. 6B is the light guiding member 11c seen from the side of the other end. FIG. 7 is an external perspective view showing a schematic configuration of the light source 1c according to the third preferred embodiment of the present invention.

As shown in FIGS. 6A and 6B, the light guiding member 11c used for the light source 1c according to the third preferred embodiment of the present invention has a tapered cylindrical shape such that the outer diameter at one end in an axial direction is smaller and the outer diameter at the other end is larger. To be specific, the light guiding member 11c has a shape such that its surface areas per unit length become larger by degrees from the one end in the axial direction to the other end. The light guiding member 11c includes a through-hole 111c inside that runs from the one end to the other end in the axial direction. The internal diameter of the through-hole 111c is same as that of the through-hole 111a of the light guiding member 11a used in the light sources 1a according to the first preferred embodiment of the present invention. The length in the axial direction of the light guiding member 11c is substantially same or slightly shorter than the length in the axial direction of the tube body 21 of the fluorescent lamp 2. In FIGS. 6A, 6B and 7, shown is the configuration of the light guiding member 11c having the length in the axial direction that is set to be slightly shorter than the length in the axial direction of the tube body 21 of the fluorescent lamp 2.

As shown in FIG. 7, the tube body 21 of the fluorescent lamp 2 is inserted in the through-hole 111c of the light guiding member 11c, whereby the light guiding member 11c is attached on the outer surface of the tube body 21 of the fluorescent lamp 2. When the light guiding member 11c has the length substantially same as the length in the axial direction of the tube body 21 of the fluorescent lamp 2, the outer surface of the tube body 21 of the fluorescent lamp 2 is covered throughout its substantial length with the light guiding member 11c. When the light guiding member 11c has the length slightly shorter than the length in the axial direction of the tube body 21 of the fluorescent lamp 2, the outer surface of the tube body 21 of the fluorescent lamp 2 is covered with the light guiding member 11c such that both the ends of the tube body 21 of the fluorescent lamp 2 protrude through the light guiding member 11c.

The light source 1c according to the third preferred embodiment of the present invention thus has a light emission area that becomes larger by degrees from one end in the axial direction to the other end. Consequently, the same action and effect as those obtained by the light source 1b according to the second preferred embodiment of the present invention can be obtained by the light source 1c according to the third preferred embodiment of the present invention. Especially because the light guiding member 11c is attached to the tube body 21 of the fluorescent lamp 2 throughout the length in the axial direction of the tube body 21, the light source 1c according to the third preferred embodiment of the present invention can emit light of which the amount emitted to the outside is uniform throughout the length.

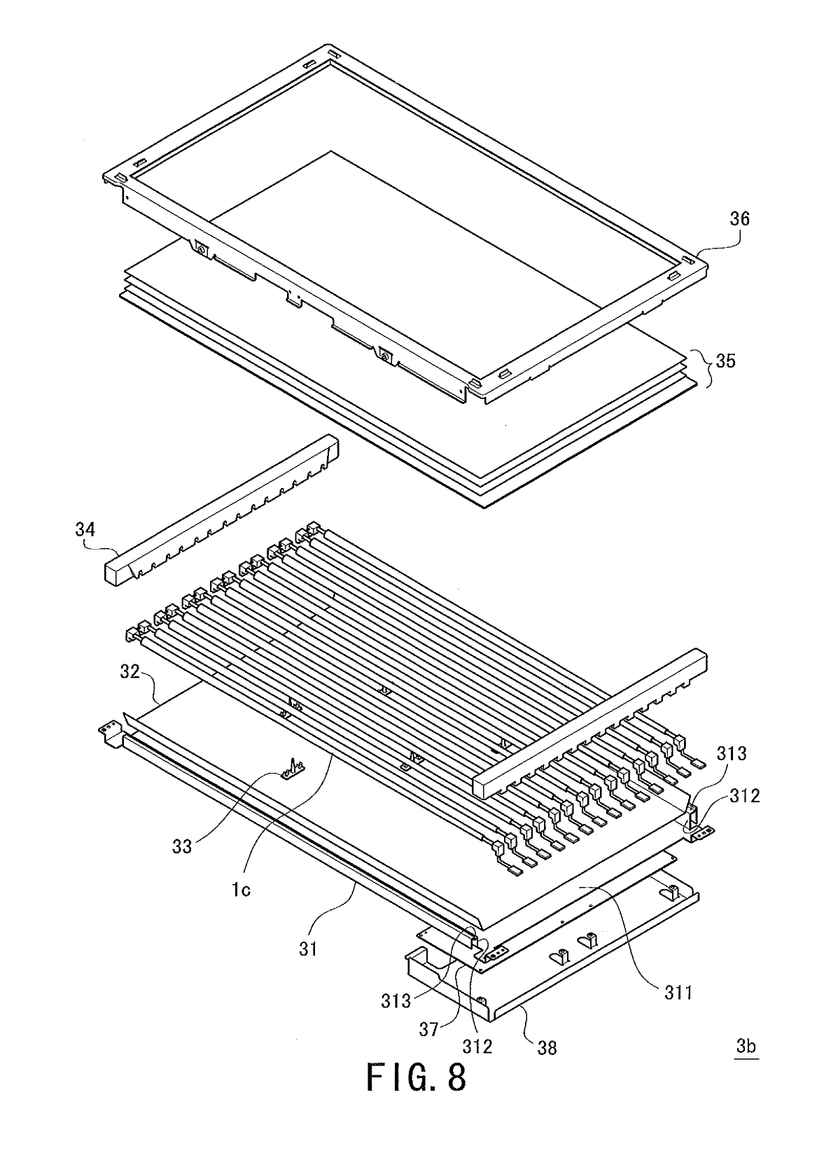

Next, alight source device 3b according to a second preferred embodiment of the present invention will be described. The light source device 3b according to the second preferred embodiment of the present invention includes the light sources 1c according to the third preferred embodiment of the present invention. FIG. 8 is an exploded perspective view showing a schematic configuration of the light source device 3b according to the second preferred embodiment of the present invention. It is to be noted that the light source device 3b according to the second preferred embodiment of the present invention has a configuration same as the light source device 3a according to the first preferred embodiment of the present invention except that the light source device 3b according to the second preferred embodiment of the present invention includes the light sources 1c according to the third preferred embodiment of the present invention. Thus, explanations of some components of the light source device 3b, which are common to components of the light source device 3a, are omitted, providing reference numerals same as the components of the light source device 3a to the corresponding components of the light source device 3b.

A reflection sheet 32 is laid on the front side of a bottom face 311 of a chassis 31. A given number of the light sources 1c according to the third preferred embodiment of the present invention are arranged in parallel on the front side of the reflection sheet 32. All the light guiding members 11c of the light sources 1c are oriented in a direction. To be specific, the light guiding members 11c of the light sources 1c are oriented in a direction such that their larger diameter ends are disposed close to one of the shorter sides of the chassis 31 while the smaller diameter ends are disposed close to the other shorter side of the chassis 31. Shown in FIG. 8 is the configuration that the smaller diameter ends face the bottom right side of FIG. 8, and the larger diameter ends face the top left side of FIG. 8. The light sources 1c are held by light source holders 33 and fixed to the front side of the bottom face 311 of the chassis 31.

Alight source driving circuit board 37 is disposed behind the chassis 31. The light source driving circuit board 37 is electrically connected to the light sources 1c according to the third preferred embodiment of the present invention. To be specific, the light source driving circuit board 37 is connected to the light sources 1c such that the alternating-current voltages generated by the light source driving circuit board 37 are applied to the discharging electrodes 221 at the one ends of the light sources 1c, the one ends being closer to the smaller diameter ends of the light guiding members 11c. Meanwhile, the discharging electrodes 222 at the other ends of the light sources 1c are grounded, the other ends being closer to the larger diameter ends of the light guiding members 11c.

Consequently, the same action and effect as those obtained by the light source device 3a according to the first preferred embodiment of the present invention can be obtained by the light source device 3b according to the second preferred embodiment of the present invention.

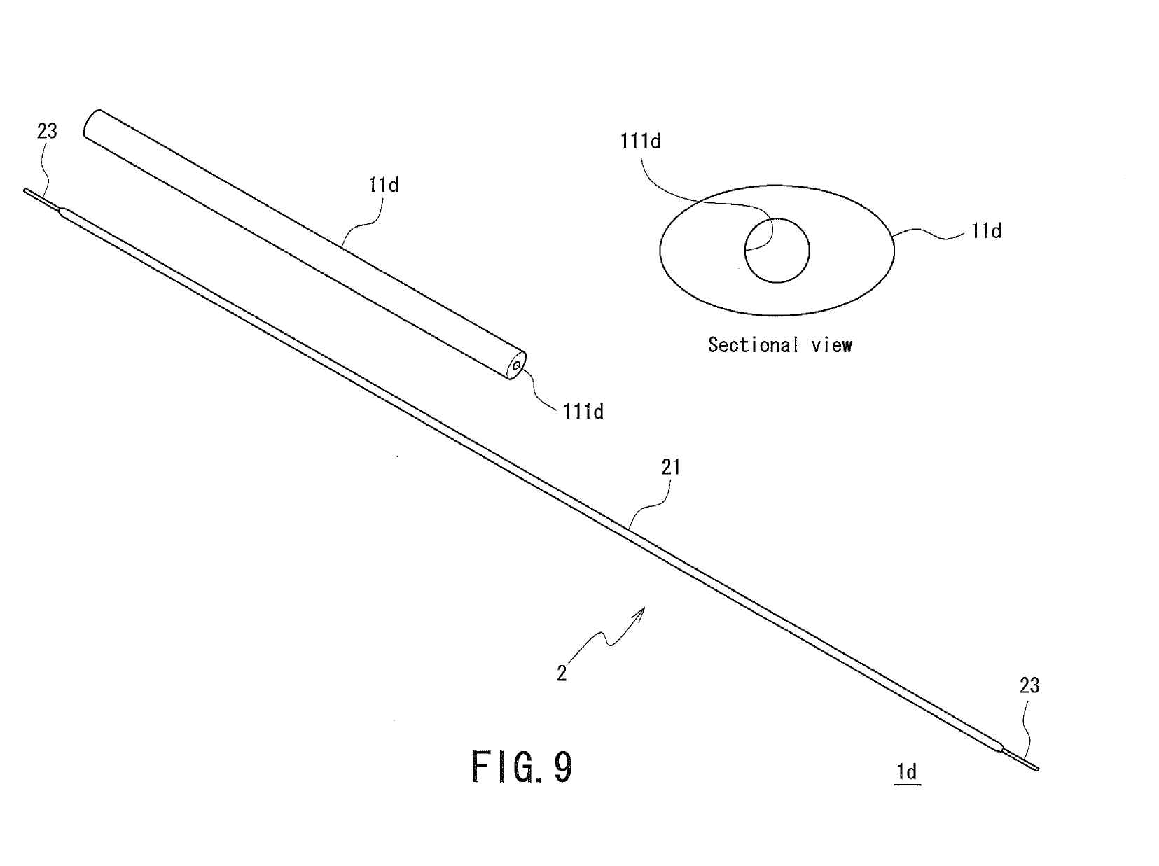

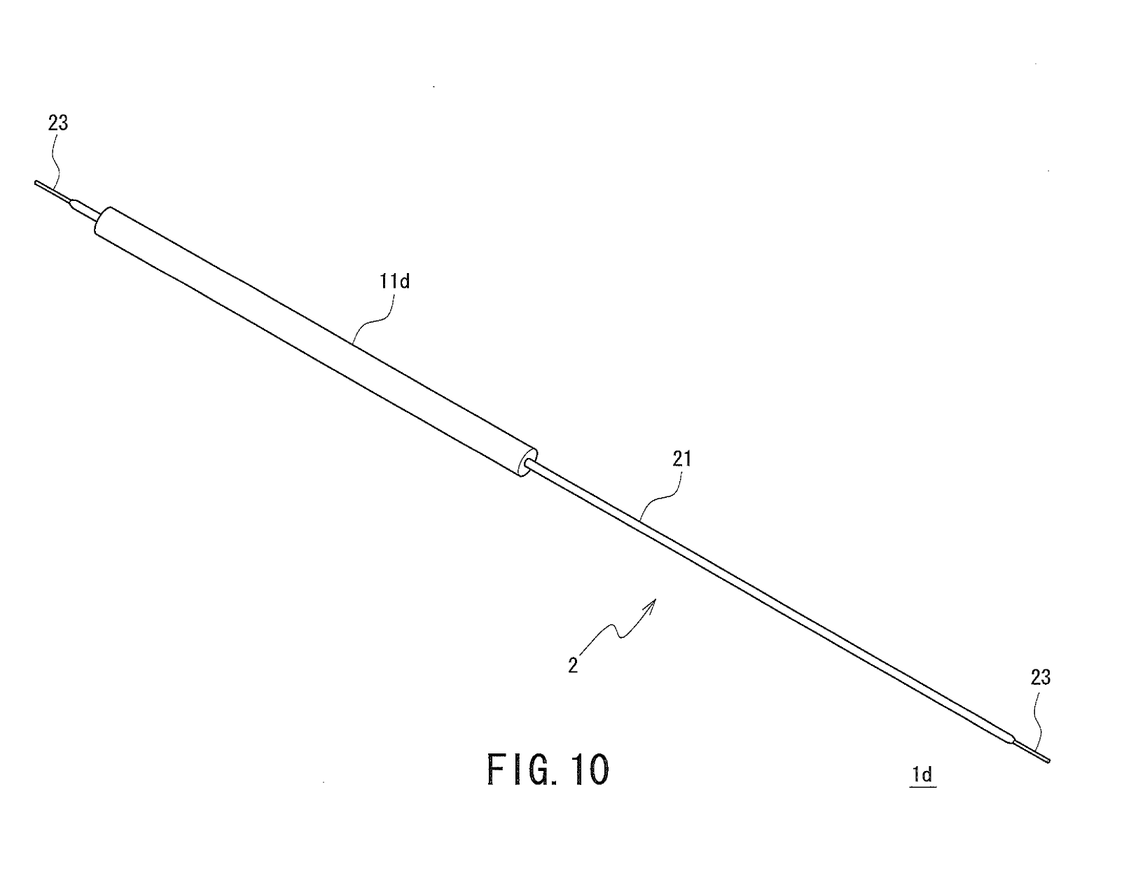

Next, a description of a light source 1d according to a fourth preferred embodiment of the present invention will be provided. FIG. 9 is an exploded perspective view showing a schematic configuration of the light source 1d according to the fourth preferred embodiment of the present invention, and a cross-sectional view showing a cross section structure of a light guiding member 11d. FIG. 10 is an external perspective view showing the schematic configuration of the light source 1d according to the fourth preferred embodiment of the present invention. The light source 1d according to the fourth preferred embodiment of the present invention includes the light guiding member 11d and the fluorescent lamp 2 as shown in FIGS. 9 and 10.

As shown in FIGS. 9 and 10, the light guiding member 11d has a cylindrical (linear) shape. To be specific, the outer surface of the light guiding member 11d is substantially oval in cross section. The light guiding member 11d includes a through-hole 111d inside that runs from one end to the other end in an axial direction of the light guiding member 11d. The internal diameter of the through-hole 111d is same as that of the through-hole 111a of the light guiding member 11a used in the light sources 1a according to the first preferred embodiment of the present invention. The length in the axial direction of the light guiding member 11d is substantially same as the length in the axial direction of the light guiding member 11a of the light sources 1a according to the first preferred embodiment of the present invention.

As shown in FIG. 10, the tube body 21 of the fluorescent lamp 2 is inserted in the through-hole 111d of the light guiding member 11d, where the light guiding member 11d is attached at a section closer to one end in the axial direction of the tube body 21 of the fluorescent lamp 2. Similarly to the light sources 1a according to the first preferred embodiment of the present invention, the light guiding member 11d is attached such that its one end in the axial direction is disposed close to the discharging electrode 222 at the one end of the fluorescent lamp 2.

Consequently, the same action and effect as those obtained by the light source 1a according to the first preferred embodiment of the present invention can be obtained by the light source 1d according to the fourth preferred embodiment of the present invention.

Next, a light source device 3c according to a third preferred embodiment of the present invention will be described. The light source device 3c according to the third preferred embodiment of the present invention includes the light sources 1d according to the fourth preferred embodiment of the present invention. It is to be noted that the light source device 3c according to the third preferred embodiment of the present invention has a configuration same as the light source device 3a according to the first preferred embodiment of the present invention except that the light source device 3c according to the third preferred embodiment of the present invention includes the light sources 1d according to the fourth preferred embodiment of the present invention. Thus, explanations of some components of the light source device 3c, which are common to components of the light source device 3a, are omitted, providing reference numerals same as the components of the light source device 3a to the corresponding components of the light source device 3c.

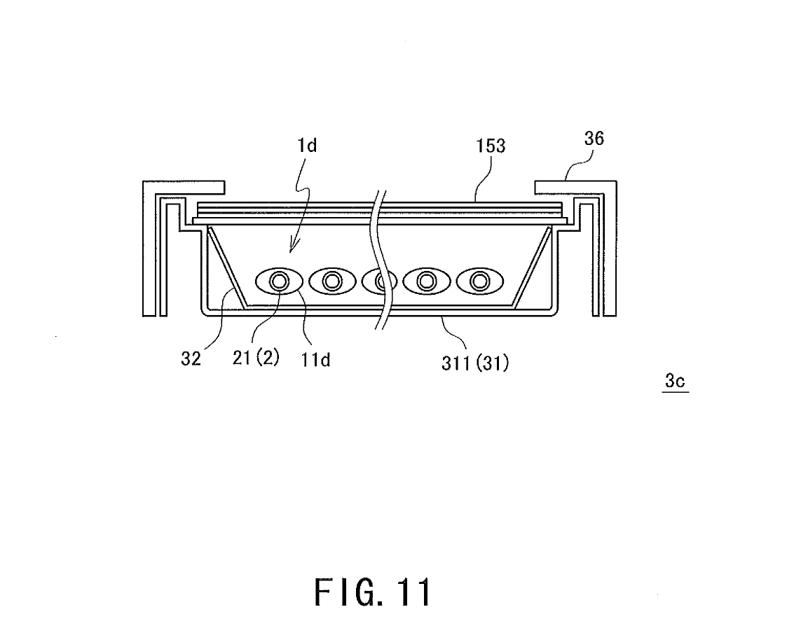

FIG. 11 is a cross-sectional view schematically showing a cross section structure of the light source device 3c according to the third preferred embodiment of the present invention. A reflection sheet 32 is laid on the front side of a bottom face 311 of a chassis 31 as shown in FIG. 11. A given number of the light sources 1d according to the fourth preferred embodiment of the present invention are arranged in parallel on the front side of the reflection sheet 32. The light sources 1d are oriented in a direction such that the sections where the light guiding members 11d are attached are brought to a same side. To be specific, the ends of the light sources 1d closer to sections where the light guiding members 11d are attached are disposed close to one of the shorter sides of the bottom face 311 of the chassis 31 while the other ends closer to sections where the light guiding members 11d are not attached are disposed close to the other shorter side.

In addition, the light sources 1d are disposed such that the longer axial directions of the oval shapes of the light guiding members 11d are substantially parallel to a plane direction of the optical sheets 35 as shown in FIG. 11.

Alight source driving circuit board 37 is disposed behind the chassis 31 (not shown in FIG. 11). The light source driving circuit board 37 is electrically connected to the light sources 1d according to the fourth preferred embodiment of the present invention. To be specific, the light source driving circuit board 37 is connected to the light sources 1d such that the alternating-current voltages generated by the light source driving circuit board 37 are applied to the discharging electrodes 221 at the one ends of the light sources 1d (at the one ends closer to the sections where the light guiding members 11d are not attached). Meanwhile, the discharging electrodes 222 at the other ends of the light sources 1d (at the other ends closer to the sections where the light guiding members 11d are attached) are grounded.

Consequently, the same action and effect as those obtained by the light source device 3a according to the first preferred embodiment of the present invention can be obtained by the light source device 3c according to the third preferred embodiment of the present invention. Because the longer axial directions of the oval shapes of the light guiding members 11d are substantially parallel to the plane direction of the optical sheets 35, an apparent surface area (project area) of the light guiding members 11d can be increased when the light source device 3a is seen from the front side. Accordingly, the amount of light the light sources 1d according to the fourth preferred embodiment of the present invention emit toward the front side can be increased. In addition, because the shorter axial directions of the oval shapes of the light guiding members 11d are parallel to the back and front direction of the light source device 3c, an increase in size in the back and front direction (increase in thickness) of the light source device 3c is prevented.

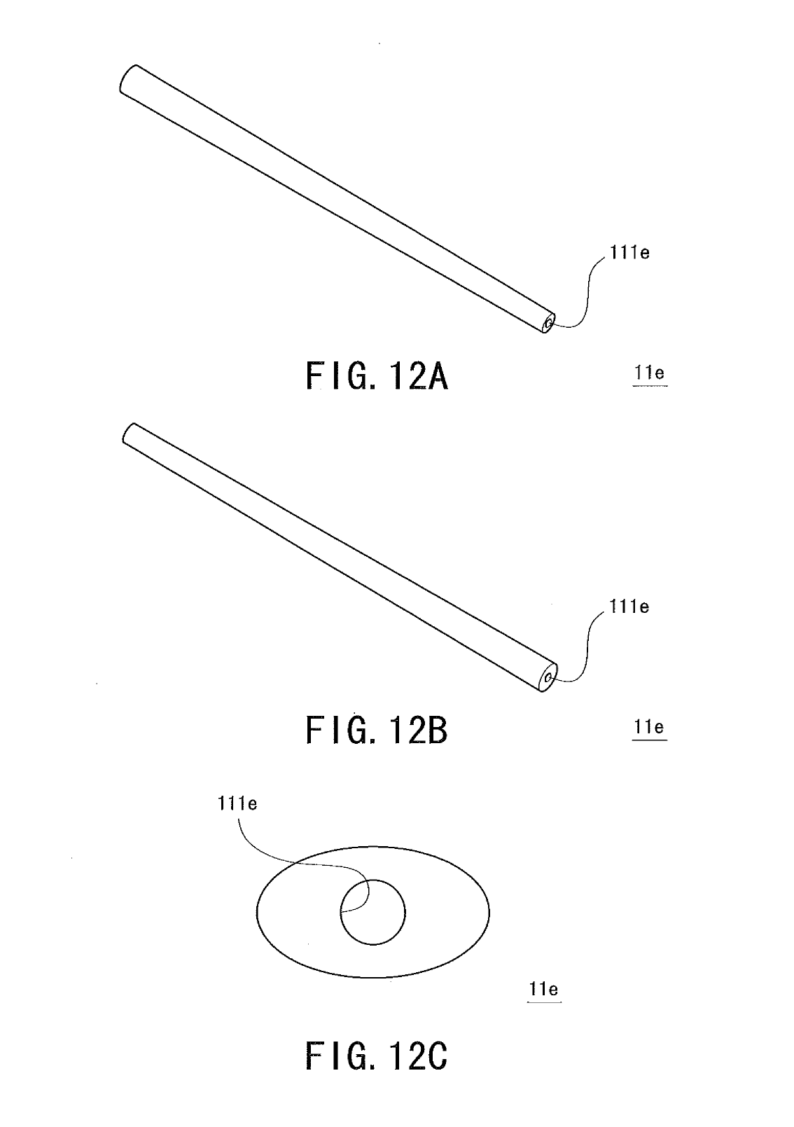

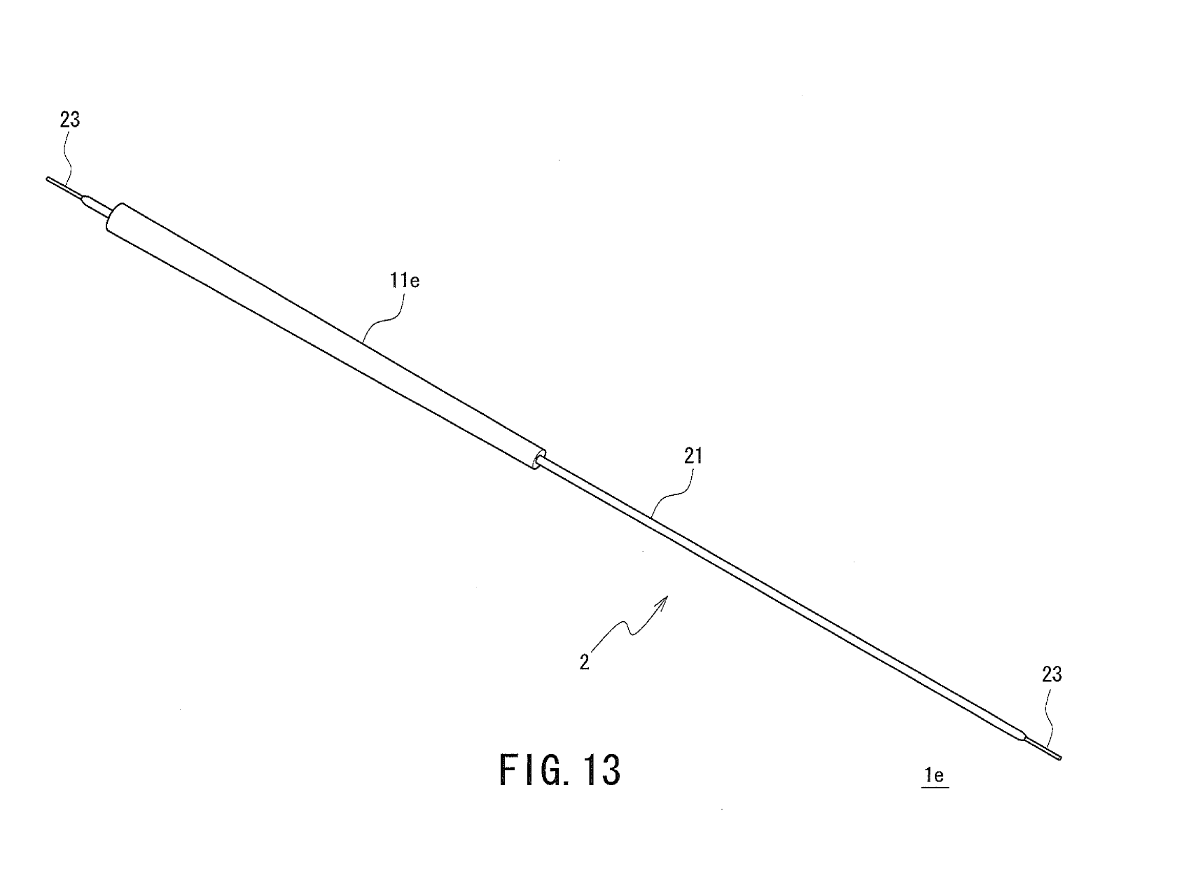

Next, a description of a light source 1e according to a fifth preferred embodiment of the present invention will be provided. FIGS. 12A, 12B and 12C are views showing a schematic configuration of a light guiding member 11e used for the light source 1e according to the fifth preferred embodiment of the present invention, where FIG. 12A is an external perspective view showing the light guiding member 11e seen from the side of its one end in an axial direction, FIG. 12B is an external perspective view showing the light guiding member 11e seen from the side of the other end, and FIG. 12C is a cross-sectional view of the light guiding member 11e. FIG. 13 is an external perspective view showing a schematic configuration of the light source 1e according to the fifth preferred embodiment of the present invention.

As shown in FIGS. 12A and 12B, the light guiding member 11e used for the light source 1e according to the fifth preferred embodiment of the present invention has a tapered cylindrical (linear) shape such that the outer diameter at one end in the axial direction is smaller and the outer diameter at the other end is larger. To be specific, the light guiding member 11e has a shape such that its surface areas per unit length become larger by degrees from the one end in the axial direction to the other end, and is substantially oval in cross section (see especially FIG. 12C). The light guiding member 11e includes a through-hole 111e inside that runs from the one end to the other end in the axial direction. The internal diameter of the through-hole 111e is same as that of the through-hole 111a of the light guiding member 11a used in the light source 1a according to the first preferred embodiment of the present invention. In addition, the length in the axial direction of the light guiding member 11e is same as that of the light guiding member 11a used in the light source 1a according to the first preferred embodiment of the present invention. In FIGS. 12A, 12B and 13, shown is the configuration of the light guiding member 11e having the length in the axial direction that is set to be about half the length in the axial direction of the tube body 21 of the fluorescent lamp 2.

As shown in FIG. 13, the tube body 21 of the fluorescent lamp 2 is inserted in the through-hole 111e of the light guiding member 11e, where the light guiding member 11e is attached at a section closer to one end in the axial direction of the tube body 21 of the fluorescent lamp 2. To be specific, the light guiding member 11e is attached such that its one end of which the outer diameter is larger is disposed close to the one end (close to the discharging electrode 222 at the one end) of the fluorescent lamp 2. Thus, the light guiding member 11e is attached on the outer surface of the tube body 21 of the fluorescent lamp 2 at a section from the one end to the center in the axial direction of the tube body 21.

Consequently, the same action and effect as those obtained by the light source 1b according to the second preferred embodiment of the present invention can be obtained by the light source 1e according to the fifth preferred embodiment of the present invention.

The light sources 1e according to the fifth preferred embodiment of the present invention are incorporated to be used in a light source device having a same configuration as the light source device 3c according to the third preferred embodiment of the present invention. In other words, the light source device including the light sources 1e has a configuration such that the light sources 1d according to the fourth preferred embodiment of the present invention are replaced with the light sources 1e according to the fifth preferred embodiment of the present invention in the light source device 3c according to the third preferred embodiment of the present invention. The light source device including the light sources 1e has other configurations, which are same as the light source device 3c according to the third preferred embodiment of the present invention, such that alternating-current voltages are applied to the discharging electrodes 221 at the one ends of the light sources 1e closer to the sections where the light guiding members 11d are not attached while the discharging electrodes 222 at the other ends closer to the sections where the light guiding members 11d are attached are grounded, and such that the light guiding members 11e substantially oval in cross section are disposed such that the longer axial directions of the oval shapes are substantially parallel to the plane direction of the optical sheets 35.

Consequently, the same action and effect as those obtained by the light source device including the light sources 1b according to the second preferred embodiment of the present invention can be obtained by the light source device including the light sources 1e according to the fifth preferred embodiment of the present invention. Further, the same action and effect as those obtained by the light source device 3c according to the third preferred embodiment of the present invention can be obtained by the light source device including the light sources 1e according to the fifth preferred embodiment of the present invention.

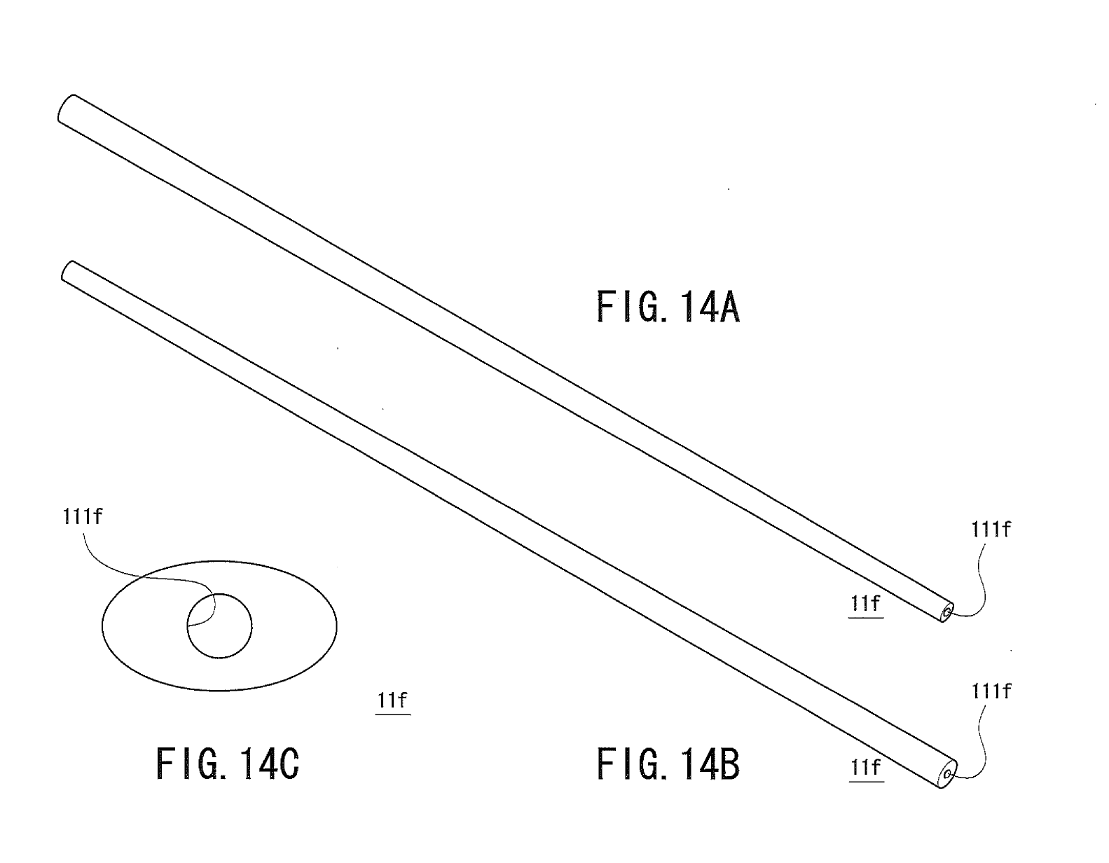

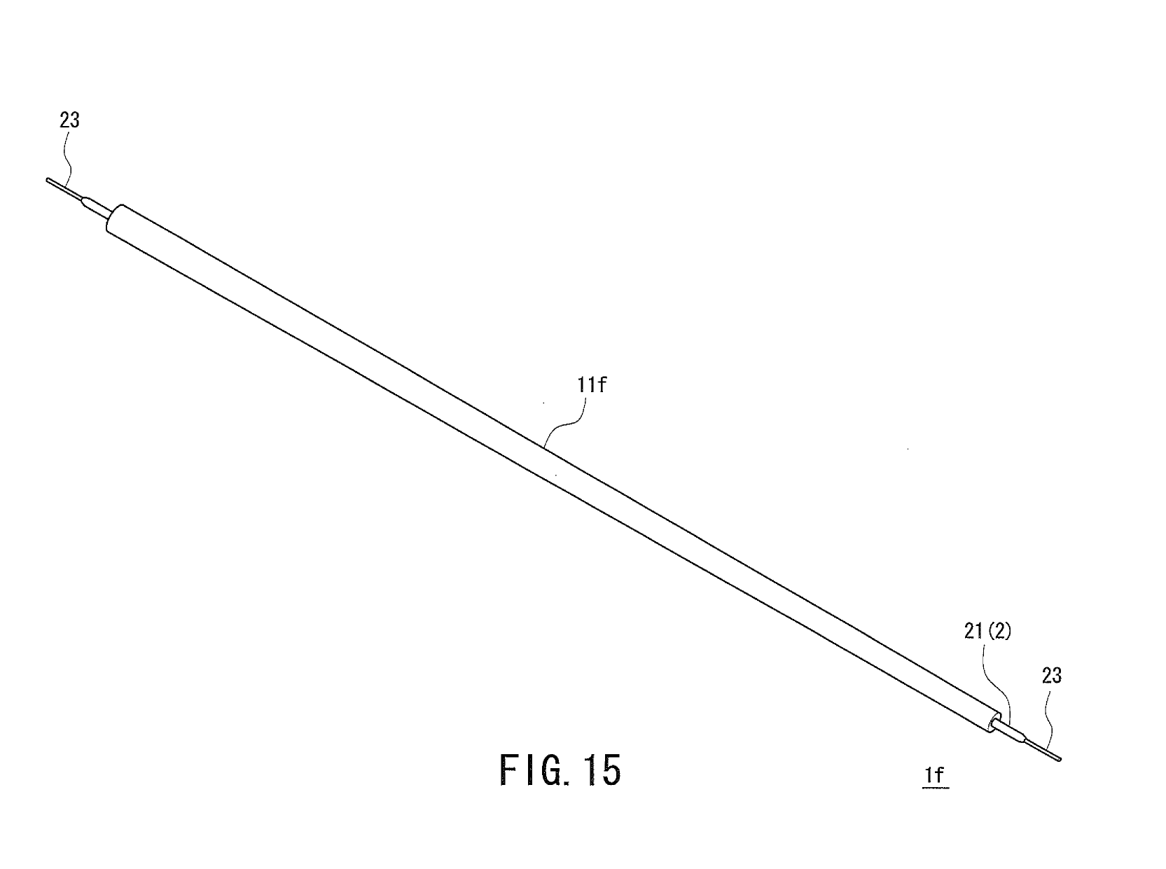

Next, a description of a light source 1f according to a sixth preferred embodiment of the present invention will be provided. FIGS. 14A, 14B and 14C are views showing a schematic configuration of a light guiding member 11f used for the light source 1f according to the sixth preferred embodiment of the present invention, where FIG. 14A is an external perspective view showing the light guiding member 11f seen from the side of its one end, FIG. 14B is an external perspective view showing the light guiding member 11f seen from the side of the other end, and FIG. 14C is a cross-sectional view of the light guiding member 11f. FIG. 15 is an external perspective view showing a schematic configuration of the light source 11f according to the sixth preferred embodiment of the present invention.

As shown in FIGS. 14A and 14B, the light guiding member 11f used for the light source 1f according to the sixth preferred embodiment of the present invention has a tapered cylindrical (linear) shape such that the outer diameter at one end in an axial direction is smaller and the outer diameter at the other end is larger. To be specific, the light guiding member 11f has a shape such that its surface areas per unit length become larger by degrees from the one end in the axial direction to the other end, and is substantially oval in cross section (see especially FIG. 14C). The light guiding member 11f includes a through-hole 111f inside that runs from the one end to the other end in the axial direction. The internal diameter of the through-hole 111f is same as that of the through-hole 111a of the light guiding member 11a used in the light sources 1a according to the first preferred embodiment of the present invention. In addition, the length in the axial direction of the light guiding member 11f is substantially same or slightly shorter than the length in the axial direction of the tube body 21 of the fluorescent lamp 2. In FIGS. 14A, 14B and 15, shown is the configuration of the light guiding member 11f having the length in the axial direction that is set to be slightly shorter than the length in the axial direction of the tube body 21 of the fluorescent lamp 2.

As shown in FIG. 15, the tube body 21 of the fluorescent lamp 2 is inserted in the through-hole 111f of the light guiding member 11f, whereby the light guiding member 11f is attached on the outer surface of the tube body 21 of the fluorescent lamp 2. When the light guiding member 11f has the length substantially same as the length in the axial direction of the tube body 21 of the fluorescent lamp 2, the outer surface of the tube body 21 of the fluorescent lamp 2 is covered throughout its substantial length with the light guiding member 11f. When the light guiding member 11f has the length slightly shorter than the length in the axial direction of the tube body 21 of the fluorescent lamp 2, the outer surface of the tube body 21 of the fluorescent lamp 2 is covered with the light guiding member 11f such that both the ends of the tube body 21 of the fluorescent lamp 2 protrude through the light guiding member 11f.

The light source 1f according to the sixth preferred embodiment of the present invention has a light emission area that becomes larger by degrees from one end in the axial direction to the other end. Consequently, the same action and effect as those obtained by the light source 1c according to the third preferred embodiment of the present invention can be obtained by the light source 1f according to the sixth preferred embodiment of the present invention.

The light sources 1f according to the sixth preferred embodiment of the present invention are incorporated to be used in a light source device having a same configuration as the light source device 3b according to the second preferred embodiment of the present invention. In other words, the light source device including the light sources 1f has a configuration such that the light sources 1c according to the third preferred embodiment of the present invention are replaced with the light sources 1f according to the sixth preferred embodiment of the present invention in the light source device 3b according to the second preferred embodiment of the present invention (see FIG. 8).

The light source device including the light sources 1f has other configurations, which are same as the light source device 3b according to the second preferred embodiment of the present invention, such that the light sources 1f are oriented in a direction, and such that alternating-current voltages are applied to the discharging electrodes 221 at the one ends of the light sources 1f closer to the smaller diameter ends of the light guiding members 11f while the discharging electrodes 222 at the other ends of the light sources 1f closer to the larger diameter ends of the light guiding members 11f are grounded. In addition, the light source device including the light sources 1f has another configuration, which is same as the light source device 3c according to the third preferred embodiment of the present invention, such that the light guiding members 11f substantially oval in cross section are disposed such that the longer axial directions of the oval shapes are substantially parallel to the plane direction of the optical sheets 35 (see FIG. 11).

Consequently, the same action and effect as those obtained by the light source device 3b according to the second preferred embodiment of the present invention can be obtained by the light source device including the light sources 1f according to the sixth preferred embodiment of the present invention. Further, the same action and effect as those obtained by the light source device 3c according to the third preferred embodiment of the present invention can be obtained by the light source device including the light sources 1f according to the sixth preferred embodiment of the present invention.

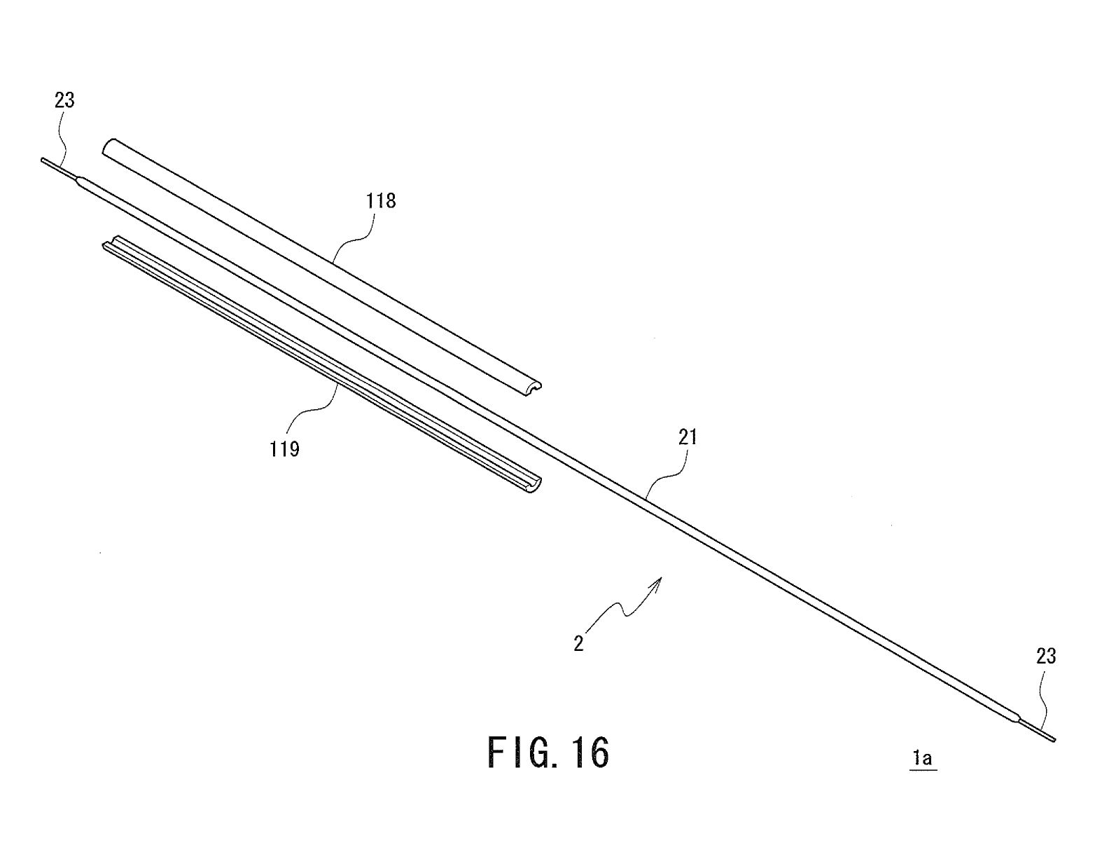

It is also preferable that each of the light guiding members used in the light sources according to the preferred embodiments of the present invention consists of two or more components. FIG. 16 is an exploded perspective view showing the schematic configuration of the light source 1a according to the first preferred embodiment of the present invention, where the light guiding member 11a consists of two components. As shown in FIG. 16, the light guiding member 11a consists of two components 118 and 119. Each of the components 118 and 119 has a substantially half round shape in cross section, and includes a groove in its axial direction that has a substantially half round shape in cross section and a configuration such that that the tube body 21 of the fluorescent lamp 2 is inserted therein. The components 118 and 119 are attached to the tube body 21 of the fluorescent lamp 2 so as to sandwich them. The same action and effect as those obtained by the light guiding members of monolithic constructions can be obtained also by the light guiding member 11a consisting or the two components 118 and 119.

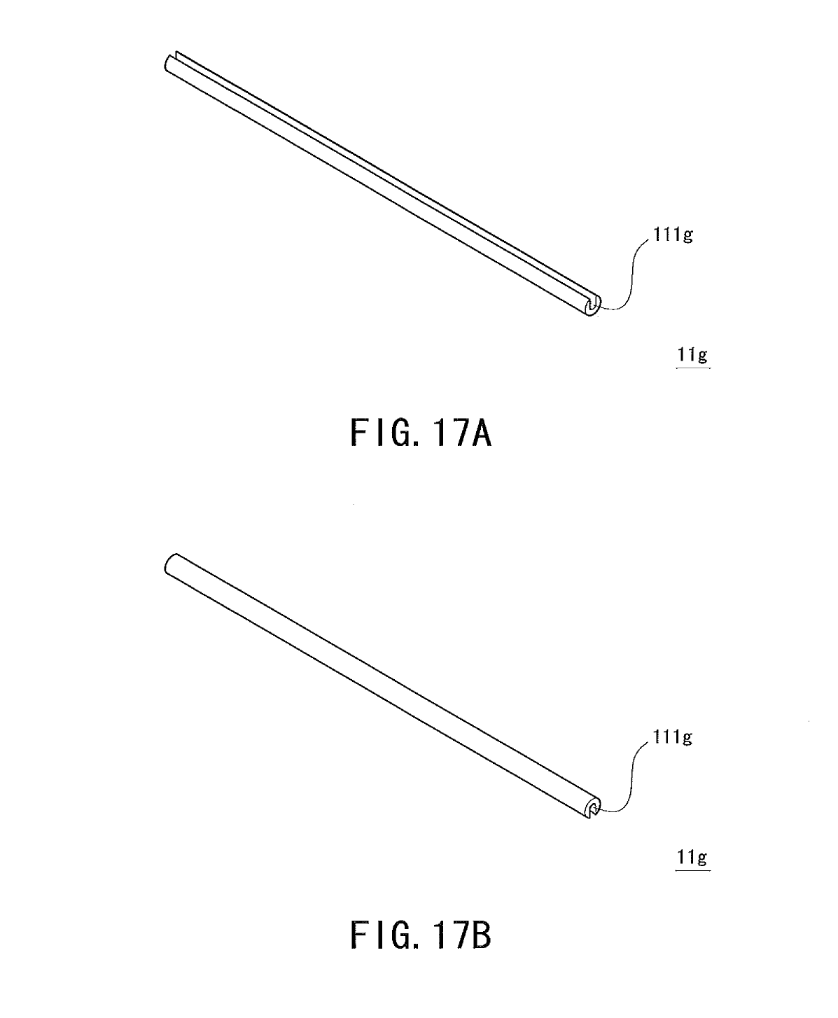

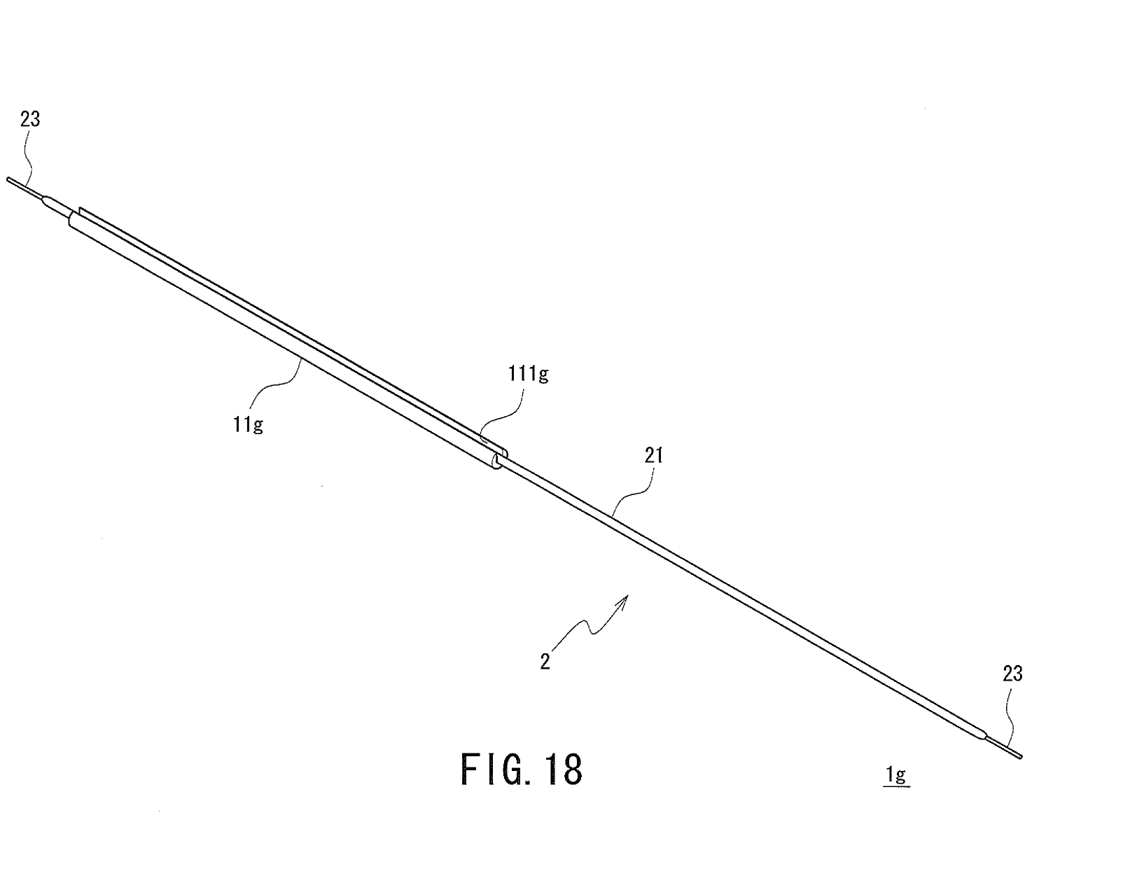

Next, a description of a light source 1g according to a seventh preferred embodiment of the present invention will be provided. FIGS. 17A and 17B are external perspective views showing a schematic configuration of a light guiding member 11g used for the light source 1g according to the seventh preferred embodiment of the present invention, where shown in FIG. 17A is the light guiding member 11g seen from one lateral side around the light guiding member 11g, and shown in FIG. 17B is the light guiding member 11g seen from the opposite lateral side. The light source 1g according to the seventh preferred embodiment of the present invention includes the fluorescent lamp 2 and the light guiding member 11g as shown in FIGS. 17A, 17B and 18.

As shown in FIGS. 17A and 17B, the light guiding member 11g has a rod (linear) shape and is substantially round in cross section. A groove 111g is provided on the outer surface of the light guiding member 11g along an axial direction throughout the length of the light guiding member 11g. The groove 111g has a configuration such that the tube body 21 of the fluorescent lamp 2 is inserted therein. In other words, the light guiding member 11g has the shape of the letter “C” or the letter “U” in cross section. The length in the axial direction of the light guiding member 11g is same as that of the light guiding member 11a used in the light source 1a according to the first preferred embodiment of the present invention. The groove 111g has a size and shape such that the tube body 21 of the fluorescent lamp 2 is brought to a center portion in cross section of the light guiding member 11g while an inner surface of the groove 111g is brought into substantially intimate contact with the outer surface of the tube body 21 of the fluorescent lamp 2 when the tube body 21 is inserted in the groove 111g.

As shown in FIG. 18, the tube body 21 of the fluorescent lamp 2 is inserted in the groove 111g of the light guiding member 11g, where the light guiding member 11g is attached at a section closer to one end of the tube body 21 of the fluorescent lamp 2. To be specific, the light guiding member 11g is attached such that its one end in the axial direction is disposed close to the discharging electrode 222 of the fluorescent lamp 2 (i.e., close to the one end of the tube body 21).

The same action and effect as those obtained by the light source 1a according to the first preferred embodiment of the present invention can be obtained by the light source 1g according to the seventh preferred embodiment of the present invention. In addition, because the light guiding member 11g has the configuration to be attached to the tube body 21 from the lateral side thereof, the attachment of the light guiding member 11g is easy. In addition, if the light guiding member 11g is made elastically deformable to have the tube body 21 of the fluorescent lamp 2 elastically held inside the groove 111g, the inner surface of the groove 111g is brought into substantially intimate contact with the outer surface of the tube body 21 of the fluorescent lamp 2. Thus, the light the fluorescent lamp 2 emits can be directly transmitted to the light guiding member 11g, which can easily prevent or minimize the loss of the light between the outer surface of the tube body 21 of the fluorescent lamp 2 and the inner surface of the groove 111g.

The light sources 1g according to the seventh preferred embodiment of the present invention are incorporated to be used in a light source device having a same configuration as the light source device 3a according to the first preferred embodiment of the present invention. In other words, the light source device including the light sources 1g has a configuration such that the light sources 1a according to the first preferred embodiment of the present invention are replaced with the light sources 1g according to the seventh preferred embodiment of the present invention in the light source device 3a according to the first preferred embodiment of the present invention. Consequently, the same action and effect as those obtained by the light source device 3a according to the first preferred embodiment of the present invention can be obtained by the light source device including the light sources 1g according to the seventh preferred embodiment of the present invention.

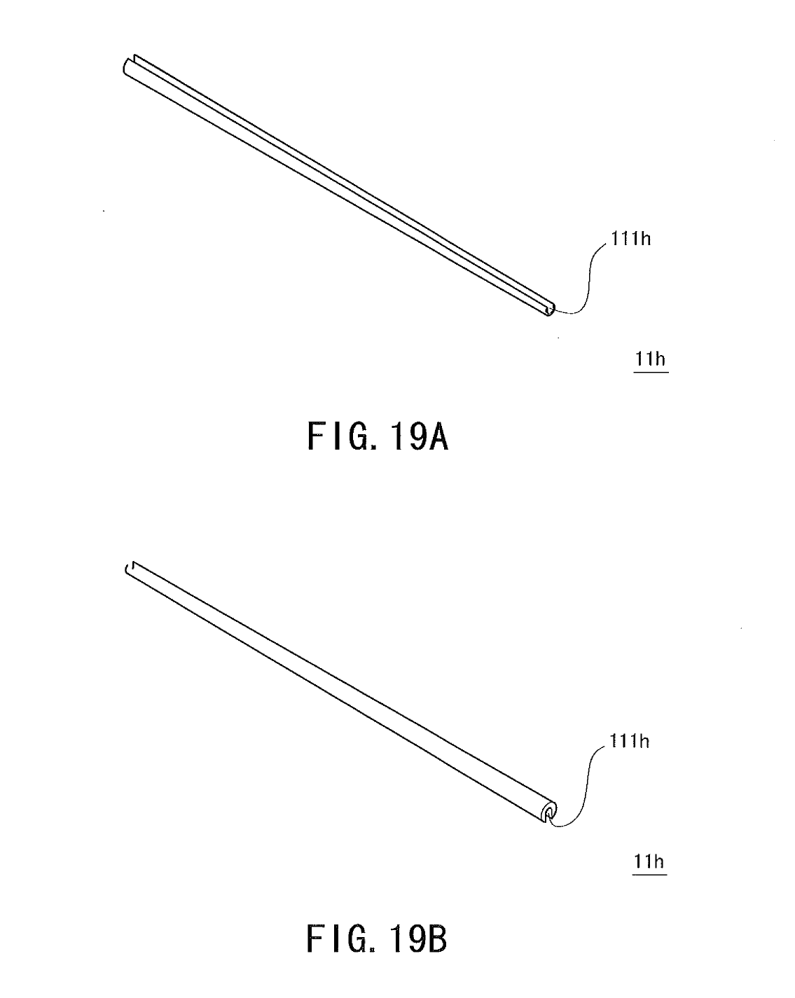

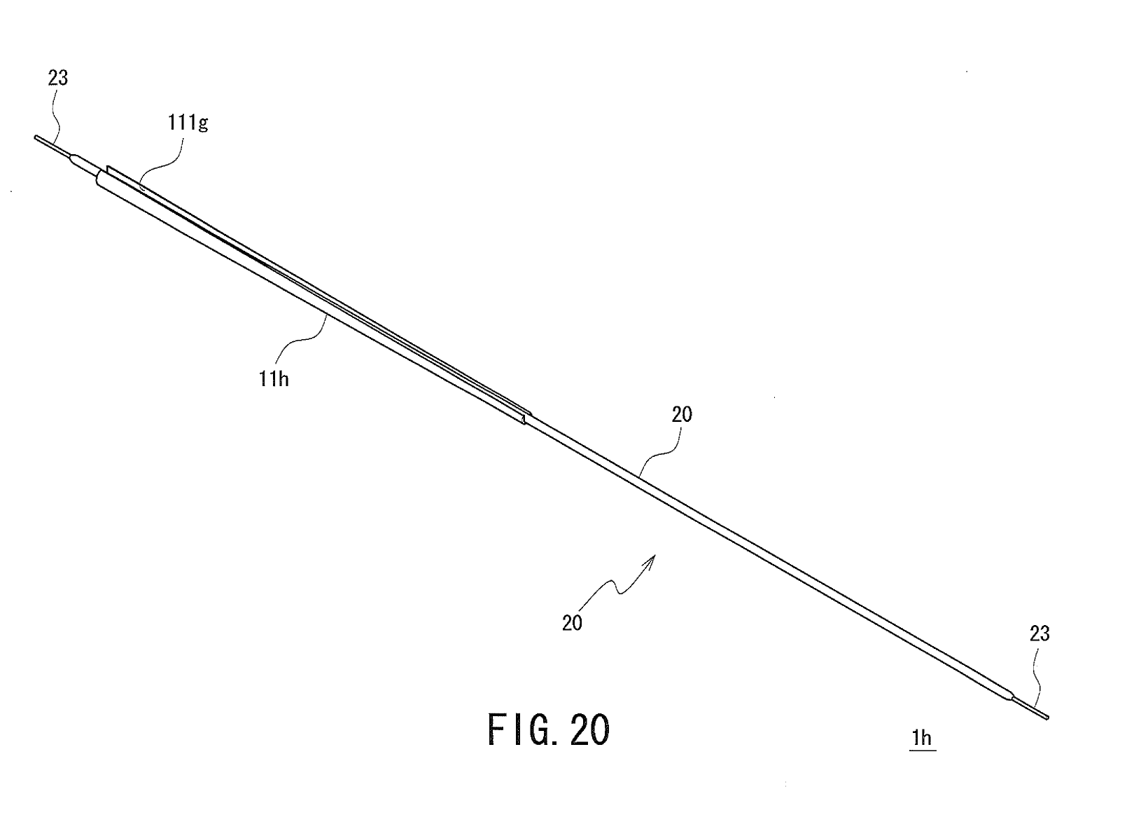

Next, a description of a light source 1h according to an eighth preferred embodiment of the present invention will be provided. FIGS. 19A and 19B are external perspective views showing a schematic configuration of a light guiding member 11h used for the light source 1h according to the eighth preferred embodiment of the present invention, where shown in FIG. 19A is the light guiding member 11h seen from the side of its one end in an axial direction, and shown in FIG. 19B is the light guiding member 11h seen from the side of the other end. FIG. 20 is an external perspective view showing a schematic configuration of the light source 1h according to the eighth preferred embodiment of the present invention.

As shown in FIGS. 19A and 19B, the light guiding member 11h has a tapered rod (linear) shape such that the outer diameter at one end in the axial direction is smaller and the outer diameter at the other end is larger. To be specific, the light guiding member 11h has a shape such that its surface areas per unit length become larger by degrees from the one end in the axial direction to the other end. A groove 111h is provided on the outer surface of the light guiding member 11h along the axial direction throughout the length of the light guiding member 11h. The groove 111h has a configuration such that the tube body 21 of the fluorescent lamp 2 is inserted therein. In other words, the light guiding member 11h has the shape of the letter “C” or the letter “U” in cross section. The size and shape of the groove 111h are same as those of the groove 111g of the light guiding member 11g of the light source 1g according to the seventh preferred embodiment of the present invention. The length in the axial direction of the light guiding member 11h is same as that of the light guiding member 11a used in the light source 1a according to the first preferred embodiment of the present invention.

As shown in FIG. 20, the tube body 21 of the fluorescent lamp 2 is inserted in the groove 111h of the light guiding member 11h, where the light guiding member 11h is attached on the outer surface at a section closer to one end in the axial direction of the tube body 21 of the fluorescent lamp 2. To be specific, the light guiding member 11h is attached such that its one end of which the outer diameter is larger is disposed close to the discharging electrode 222 of the fluorescent lamp 2 (i.e., close to the one end of the tube body 21), similarly to the light source 1b according to the second preferred embodiment of the present invention.

The same action and effect as those obtained by the light source 1b according to the second preferred embodiment of the present invention can be obtained by the light source 1h according to the eighth preferred embodiment of the present invention. In addition, because, similarly to the light source 1g according to the seventh prefer red embodiment of the present invention, the light guiding member 11h has the configuration to be attached to the tube body 21 from the lateral side thereof, the attachment of the light guiding member 11h is easy.

The light sources 1h according to the eighth preferred embodiment of the present invention are incorporated to be used in a light source device having a same configuration as the light source device 3a according to the first preferred embodiment of the present invention. In other words, the light source device including the light sources 1h has a configuration such that the light sources 1a according to the first preferred embodiment of the present invention are replaced with the light sources 1h according to the eighth preferred embodiment of the present invention in the light source device 3a according to the first preferred embodiment of the present invention. The light sources 1h are oriented in a direction. Alternating-current voltages are applied to the discharging electrodes 221 at the one ends of the light sources 1h closer to the sections where the light guiding members 11h are not attached while the discharging electrodes 222 at the other ends closer to the sections where the light guiding members 11h are attached are grounded

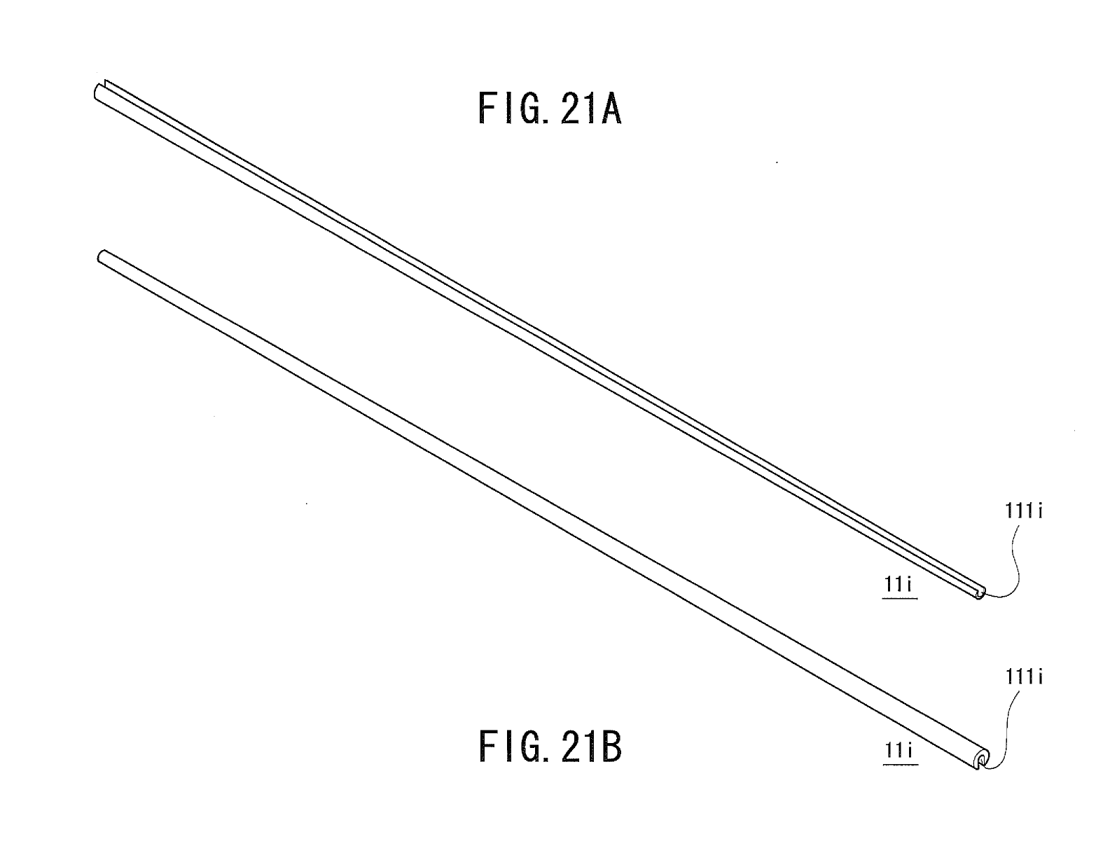

Next, a description of a light source 1i according to a ninth preferred embodiment of the present invention will be provided. FIGS. 21A and 21B are external perspective views showing a schematic configuration of a light guiding member 11i used for the light source 1i according to the ninth preferred embodiment of the present invention, where shown in FIG. 21A is the light guiding member 11i seen from the side of its one end in an axial direction, and shown in FIG. 21B is the light guiding member 11i seen from the side of the other end.

As shown in FIGS. 21A and 21B, the light guiding member 11i has a tapered rod (linear) shape such that the outer diameter at one end in the axial direction is smaller and the outer diameter at the other end is larger. The length in the axial direction of the light guiding member 11i is substantially same or slightly shorter than the length in the axial direction of the tube body 21 of the fluorescent lamp 2. A groove 111i is provided on the outer surface of the light guiding member 11i along the axial direction throughout the length of the light guiding member 11i. The groove 111i has a configuration such that the tube body 21 of the fluorescent lamp 2 is inserted therein. The size and shape of the groove 111i are same as those of the groove 111g of the light guiding member 11g of the light source 1g according to the seventh preferred embodiment of the present invention.

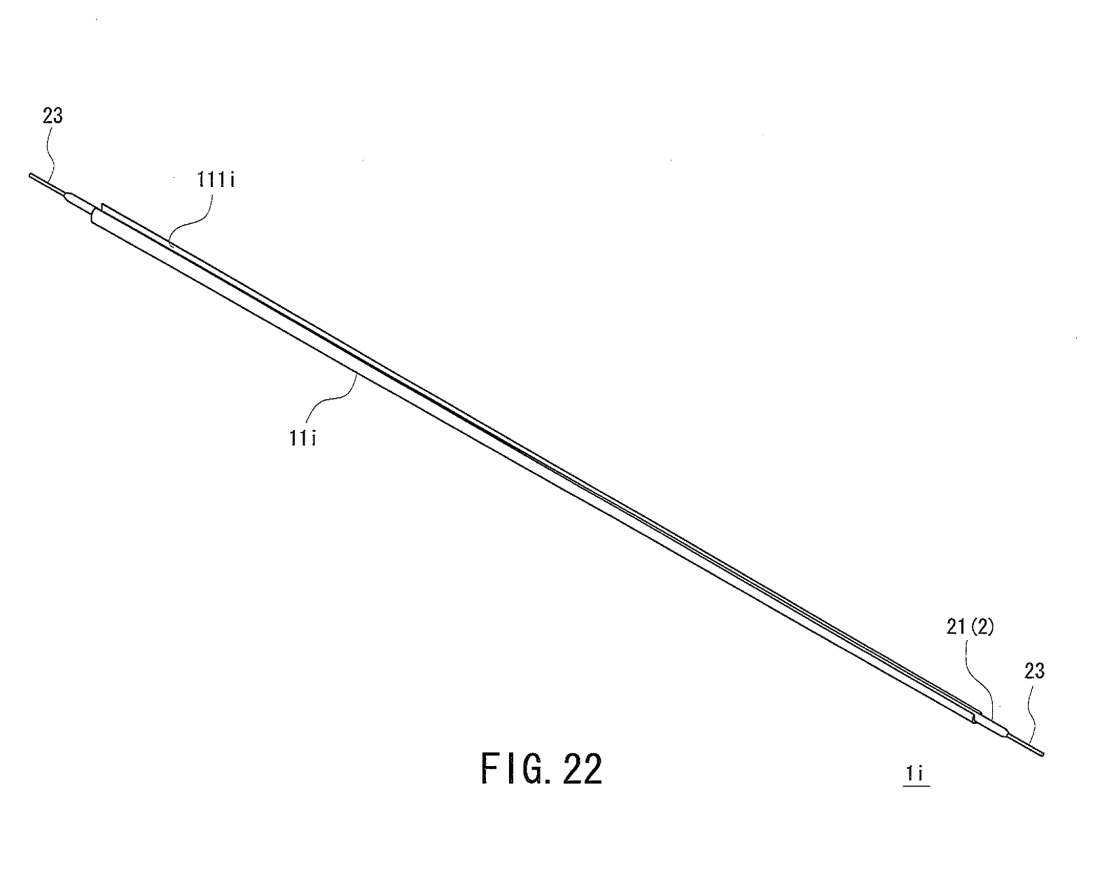

As shown in FIG. 22, the tube body 21 of the fluorescent lamp 2 is inserted in the through-hole 111i of the light guiding member 11i, whereby the light guiding member 11i is attached on the outer surface of the tube body 21 of the fluorescent lamp 2. When the light guiding member 11i has the length substantially same as the length in the axial direction of the tube body 21 of the fluorescent lamp 2, the outer surface of the tube body 21 of the fluorescent lamp 2 is covered throughout its substantial length with the light guiding member 111. When the light guiding member 11i has the length slightly shorter than the length in the axial direction of the tube body 21 of the fluorescent lamp 2, the outer surface of the tube body 21 of the fluorescent lamp 2 is covered with the light guiding member 11i such that both the ends of the tube body 21 of the fluorescent lamp 2 protrude through the light guiding member 11i.

The light source 1i according to the ninth preferred embodiment of the present invention has a light emission area that becomes larger by degrees from one end in the axial direction to the other end. Consequently, the same action and effect as those obtained by the light source 1c according to the third preferred embodiment of the present invention can be obtained by the light source 1i according to the ninth preferred embodiment of the present invention.

The light sources 1i according to the ninth preferred embodiment of the present invention are incorporated to be used in a light source device having a same configuration as the light source device 3b according to the second preferred embodiment of the present invention. In other words, the light source device including the light sources 1i has a configuration such that the light sources 1c according to the third preferred embodiment of the present invention are replaced with the light sources 1i according to the ninth preferred embodiment of the present invention in the light source device 3b according to the second preferred embodiment of the present invention. Consequently, the same action and effect as those obtained by the light source device 3b according to the second preferred embodiment of the present invention can be obtained by the light source device including the light sources 1i according to the ninth preferred embodiment of the present invention.

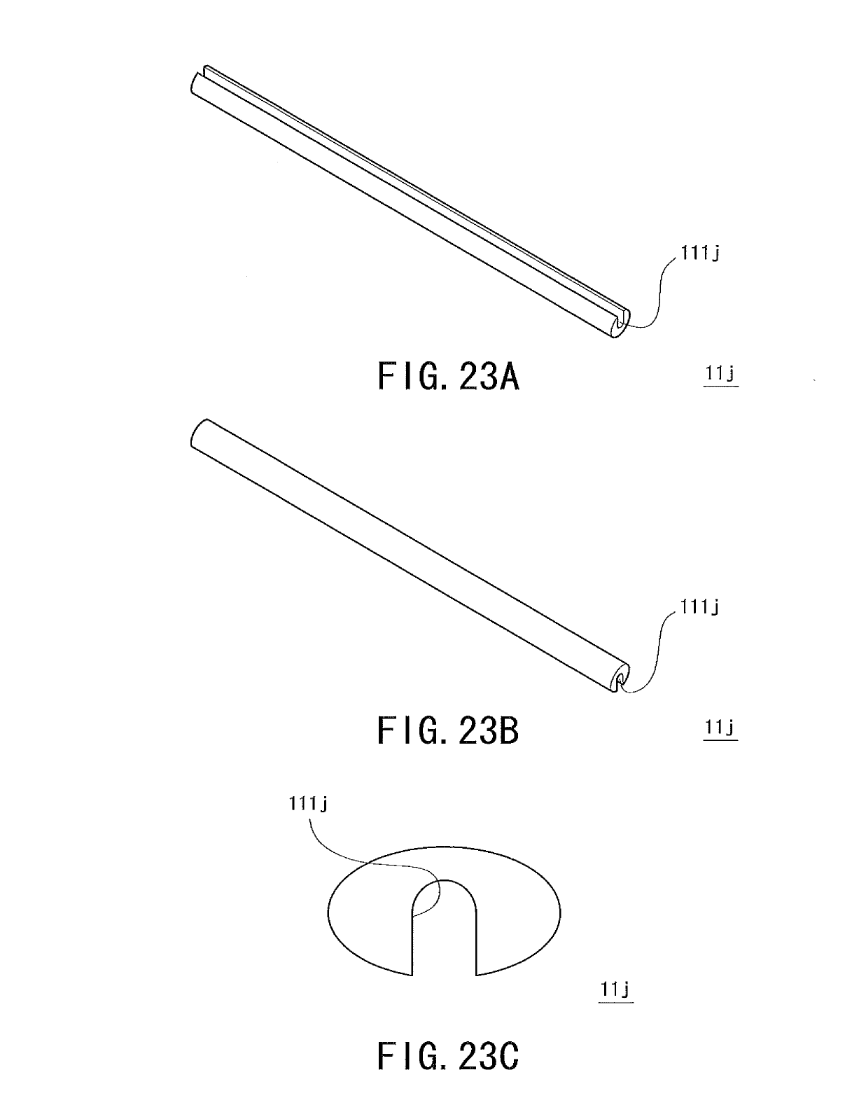

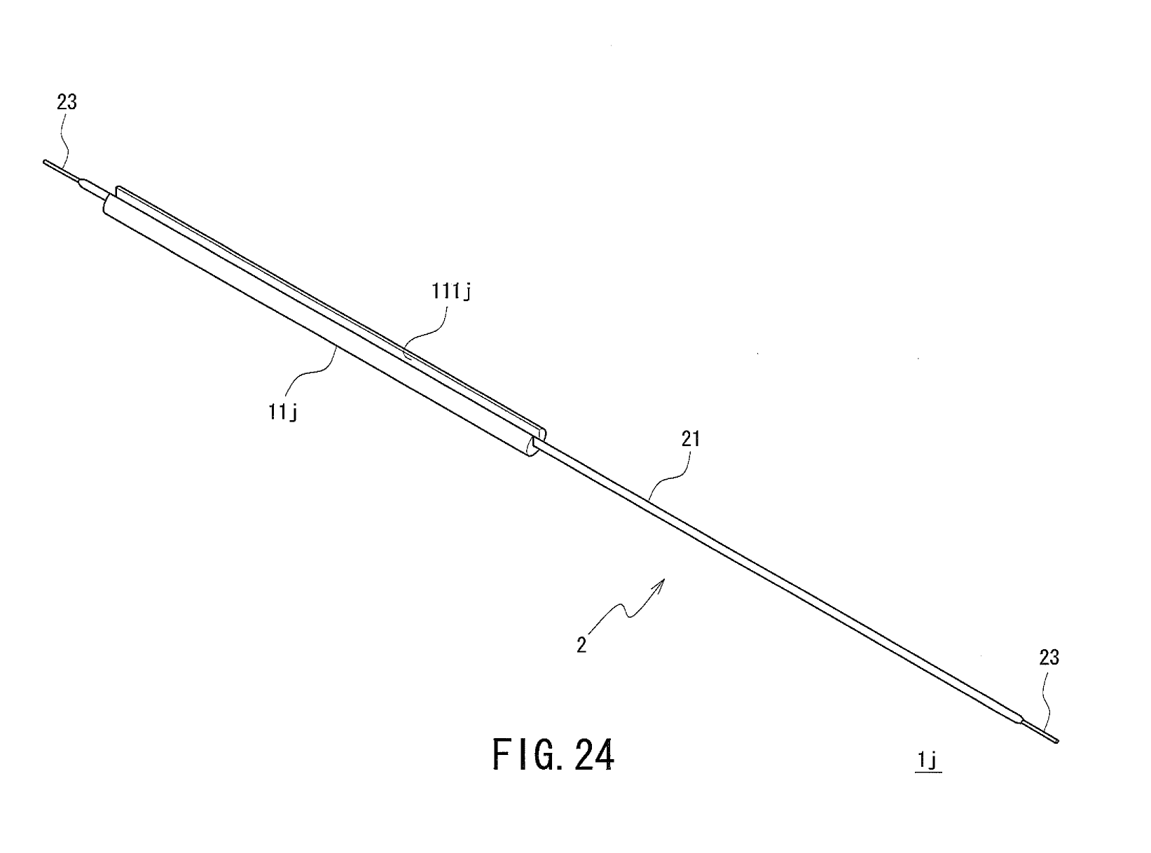

Next, a description of a light source 1j according to a tenth preferred embodiment of the present invention will be provided. FIGS. 23A, 23B and 23C are views showing a schematic configuration of a light guiding member 11j used for the light source 1j according to the tenth preferred embodiment of the present invention, where FIG. 23A is an external perspective view showing the light guiding member 11j seen from the side of its one end in an axial direction, FIG. 23B is an external perspective view showing the light guiding member 11j seen from the side of the other end, and FIG. 23C is a cross-sectional view of the light guiding member 11j. FIG. 24 is an external perspective view showing a schematic configuration of the light source 1j according to the tenth preferred embodiment of the present invention. The light source 1j according to the tenth preferred embodiment of the present invention includes the light guiding member 11j and the fluorescent lamp 2 as shown in FIGS. 23A, 23B and 24.

As shown in FIGS. 23A, 23B and 23C, the light guiding member 11j has a rod (linear) shape and is substantially oval in cross section. The length in the axial direction of the light guiding member 11j is same as that of the light guiding member 11a used in the light source 1a according to the first preferred embodiment of the present invention. A groove 111j is provided on the outer surface of the light guiding member 11j along the axial direction. Thus, the light guiding member 11j has the shape of the letter “C” or the letter “U” in cross section. The size and shape of the groove 111j are same as those of the groove 111g of the light guiding member 11g of the light source 1g according to the seventh preferred embodiment of the present invention.

As shown in FIG. 24, the tube body 21 of the fluorescent lamp 2 is inserted in the groove 111j of the light guiding member 11j, where the light guiding member 11j is attached at a section closer to one end in the axial direction of the tube body 21 of the fluorescent lamp 2, similarly to the light source 1a according to the first preferred embodiment of the present invention.

With this configuration, the light emission area can be increased at the section closer to the one end of the tube body 21 of the fluorescent lamp 2. Thus, the same action and effect as those obtained by the light source 1a according to the first preferred embodiment of the present invention can be obtained by the light source 1j according to the tenth preferred embodiment of the present invention. In addition, because the light guiding member 11j has the configuration to be attached to the tube body 21 from the lateral side thereof, the attachment of the light guiding member 11j is easy.

The light sources 1j according to the tenth preferred embodiment of the present invention are incorporated to be used in a light source device having a same configuration as the light source device 3c according to the third preferred embodiment of the present invention. In other words, the light source device including the light sources 1j has a configuration such that the light sources 1d according to the fourth preferred embodiment of the present invention are replaced with the light sources 1j according to the tenth preferred embodiment of the present invention in the light source device 3c according to the third preferred embodiment of the present invention. The light sources 1j are oriented in a direction. Alternating-current voltages are applied to the discharging electrodes 221 at the one ends of the light sources 1j closer to the sections where the light guiding members 11j are not attached while the discharging electrodes 222 at the other ends closer to the sections where the light guiding members 11j are attached are grounded. The light guiding members 11j substantially oval in cross section are disposed such that the longer axial directions of the oval shapes are substantially parallel to the plane direction of the optical sheets 35.

Consequently, the same action and effect as those obtained by the light source device 3c according to the third preferred embodiment of the present invention can be obtained by the light source device including the light sources 1j according to the tenth preferred embodiment of the present invention.

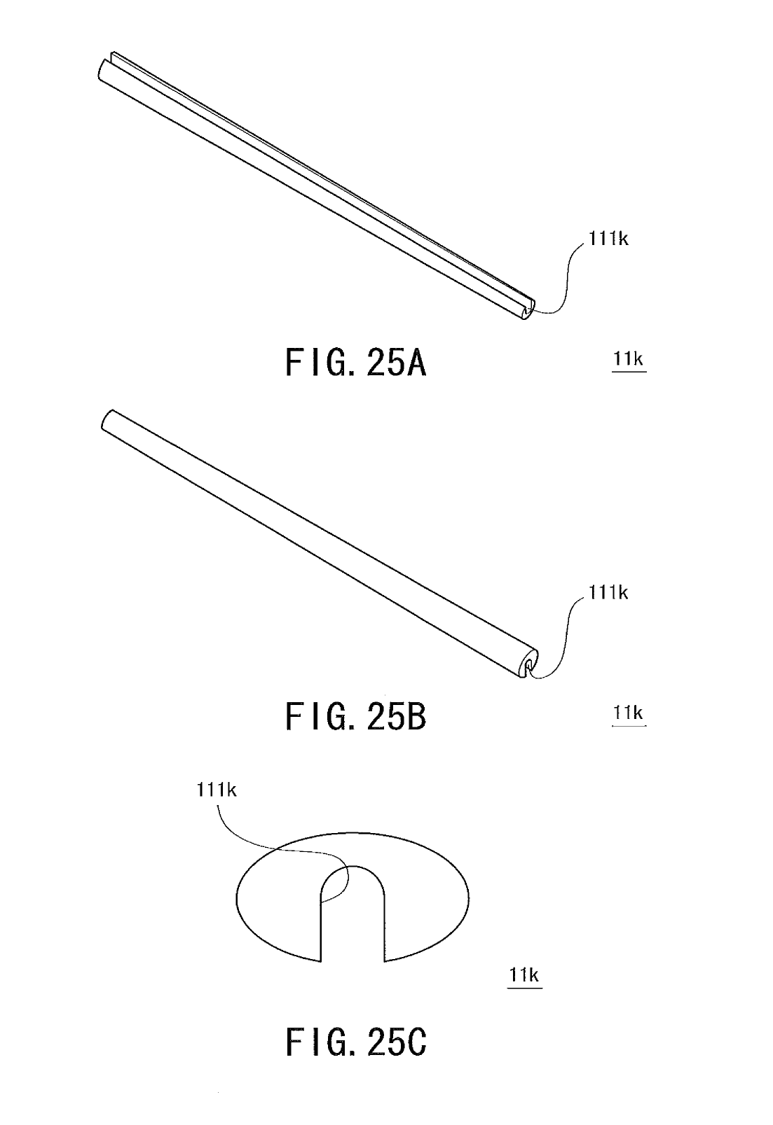

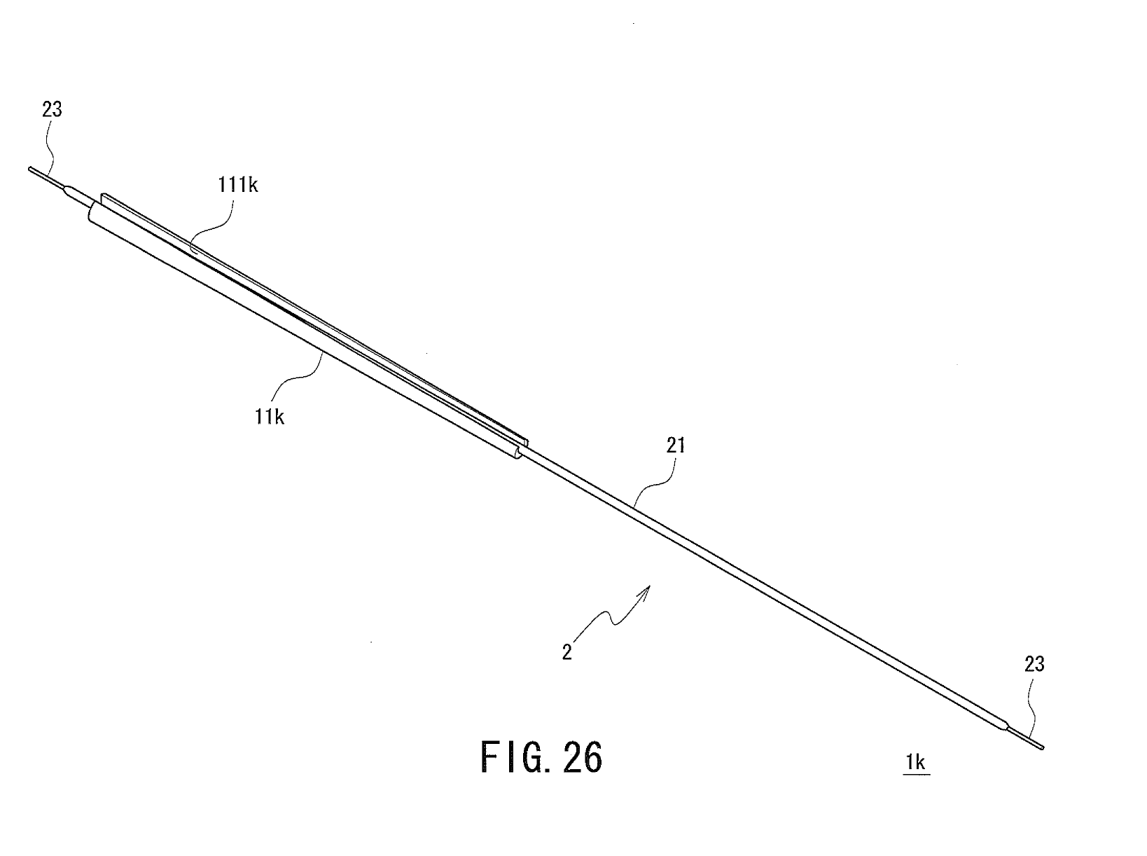

Next, a description of a light source 1k according to an eleventh preferred embodiment of the present invention will be provided. FIGS. 25A, 25B and 25C are views showing a schematic configuration of a light guiding member 11k used for the light source 1k according to the eleventh preferred embodiment of the present invention, where FIG. 25A is an external perspective view showing the light guiding member 11k seen from the side of its one end in an axial direction, FIG. 25B is an external perspective view showing the light guiding member 11k seen from the side of the other end, and FIG. 25C is a cross-sectional view of the light guiding member 11k according to the eleventh preferred embodiment of the present invention. FIG. 26 is an external perspective view showing a schematic configuration of the light source 1k according to the eleventh preferred embodiment of the present invention. The light source 1k according to the eleventh preferred embodiment of the present invention includes the light guiding member 11k and the fluorescent lamp 2 as shown in FIGS. 25A, 25B and 26.

As shown in FIGS. 25A and 25B, the light guiding member 11k has a tapered rod (linear) shape such that the outer diameter at one end in the axial direction is smaller and the outer diameter at the other end is larger. The length in the axial direction of the light guiding member 11k is same as that of the light guiding member 11a used in the light source 1a according to the first preferred embodiment of the present invention. In FIGS. 25A, 25B and 26, shown is the configuration of the light guiding member 11k having the length in the axial direction that is set to be about half the length in the axial direction of the tube body 21 of the fluorescent lamp 2. The light guiding member 11k is substantially oval in cross section (see especially FIG. 25C). A groove 111k is provided on the outer surface of the light guiding member 11k along the axial direction. The groove 111k has a configuration such that the tube body 21 of the fluorescent lamp 2 is inserted therein. The size and shape of the groove 111k are same as those of the groove 111g of the light guiding member 11g of the light source 1g according to the seventh preferred embodiment of the present invention. Thus, the light guiding member 11k has the shape of the letter “C” or the letter “U” in cross section.

As shown in FIG. 26, the tube body 21 of the fluorescent lamp 2 is inserted in the groove 111k of the light guiding member 11k, where the light guiding member 11k is attached at a section closer to one end in the axial direction of the tube body 21 of the fluorescent lamp 2. To be specific, the light guiding member 11k is attached such that its one end of which the outer diameter is larger is disposed close to the discharging electrode 222 of the fluorescent lamp 2 (i.e., close to the one end of the tube body 21).

The light source 1k according to the eleventh preferred embodiment of the present invention has a light emission area that becomes larger by degrees toward the one end of the tube body 21 of the fluorescent lamp 2 (i.e., toward the discharging electrode 222 at the one end) at the section where the light guiding member 11k is attached. Consequently, the same action and effect as those obtained by the light source 1b according to the second preferred embodiment of the present invention can be obtained by the light source 1k according to the eleventh preferred embodiment of the present invention.

The light sources 1k according to the eleventh preferred embodiment of the present invention are incorporated to be used in a light source device having a same configuration as the light source device 3c according to the third preferred embodiment of the present invention. In other words, the light source device including the light sources 1k has a configuration such that the light sources 1d according to the fourth preferred embodiment of the present invention are replaced with the light sources 1k according to the eleventh preferred embodiment of the present invention in the light source device 3c according to the third preferred embodiment of the present invention. The light sources 1k are oriented in a direction. Alternating-current voltages are applied to the discharging electrodes 221 at the one ends of the light sources 1k closer to the sections where the light guiding members 11k are not attached while the discharging electrodes 222 at the other ends closer to the sections where the light guiding members 11k are attached are grounded. The light guiding members 11k substantially oval in cross section are disposed such that the longer axial directions of the oval shapes are substantially parallel to the plane direction of the optical sheets 35. Consequently, the same action and effect as those obtained by the light source device 3c according to the third preferred embodiment of the present invention can be obtained by the light source device including the light sources 1k according to the eleventh preferred embodiment of the present invention.

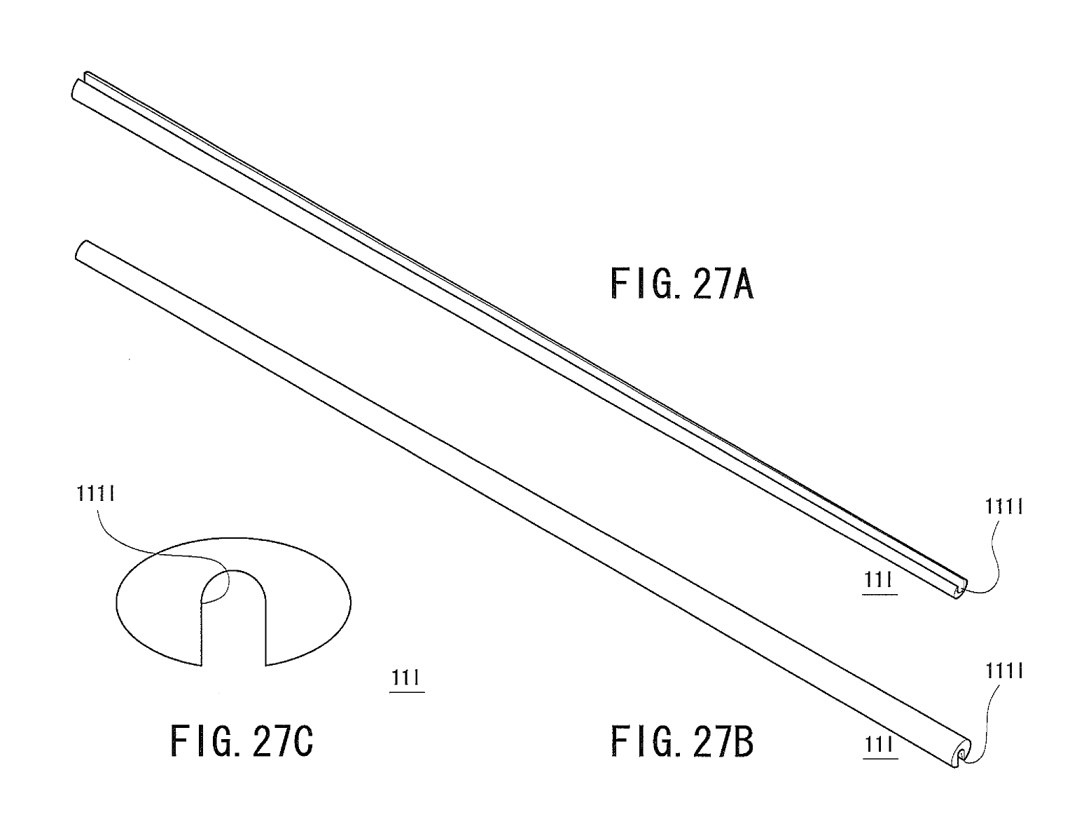

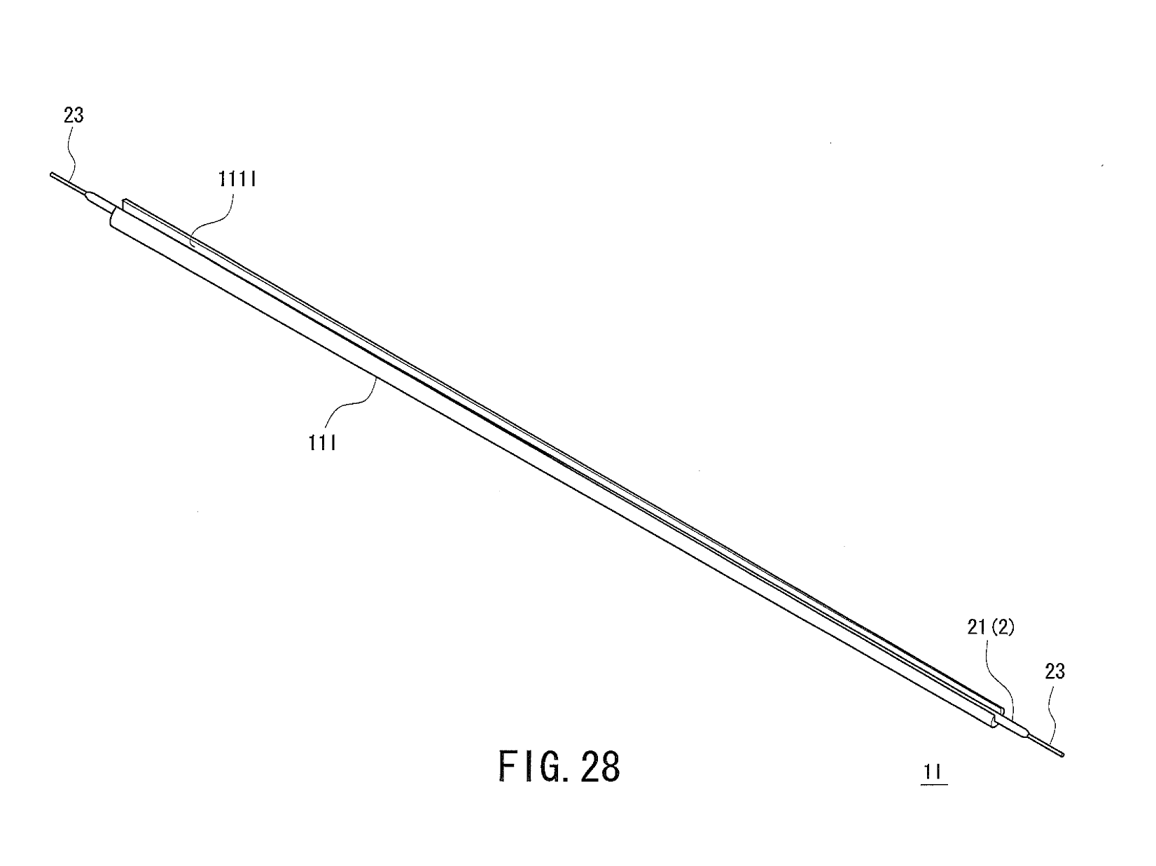

Next, a description of a light source 1l according to a twelfth preferred embodiment of the present invention will be provided. FIGS. 27A, 27B and 27C are views showing a schematic configuration of a light guiding member 111 used for the light source 1l according to the twelfth preferred embodiment of the present invention, where FIG. 27A is an external perspective view showing the light guiding member 11l seen from the side of its one end in an axial direction, FIG. 27B is an external perspective view showing the light guiding member 11l seen from the side of the other end, and FIG. 27C is a cross-sectional view of the light guiding member 11l according to the twelfth preferred embodiment of the present invention. FIG. 28 is an external perspective view showing a schematic configuration of the light source 1l according to the twelfth preferred embodiment of the present invention. The light source 1l according to the twelfth preferred embodiment of the present invention includes the light guiding member 11l and the fluorescent lamp 2 as shown in FIGS. 27A, 27B and 28.

As shown in FIGS. 27A and 27B, the light guiding member 11l has a tapered rod (linear) shape such that the outer diameter at one end in the axial direction is smaller and the outer diameter at the other end is larger. The length in the axial direction of the light guiding member 11l is substantially same or slightly shorter than the length in the axial direction of the tube body 21 of the fluorescent lamp 2. In FIGS. 27A, 27B and 28, shown is the configuration of the light guiding member 11l having the length in the axial direction that is set to be slightly shorter than the length in the axial direction of the tube body 21 of the fluorescent lamp 2.

The light guiding member 11l is substantially oval in cross section (see especially FIG. 27C). A groove 111l is provided on the outer surface of the light guiding member 11l along the axial direction. The groove 111l has a configuration such that the tube body 21 of the fluorescent lamp 2 is inserted therein. Thus, the light guiding member 11l has the shape of the letter “C” or the letter “U” in cross section. The size and shape of the groove 111l are same as those of the groove 111g of the light guiding member 11g of the light source 1g according to the seventh preferred embodiment of the present invention.

As shown in FIG. 28, the tube body 21 of the fluorescent lamp 2 is inserted in the through-hole 111l of the light guiding member 111, whereby the light guiding member 11l is attached on the outer surface of the tube body 21 throughout the length in the axial direction of the tube body 21 of the fluorescent lamp 2. When the light guiding member 11l has the length substantially same as the length in the axial direction of the tube body 21 of the fluorescent lamp 2, the outer surface of the tube body 21 of the fluorescent lamp 2 is covered throughout its substantial length with the light guiding member 111. When the light guiding member 11l has the length slightly shorter than the length in the axial direction of the tube body 21 of the fluorescent lamp 2, the outer surface of the tube body 21 of the fluorescent lamp 2 is covered with the light guiding member 11l such that both the ends of the tube body 21 of the fluorescent lamp 2 protrude through the light guiding member 111.

The light source 1l according to the twelfth preferred embodiment of the present invention has a light emission area that becomes larger by degrees from one end in the axial direction to the other end. Consequently, the same action and effect as those obtained by the light source 1c according to the third preferred embodiment of the present invention can be obtained by the light source 1l according to the twelfth preferred embodiment of the present invention.

The light sources 1l according to the twelfth preferred embodiment of the present invention are incorporated to be used in a light source device having a same configuration as the light source device 3b according to the second preferred embodiment of the present invention. In other words, the light source device including the light sources 1l has a configuration such that the light sources 1c according to the third preferred embodiment of the present invention are replaced with the light sources 1l according to the twelfth preferred embodiment of the present invention in the light source device 3b according to the second preferred embodiment of the present invention. The light sources 11 are oriented in a direction. The light guiding members 111 substantially oval in cross section are disposed such that the longer axial directions of the oval shapes are substantially parallel to the plane direction of the optical sheets 35. Alternating-current voltages are applied to the discharging electrodes 221 at the one ends of the light sources 1l closer to the smaller diameter ends of the light guiding members 111. Meanwhile, the discharging electrodes 222 at the other ends of the light sources 1l closer to the larger diameter ends of the light guiding members 11l are grounded.

Consequently, the same action and effect as those obtained by the light source device 3b according to the second preferred embodiment of the present invention can be obtained by the light source device including the light sources 1l according to the twelfth preferred embodiment of the present invention. In addition, the same action and effect as those obtained by the light source device 3c according to the third preferred embodiment of the present invention can be obtained by the light source device including the light sources 1l according to the twelfth preferred embodiment of the present invention.

The light sources 1a, 1b, 1c, 1d, 1e, 1f, 1g, 1h, 1i, 1j and 1k according to the preferred embodiments of the present invention described above each include the fluorescent lamps 2 including the linear-shaped tube bodies 21; however, they may each include florescent lamps including tube bodies that have a substantially U shape.

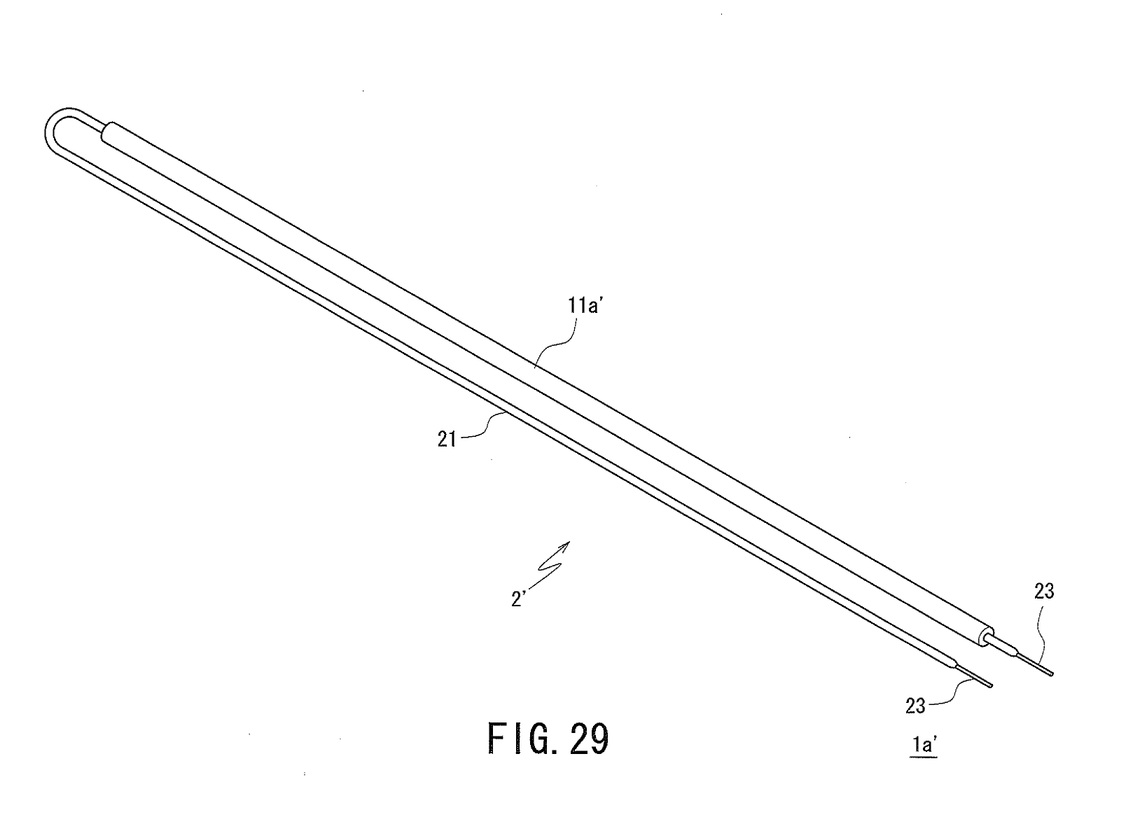

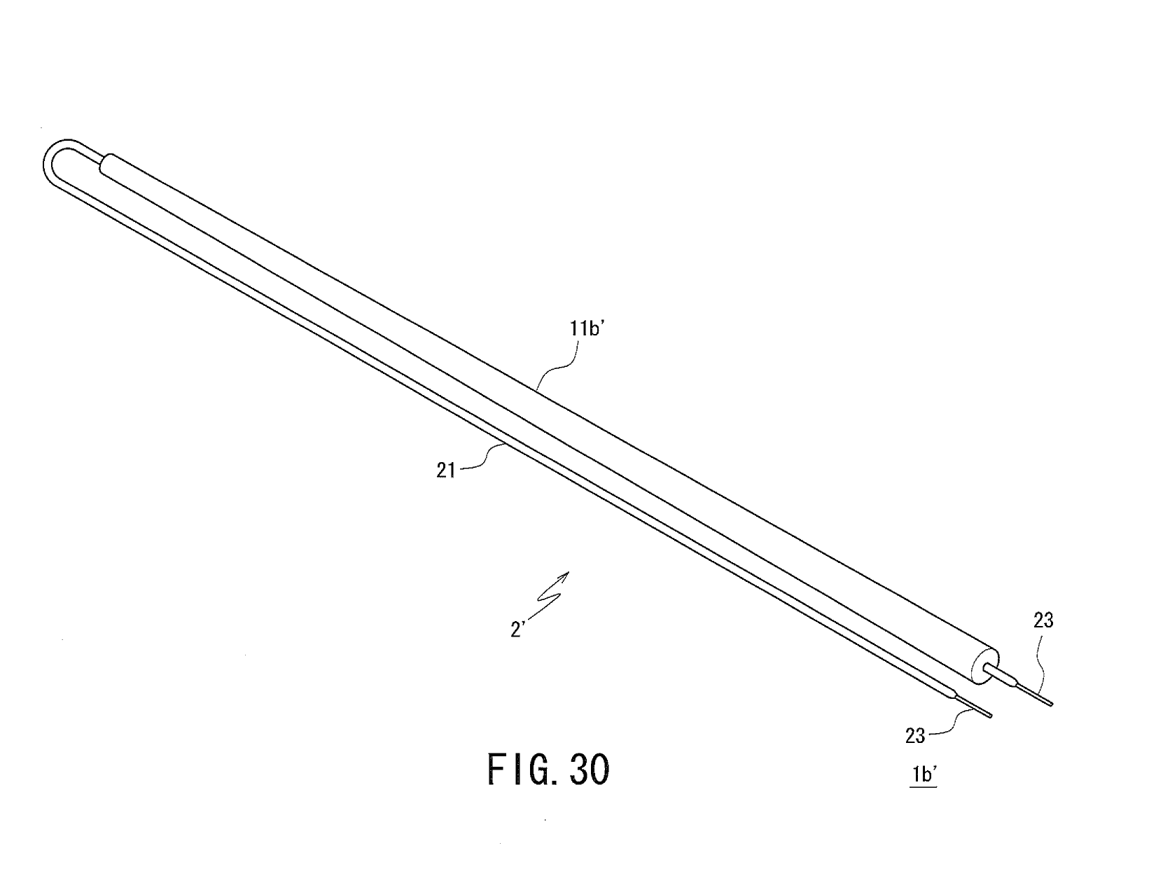

FIGS. 29 and 30 are external perspective views showing schematic configurations of light sources 1a′ and 1b′ including fluorescent lamps including tube bodies that have a substantially U shape. The light sources 1a′ and 1b′ each include the fluorescent lamps 2′ including the substantially U-shaped tube bodies, and light guiding members 11a′ and 11b′, respectively, as shown in FIGS. 29 and 30. A fluorescent lamp having a same configuration as the fluorescent lamp 2 of the light source 1a according to the first preferred embodiment of the present invention except the shape of the tube body 21 can be used as the fluorescent lamp 2′.

The light guiding member 11a′ of the light source 1a′ shown in FIG. 29 has a substantially same configuration as the light guiding member 11a of the light source 1a according to the first preferred embodiment of the present invention. To be specific, the light guiding member 11a′ has a linear (rod) shape and is substantially round in cross section. The light guiding member 11a′ includes a through-hole having a configuration such that the tube body 21 of the fluorescent lamp 2′ is inserted therein. The length in the axial direction of the light guiding member 11a′ is set to be about half or less than half the length in an axial direction of the tube body 21 of the fluorescent lamp 2′ (the length that would be obtained when the tube body 21 is brought into line). In other words, the length is set to be same or less than the length of the linear section of the tube body 21. Shown in FIG. 29 is a configuration such that the length is set to be about half the length in the axial direction of the tube body 21 (i.e., set to be substantially same as the length of the linear section of the tube body 21).

The light guiding member 11b′ of the light source 1b′ shown in FIG. 30 has a substantially same configuration as the light guiding member 11b of the light source 1b according to the second preferred embodiment of the present invention. To be specific, the light guiding member 11b′ has a linear shape and is substantially round in cross section. The light guiding member 11b′ has a tapered shape such that its surface areas (i.e., “outer diameters”) per unit length become larger by degrees from one end in an axial direction to the other end. The light guiding member 11b′ includes a through-hole having a configuration such that the tube body 21 of the fluorescent lamp 2′ is inserted therein. The length in the axial direction of the light guiding member 11b′ is set to be about half or less than half the length in an axial direction of the tube body 21 of the fluorescent lamp 2′ (the length that would be obtained when the tube body 21 is brought into line). In other words, the length is set to be same or less than the length of the linear section of the tube body 21. Shown in FIG. 30 is a configuration such that the length is set to be about half the length in the axial direction of the tube body 21 (i.e., set to be substantially same as the length of the linear section of the tube body 21).

As shown in FIGS. 29 and 30, the tube bodies 21 of the fluorescent lamps 2′ are inserted in the through-holes of the light guiding members 11a′ and 11b′. In FIG. 30, the tapered shaped light guiding member 11b′ is attached to the tube body 21 such that its one end having a larger surface area per unit length is disposed close to one end of the tube body 21 while the other end having a smaller surface area per unit length is disposed close to the center (a substantially U-shaped section) of the tube body 21. Thus, the light guiding members 11a′ and 11b′ are attached on the outer surfaces of the tube bodies 21 of the fluorescent lamps 2′ at given sections from the one ends of the tube bodies 21 (i.e., at sections from the one ends to the centers (substantially U-shaped sections) of the tube bodies 21 when the light guiding members 11a′ and 11b′ have the length about half the length in the axial direction of the tube bodies 21).

In the light sources 1a′ and 1b′ having these configurations, alternating-current voltages are applied to the discharging electrodes 221 at one ends of the light sources 1a′ and 1b′ closer to the sections where the light guiding members 11a′ and 11b′ are not attached while the discharging electrodes 222 at the other ends closer to the sections where the light guiding members 11a′ and 11b′ are attached are grounded. Consequently, the same actions and effects as those obtained by the light sources 1a and 1b according to the first and second preferred embodiments of the present invention can be obtained by the light sources 1a′ and 1b′ having these configurations, respectively.

Besides, instead of the round shape, the light guiding member 11a′ may have an oval shape in cross section, similarly to the light guiding member 11d of the light source 1d according to the fourth preferred embodiment of the present invention. In addition, instead of the through-hole, the light guiding member 11a′ may have a groove having a configuration such that the tube body 21 of the fluorescent lamp 2′ is inserted therein, similarly to the light guiding members 11g and 11j of the light sources 1g and 1j according to the seventh and tenth preferred embodiments of the present invention. Also the tapered shaped light guiding member 11b′ may have an oval shape in cross section, instead of the round shape, similarly to the light guiding member 11e of the light source 1e according to the fifth preferred embodiment of the present invention. In addition, instead of the through-hole, the light guiding member 11b′ may have a groove having a configuration such that the tube body 21 of the fluorescent lamp 2′ is inserted therein, similarly to the light guiding members 11h and 11k of the light sources 1h and 1k according to the eighth and eleventh preferred embodiments of the present invention.

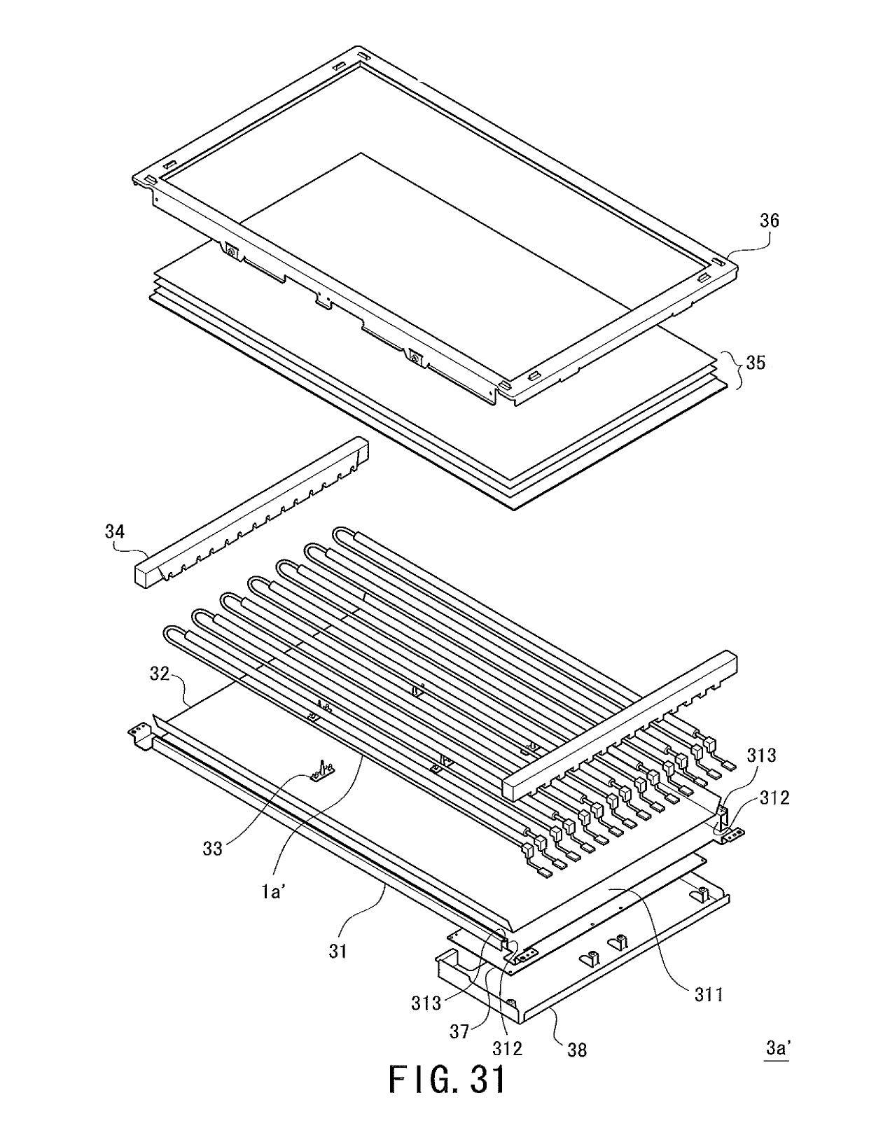

Next, alight source device 3a′ including the light sources 1a′ or 1b′ will be described. FIG. 31 is an exploded perspective view showing a schematic configuration of the light source device 3a′ including the light sources 1a′, for example. The light source device 3a′ including the light sources 1b′ has a configuration same as the light source device 3a′ including the light sources 1a′, a description of which will be provided together. Explanations of some components of the light source device 3a′, which are common to components of the light source device 3a, are omitted, providing reference numerals same as the components of the light source device 3a to the corresponding components of the light source device 3a′.

A reflection sheet 32 is laid on the front side of a bottom face 311 of a chassis 31. A given number of the light sources 1a′, 1b′ are arranged in parallel on the front side of the reflection sheet 32. The light sources 1a′, 1b′ are held by light source holders 33 and fixed to the front side of the bottom face 311 of the chassis 31.

Alight source driving circuit board 37 is disposed behind the chassis 31. The light source driving circuit board 37 is electrically connected to the light sources 1a′, 1b′. To be specific, the light source driving circuit board 37 is connected to the light sources 1a′, 1b′ such that the alternating-current voltages generated by the light source driving circuit board 37 are applied to the discharging electrodes 221 at the one ends of the light sources 1a′, 1b′ closer to the sections where the light guiding members 11a′, 11b′ are not attached. Meanwhile, the discharging electrodes 222 at the other ends of the light sources 1a′, 1b′ closer to the sections where the light guiding members 11a′, 11b′ are attached are grounded.

Consequently, the same action and effect as those obtained by the light source device 3a according to the first preferred embodiment of the present invention can be obtained by the light source device 3a′.

Sometimes, fluorescent lamps are used in pairs connected in series. To be specific, fluorescent lamps are used in pairs connected in series with discharging electrodes at one ends of each pair of fluorescent lamps being electrically connected to each other while alternating-current voltages in opposite phases are applied to the discharging electrodes at the one ends. In using the fluorescent lamps in this manner, if a leak occurs in the currents passing through tube bodies of the fluorescent lamps, the currents passing closer to the discharging electrodes to which the alternating-current voltages are applied become larger while the currents passing closer to the electrically-connected discharging electrodes become smaller. Accordingly, the amounts of light the fluorescent lamps emit at sections closer to the discharging electrodes to which the alternating-current voltages are applied become larger while the amounts of light the fluorescent lamps emit at sections closer to the electrically-connected discharging electrodes become smaller. In order to solve this problem, light sources including the fluorescent lamps in pairs will be described.

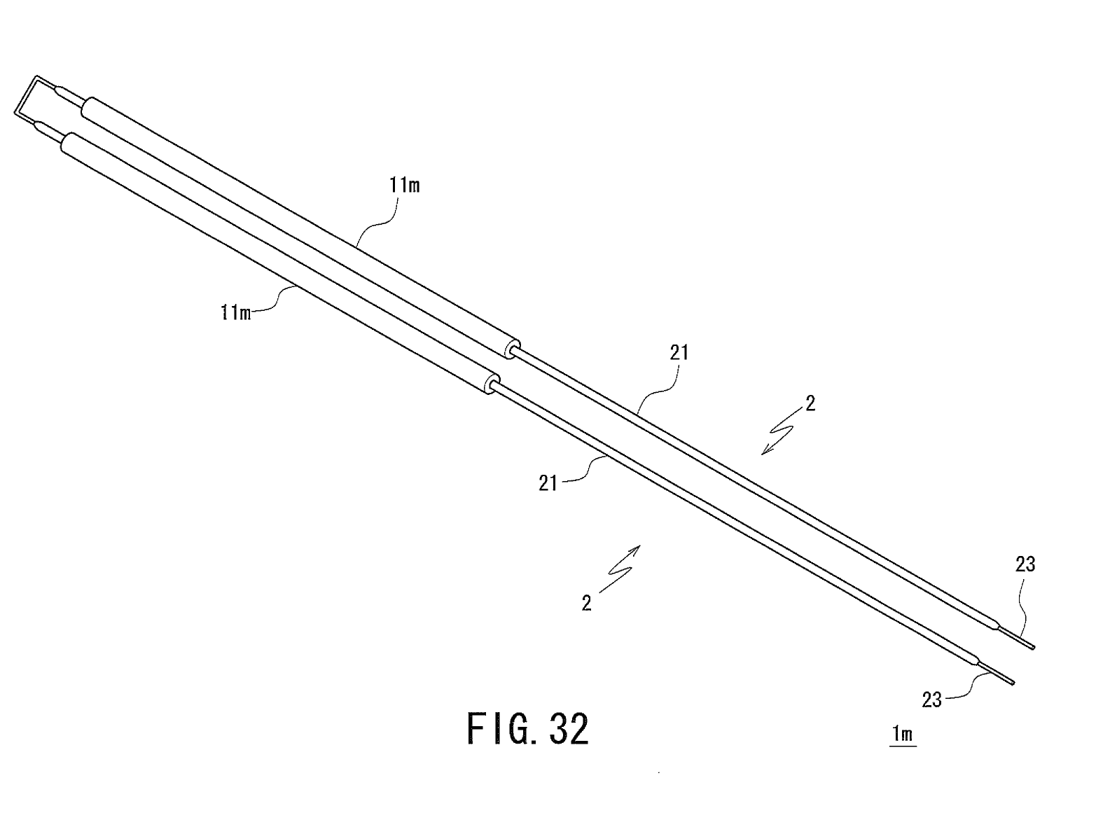

FIG. 32 is an external perspective view showing a schematic configuration of a light source 1m according to a thirteenth preferred embodiment of the present invention. The light source 1m according to the thirteenth preferred embodiment of the present invention includes a pair of fluorescent lamps 2 including linear tube bodies 21, and two light guiding members limas shown in FIG. 32. Each light guiding member 11m has a configuration almost same as the light guiding member 11a, 11d, 11g or 11j of the light source 1a, 1d, 1g or 1j according to the first, fourth, seventh or tenth preferred embodiment of the present invention, an explanation of which is omitted. Shown in FIG. 32 are the light guiding members 11m having the same configurations as the light guiding members 11a of the light source 1a according to the first preferred embodiment of the present invention, for example.

Discharging electrodes 222 at one ends of the pair of fluorescent lamps 2 are electrically connected. The light guiding members 11m are each attached on the outer surfaces of the tube bodies 21 of the fluorescent lamps 2 at the sections closer to the electrically-connected discharging electrodes 222. To be specific, the light guiding members 11m are each attached such that their one ends in axial directions are disposed close to the discharging electrodes 222 at the one ends of the tube bodies 21 of the fluorescent lamps 2.

In other words, the linear light source 1m according to the thirteenth preferred embodiment of the present invention consists of the two light sources 1a according to the first preferred embodiment of the present invention, the two light sources 1d according to the fourth preferred embodiment of the present invention, the two light sources 1g according to the seventh preferred embodiment of the present invention, or the two light sources 1j according to the tenth preferred embodiment of the present invention, where the discharging electrodes 222 at the one ends of the pair of fluorescent lamps 2 of the light sources 1a, 1d, 1g or 1j (the discharging electrodes 222 at the one ends of the light sources 1a, 1d, 1g or 1j that are closer to the sections where the light guiding members 11a, 11d, 11g or 11j are attached) are electrically connected.

Alternating-current voltages in opposite phases are applied to discharging electrodes 221 other than the electrically-connected discharging electrodes 222. A light emission area of the light source 1m is increased by the attachment of the light guiding members 11m thereto at the section closer to the electrically-connected discharging electrodes 222, so that the amount of light the light source 1m emits to the outside can be completed. Therefore, nonuniformity in the amount of light the light source 1m emits to the outside, in other words, a difference between the amount of light the light source 1m emits to the outside at the section closer to the grounded discharging electrodes 221 to which the alternating-current voltages are applied and the amount of light emitted to the outside at the section closer to the electrically-connected discharging electrodes 222 can be reduced, or eliminated.

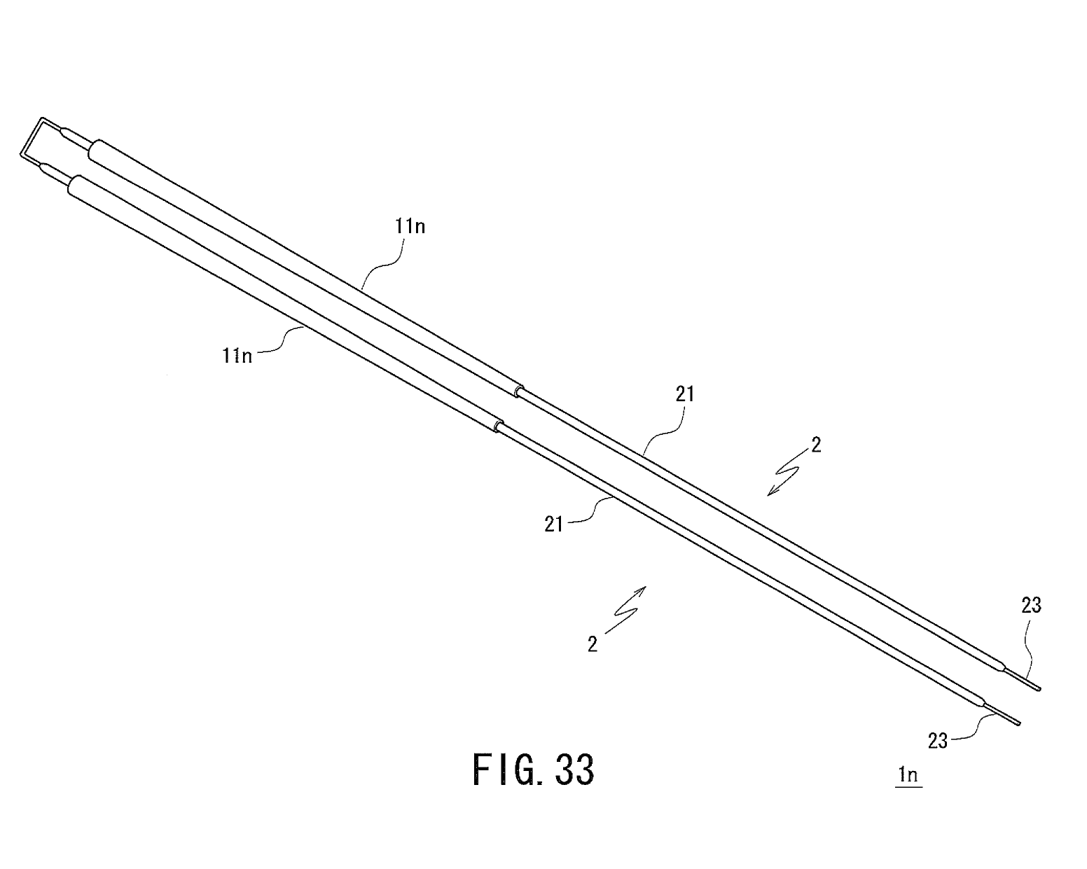

FIG. 33 is an external perspective view showing a schematic configuration of a light source 1n according to a fourteenth preferred embodiment of the present invention. The light source 1n according to the fourteenth preferred embodiment of the present invention includes a pair of fluorescent lamps 2 including linear tube bodies 21, and two light guiding members 11n as shown in FIG. 33. Each light guiding member 11n has a configuration almost same as the light guiding member 11b, 11e, 11h or 11k of the light source 1b, 1e, 1h or 1k according to the second, fifth, eighth or eleventh preferred embodiment of the present invention, an explanation of which is omitted. Shown in FIG. 33 are the light guiding members 11n having the same configurations as the light guiding members 11b of the light source 1b according to the second preferred embodiment of the present invention, for example.

Discharging electrodes 222 at one ends of the pair of fluorescent lamps 2 are electrically connected. The light guiding members 11n are each attached on the outer surfaces of the tube bodies 21 of the fluorescent lamps 2 at the sections closer to the electrically-connected discharging electrodes 222. To be specific, the light guiding members 11n are each attached such that their one ends in axial directions are disposed close to the discharging electrodes 222 at the one ends of the tube bodies 21 of the fluorescent lamps 2.

In other words, the linear light source 1n according to the fourteenth preferred embodiment of the present invention consists of the two light sources 1b according to the second preferred embodiment of the present invention, the two light sources 1e according to the fifth preferred embodiment of the present invention, the two light sources 1h according to the eighth preferred embodiment of the present invention, or the two light sources 1k according to the eleventh preferred embodiment of the present invention, where the discharging electrodes 222 at the one ends of the pair of fluorescent lamps 2 of the light sources 1b, 1e, 1h or 1k (the discharging electrodes 222 at the one ends of the light sources 1b, 1e, 1h or 1k that are closer to the sections where the light guiding members 11b, 11e, 11h or 11k are attached) are electrically connected.

Alternating-current voltages in opposite phases are applied to discharging electrodes 221 other than the electrically-connected discharging electrodes 222. Consequently, the same actions and effects as those obtained by the light sources 1a and 1b according to the first and second preferred embodiments of the present invention can be obtained by the light source 1n having this configuration.

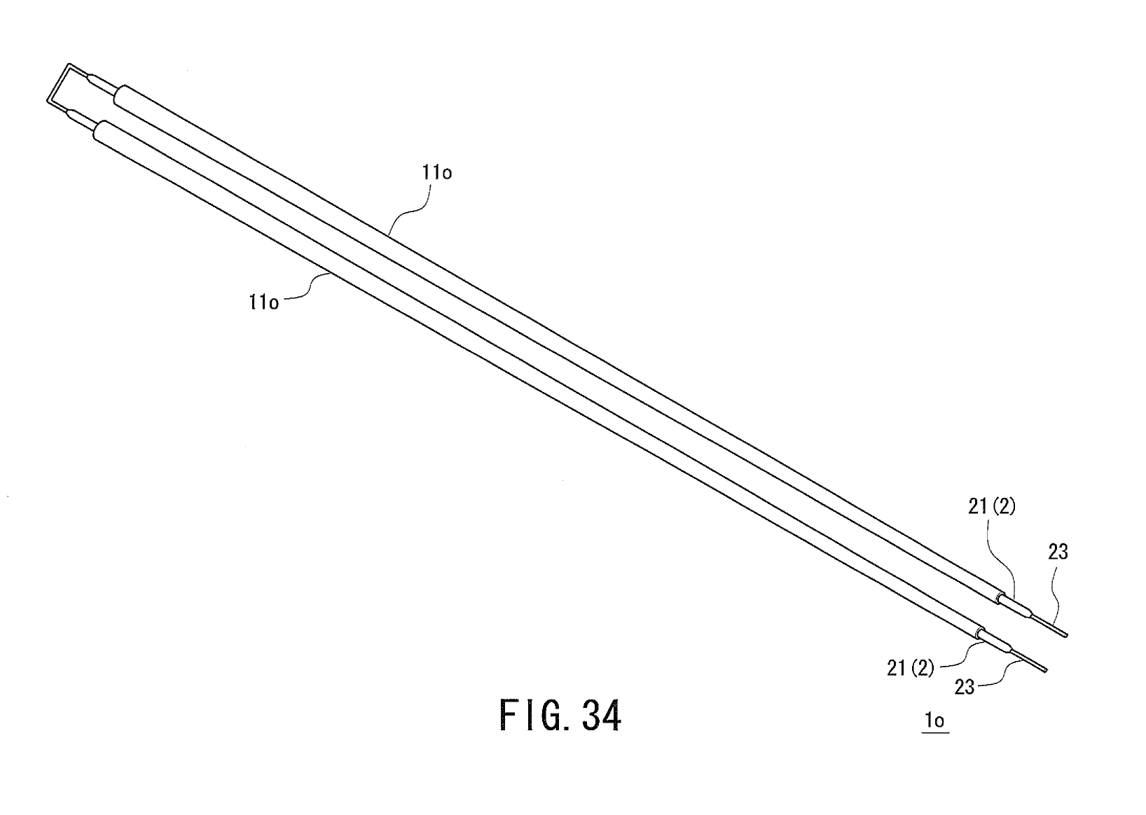

FIG. 34 is an external perspective view showing a schematic configuration of a light source 1o according to a fifteenth preferred embodiment of the present invention. The light source to according to the fifteenth preferred embodiment of the present invention includes a pair of fluorescent lamps 2 including linear tube bodies 21, and two light guiding members 11o as shown in FIG. 34. Each light guiding member 11o has a configuration almost same as the light guiding member 11c, 11f, or 11l of the light source 1c, 1f, 1i or 1l according to the third, sixth, ninth or twelfth preferred embodiment of the present invention, an explanation of which is omitted. Shown in FIG. 34 are the light guiding members 11o having the same configurations as the light guiding members 11c of the light source 1c according to the third preferred embodiment of the present invention, for example.

Discharging electrodes 222 at one ends of the pair of fluorescent lamps 2 are electrically connected. The light guiding members 11o are each attached on the outer surfaces of the tube bodies 21 of the fluorescent lamps 2. To be specific, the light guiding members 11o are each attached such that their one ends having larger surface areas per unit length (having larger outer diameters) are disposed close to the electrically-connected discharging electrodes 222.

In other words, the linear light source 1o according to the fifteenth preferred embodiment of the present invention consists of the two light sources 1c according to the third preferred embodiment of the present invention, the two light sources 1f according to the sixth preferred embodiment of the present invention, the two light sources 1i according to the ninth preferred embodiment of the present invention, or the two light sources 1l according to the twelfth preferred embodiment of the present invention, where the discharging electrodes 222 at the one ends of the pair of fluorescent lamps 2 of the light sources 1c, 1f, 1i or 1l (the discharging electrodes 222 at the one ends of the light sources 1c, 1f, 1i or 1l that are closer to the sections where the light guiding members 11c, 11f, 11i or 11l are attached) are electrically connected.

Alternating-current voltages in opposite phases are applied to discharging electrodes 221 other than the electrically-connected discharging electrodes 222. Consequently, the same actions and effects as those obtained by the light sources 1a and 1c according to the first and third preferred embodiments of the present invention can be obtained by the light source 1o having this configuration.

Next, alight source device 3d according to a fourth preferred embodiment of the present invention will be described. The light source device 3d according to the fourth preferred embodiment of the present invention includes the light sources 1m, 1n or 1o according to the thirteenth, fourteenth or fifteenth preferred embodiment of the present invention. Explanations of some components of the light source device 3d, which are common to components of the light source device 3a, are omitted, providing reference numerals same as the components of the light source device 3a to the corresponding components of the light source device 3d.

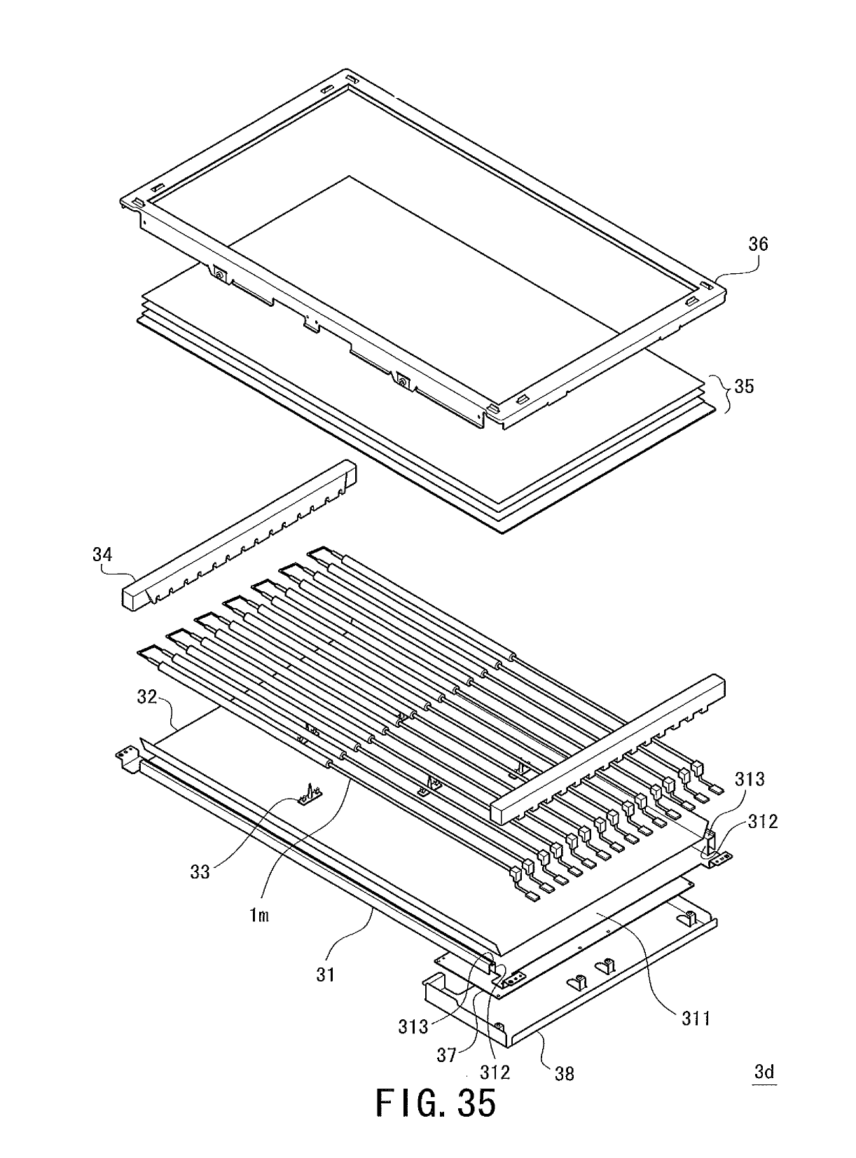

FIG. 35 is an exploded perspective view showing a schematic configuration of the light source device 3d according to the fourth preferred embodiment of the present invention. The light source device 3d according to the fourth preferred embodiment of the present invention includes a chassis 31, a reflection sheet 32, the light sources 1m, 1n or 1o according to the thirteenth, fourteenth or fifteenth preferred embodiment of the present invention (shown in FIG. 35 are the light sources 1m according to the thirteenth preferred embodiment of the present invention, for example), light source holders 33, side holders 34, optical sheets 35, a frame 36, a light source driving circuit board 37, and alight source driving circuit board cover 38. For the chassis 31, the reflection sheet 32, the light source holders 33, the side holders 34, the optical sheets 35, the frame 36, the light source driving circuit board 37, and the light source driving circuit board cover 38, the same components used in the light source device 3a according to the first preferred embodiment of the present invention are preferably used. The light source driving circuit board 37 is capable of generating alternating-current voltages in opposite phases.

The reflection sheet 32 is laid on the front side of a bottom face 311 of the chassis 31. A given number of the light sources 1m, 1n or 1o according to the thirteenth, fourteenth or fifteenth preferred embodiment of the present invention are arranged in parallel on the front side of the reflection sheet 32. All the light sources 1m, 1n or 1o are oriented in a direction such that the electrically-connected discharging electrodes 222 thereof are brought to a same side (shown in FIG. 35 is the configuration that the electrically-connected discharging electrodes 222 face the top left side of FIG. 35). The light sources 1m, 1n or 1o are held by the light source holders 33 and fixed to the front side of the bottom face 311 of the chassis 31.

The light source driving circuit board 37 is disposed behind the chassis 31. The light source driving circuit board 37 is electrically connected to the discharging electrodes 221, which are not electrically connected to each other, of the light sources 1m, 1n or 1o according to the thirteenth, fourteenth or fifteenth preferred embodiment of the present invention.

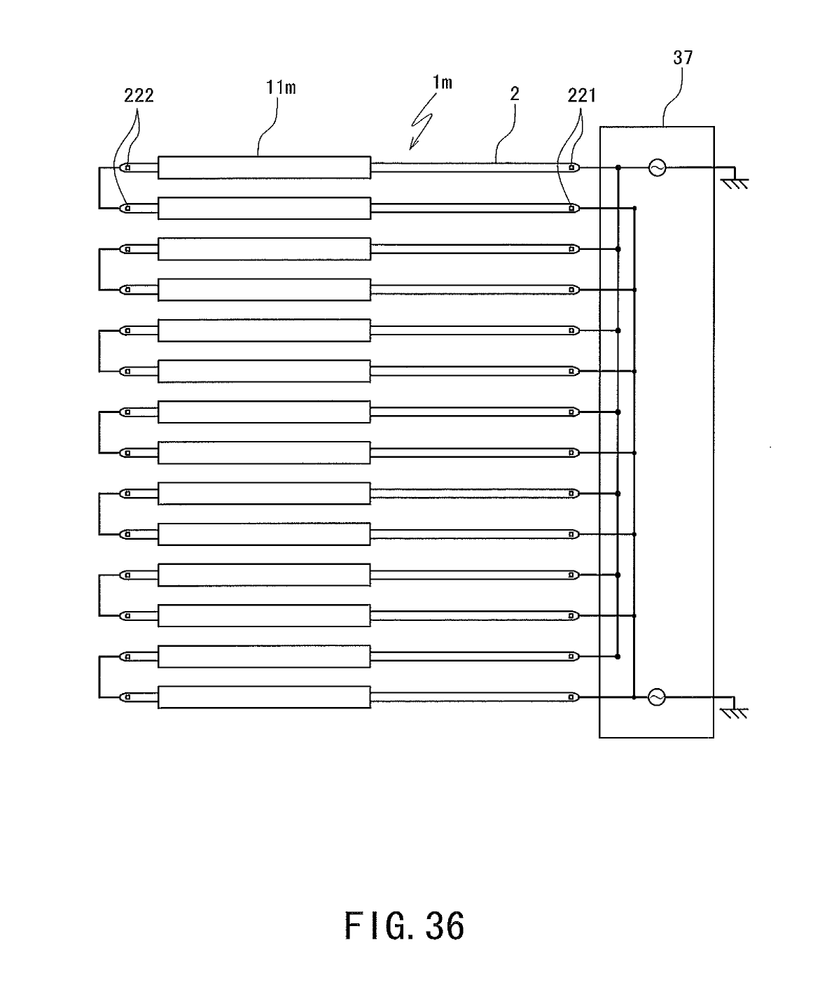

FIG. 36 is a plan view schematically showing a connecting structure of the light sources 1m, 1n or 1o according to the thirteenth, fourteenth or fifteenth preferred embodiment of the present invention, and the light source driving circuit board 37. As shown in FIG. 36, alternating-current voltages in opposite phases are applied to the discharging electrodes 221 other than the electrically-connected discharging electrodes 222 of the fluorescent lamps 2 in pairs of the light sources 1m, 1n or 1o according to the thirteenth, fourteenth or fifteenth preferred embodiment of the present invention. Consequently, the same action and effect as those obtained by the light source device 3a according to the first preferred embodiment of the present invention can be obtained by the light source device 3d according to the fourth preferred embodiment of the present invention.

There is a case where one fluorescent lamp of a light source is used while alternating-current voltages in opposite phases are applied to discharging electrodes at both ends of the fluorescent lamp. In this case, if a current leak occurs, the current passing through a center section in an axial direction of a tube body of the fluorescent lamp becomes smaller than the currents passing through both end sections of the tube body. Accordingly, the light amount at the center section of the tube body becomes smaller than the light amounts at both the end sections, which could make the light fluorescent lamp emits nonuniform as a whole. However, by attaching a light guiding member to the fluorescent lamp at the center section of the tube body, the light amount is completed. Therefore, the nonuniformity in the light amount can be minimized or eliminated.

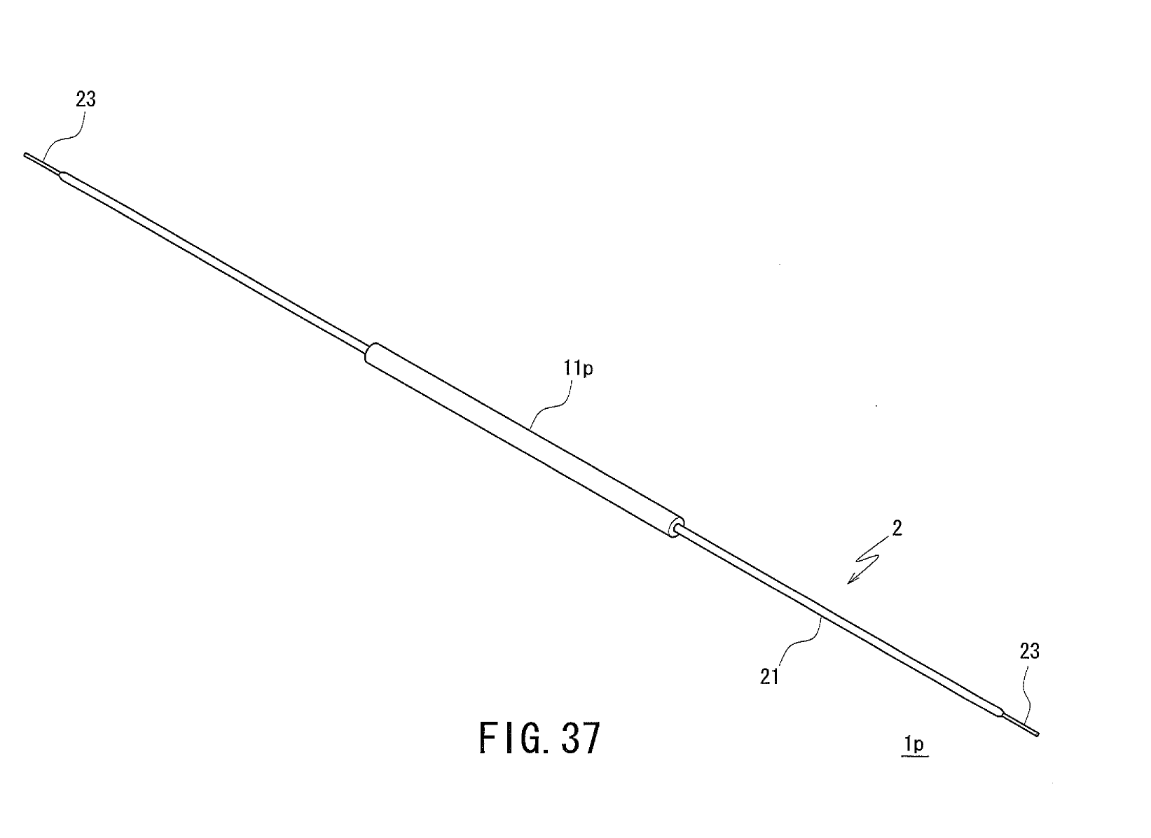

FIG. 37 is an external perspective view showing a schematic configuration of a light source 1p according to a sixteenth preferred embodiment of the present invention. The light source 1p according to the sixteenth preferred embodiment of the present invention includes the fluorescent lamp 2 that defines a light source, and alight guiding member 11p. The light guiding member 11p has a substantially same configuration as the light guiding member 11a of the light source 1a according to the first preferred embodiment of the present invention. Briefly speaking, the light guiding member 11p has a linear shape and is substantially round in cross section. The light guiding member 11p includes a through-hole that runs from one end to the other end in an axial direction of the light guiding member 11p, and has a configuration such that the tube body 21 of the fluorescent lamp 2 is inserted therein. The length in the axial direction of the light guiding member 11p is shorter than the length in the axial direction of the tube body 21 of the fluorescent lamp 2, and is set based on the length of the section of the tube body 21 of which the light amount is to be completed. For example, the length in the axial direction of the light guiding member 11p is set to be about one third of the length in the axial direction of the tube body 21 of the fluorescent lamp 2.

The tube body 21 of the fluorescent lamp 2 is inserted in the through-hole of the light guiding member 11p, where the light guiding member 11p is attached on the outer surface at a center section in the axial direction of the tube body 21 of the fluorescent lamp 2. Thus, in the configuration that the light guiding member 11p has the length in the axial direction that is set to be about one third of the length in the axial direction of the tube body 21 of the fluorescent lamp 2, the center section of a one-third length in the axial direction on the outer surface of the tube body 21 is covered with the light guiding member 11p, while sections of one-third lengths from both the ends in the axial direction on the outer surface of the tube body 21 are exposed. This configuration increases a light emission area of the center section of the tube body 21 of the fluorescent lamp 2, which can increase (or complete) the amount of light emitted to the outside. Therefore, even if alternating-current voltages in opposite phases are applied to the discharging electrodes 221 and 222, the same action and effect as those obtained by the light source 1a according to the first preferred embodiment of the present invention can be obtained by the light source 1p according to the sixteenth preferred embodiment of the present invention.

Besides, the light guiding member 11P may have an oval shape in cross section, similarly to the light guiding member 11d of the light source 1d according to the fourth preferred embodiment of the present invention. In addition, instead of the through-hole, the light guiding member 11p may have a groove having a configuration such that the tube body 21 of the fluorescent lamp 2 is inserted therein, similarly to the light guiding members 11g and 11j of the light sources 1g and 1j according to the seventh and tenth preferred embodiments of the present invention.

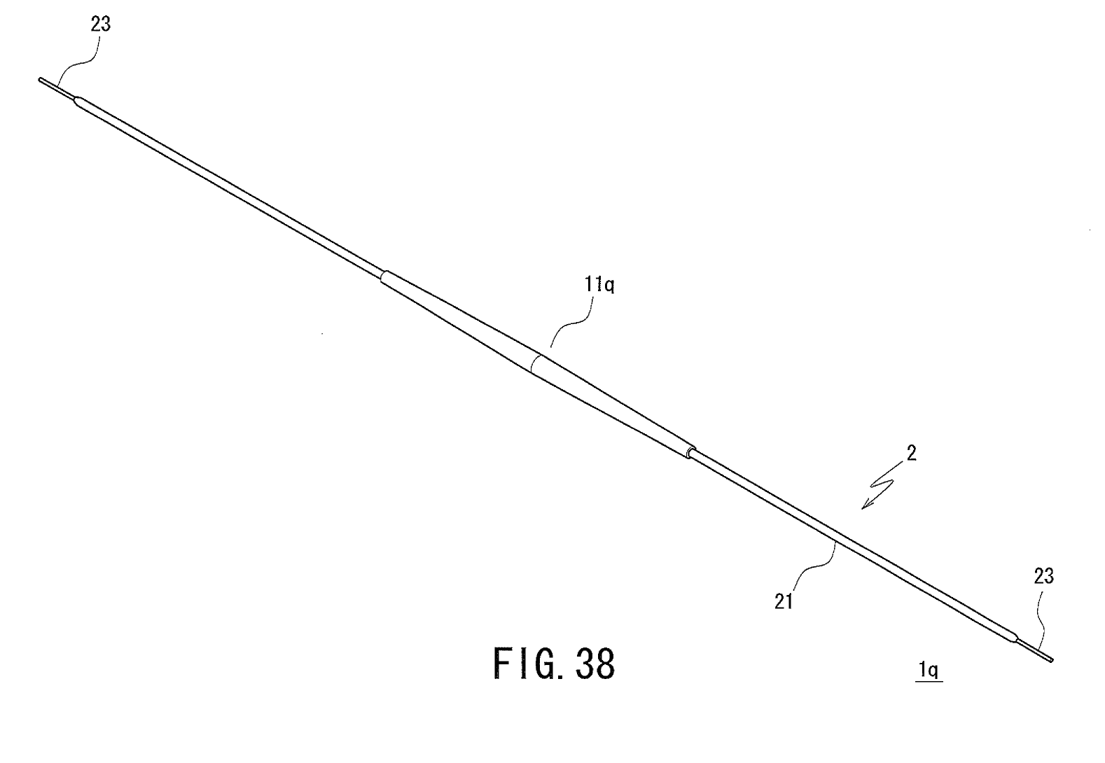

FIG. 38 is an external perspective view showing a schematic configuration of a light source 1q according to a seventeenth preferred embodiment of the present invention. The light source 1q according to the seventeenth preferred embodiment of the present invention includes the fluorescent lamp 2 and a light guiding member 11q.

The light guiding member 11q has a linear shape and is substantially round in cross section. The length in the axial direction of the light guiding member 11q is shorter than the length in the axial direction of the tube body 21 of the fluorescent lamp 2, and is set based on the length of the section of which the light amount is to be completed. For example, the length in the axial direction of the light guiding member 11q is set to be about one third of the length in the axial direction of the tube body 21 of the fluorescent lamp 2. The light guiding member 11q includes a through-hole that runs from one end to the other end in an axial direction of the light guiding member 11q, and has a configuration such that the tube body 21 of the fluorescent lamp 2 is inserted therein. The light guiding member 11q has a tapered shape such that its surface areas per unit length (i.e., the outer diameter) become larger by degrees from both the ends to the center in the axial direction. To be specific, the surface area per unit length is largest at the center in the axial direction, and the surface areas per unit length are smallest at both the ends. In other words, the light guiding member 11q has a shape formed by connecting the light guiding members 11b of the light source 1b according to the second preferred embodiment of the present invention in the axial direction (so that the bottoms of the cones are connected).

The tube body 21 of the fluorescent lamp 2 is inserted in the through-hole of the light guiding member 11q, where the light guiding member 11q is attached on the outer surface at a center section in the axial direction of the tube body 21 of the fluorescent lamp 2. Thus, in the configuration that the light guiding member 11q has the length in the axial direction that is set to be about one third of the length in the axial direction of the tube body 21 of the fluorescent lamp 2, the center section of a one-third length in the axial direction on the outer surface of the tube body 21 is covered with the light guiding member 11q, while sections of one-third lengths from both the ends in the axial direction on the outer surface of the tube body 21 are exposed. This configuration increases a light emission area of the center section in the axial direction of the tube body 21 of the fluorescent lamp 2 while decreases a light emission area by degrees toward both the ends of the fluorescent lamp 2. Accordingly, this configuration can increase (or complete) the amount of light emitted to the outside at the center section of the tube body 21 of the fluorescent lamp 2. Therefore, even if alternating-current voltages in opposite phases are applied to the discharging electrodes 221 and 222, the same action and effect as those obtained by the light source 1a according to the first preferred embodiment of the present invention can be obtained by the light source 1q according to the seventeenth preferred embodiment of the present invention.

Especially in the configuration that alternating-current voltages in opposite phases are applied to the discharging electrodes 221 and 222, the amount of the current passing through the tube body 21 becomes smaller by degrees from both the ends to the center. Accordingly, the light amount of the fluorescent lamp 2 becomes smaller by degrees from both the ends to the center. The attachment of the light guiding member 11q to the light source 1q according to the seventeenth preferred embodiment of the present invention increases the light emission area by degrees toward the center. Accordingly, the amount of light emitted to the outside can be increased by degrees from both the ends of the tube body 21 to the center, which allows the light source 1q to emit light of which the amount emitted to the outside is uniform throughout the length.

Besides, the light guiding member 11q may have an oval shape in cross section instead of the round shape, similarly to the light guiding member 11e of the light source 1e according to the fifth preferred embodiment of the present invention. In addition, instead of the through-hole, the light guiding member 11q may have a groove having a configuration such that the tube body 21 of the fluorescent lamp 2 is inserted therein, similarly to the light guiding members 11h and 11k of the light sources 1h and 1k according to the eighth and eleventh preferred embodiments of the present invention.

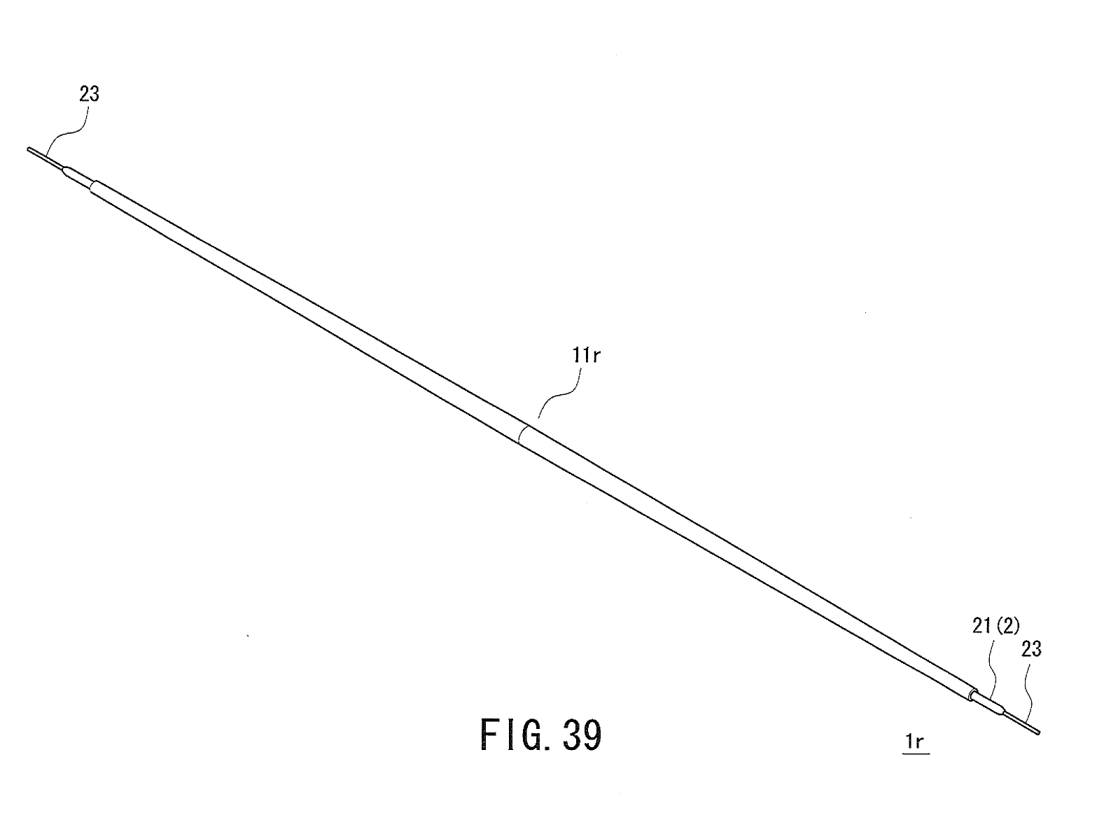

FIG. 39 is an external perspective view showing a schematic configuration of a light source 1r according to an eighteenth preferred embodiment of the present invention. The light source 1r according to the eighteenth preferred embodiment of the present invention includes the fluorescent lamp 2 and a light guiding member 11r. The light guiding member 11r has a same configuration as the light guiding member 11q of the light source 1q according to the seventeenth preferred embodiment of the present invention except the length in an axial direction, an explanation of which is omitted. The length in the axial direction of the light guiding member 11r is substantially same or slightly shorter than the length in the axial direction of the tube body 21.

The tube body 21 of the fluorescent lamp 2 is inserted in the through-hole of the light guiding member 11r, where the light guiding member 11r is attached on the outer surface at a center section of the tube body 21 of the fluorescent lamp 2. Thus, the outer surface of the tube body 21 of the fluorescent lamp 2 is covered throughout its substantial length with the light guiding member 11r. The same action and effect as those obtained by the light source 1q according to the seventeenth preferred embodiment of the present invention can be obtained by the light source 1r according to the eighteenth preferred embodiment of the present invention. Hence, the length in the axial length of the light guiding member is not limited specifically.

Next, alight source device 3e according to a fifth preferred embodiment of the present invention will be described. The light source device 3e according to the fifth preferred embodiment of the present invention includes the light sources 1p, 1q or 1r according to the sixteenth, seventeenth or eighteenth preferred embodiment of the present invention. Explanations of some components of the light source device 3e, which are common to components of the light source device 3a, are omitted, providing reference numerals same as the components of the light source device 3a to the corresponding components of the light source device 3e.

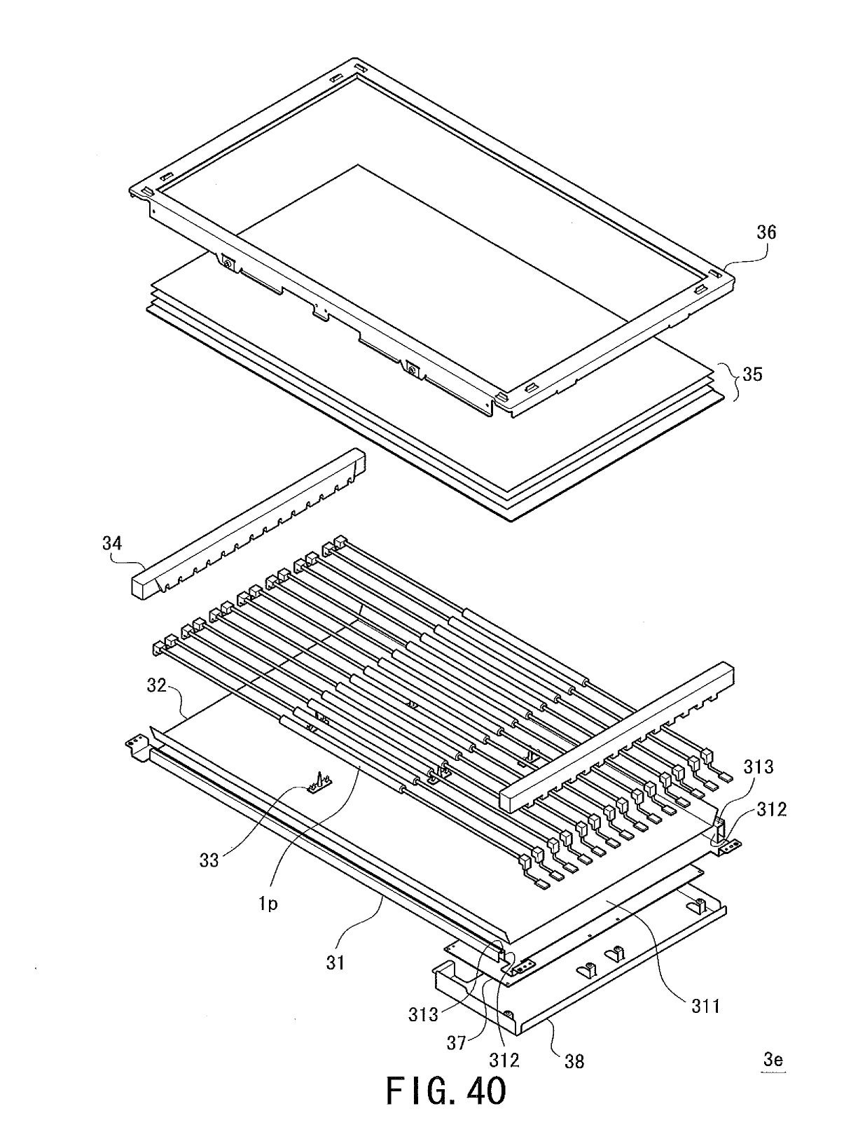

FIG. 40 is an exploded perspective view showing a schematic configuration of the light source device 3e according to the fifth preferred embodiment of the present invention. The light source device 3e according to the fifth preferred embodiment of the present invention includes a chassis 31, a reflection sheet 32, the light sources 1p, 1q or 1r according to the sixteenth, seventeenth or eighteenth preferred embodiment of the present invention (shown in FIG. 40 are the light sources 1p according to the sixteenth preferred embodiment of the present invention, for example), light source holders 33, side holders 34, optical sheets 35, a frame 36, a light source driving circuit board 37, and alight source driving circuit board cover 38. For the chassis 31, the reflection sheet 32, the light source holders 33, the side holders 34, the optical sheets 35, the frame 36, the light source driving circuit board 37, and the light source driving circuit board cover 38, the same components used in the light source device 3a according to the first preferred embodiment of the present invention are preferably used. The light source driving circuit board 37 is capable of generating alternating-current voltages in opposite phases.

The reflection sheet 32 is laid on the front side of a bottom face 311 of the chassis 31. A given number of the light sources 1p, 1q or 1r according to the sixteenth, seventeenth or eighteenth preferred embodiment of the present invention are arranged in parallel on the front side of the reflection sheet 32. The side holders 34 are disposed along the shorter sides of the chassis 31 so as to cover both the end portions of the light sources 1p, 1q or 1r.

The light source driving circuit board 37 is disposed behind the chassis 31. The light source driving circuit board cover 38 is disposed so as to protect the light source driving circuit board 37. The light source driving circuit board 37 is electrically connected to the discharging electrodes 221 of the light sources 1p, 1q or 1r according to the sixteenth, seventeenth or eighteenth preferred embodiment of the present invention. To be specific, the light source driving circuit board 37 is electrically connected to the discharging electrodes 221 such that alternating-current voltages in opposite phases are applied to the discharging electrodes at both the ends of the light sources 1p, 1q or 1r according to the sixteenth, seventeenth or eighteenth preferred embodiment of the present invention.

Consequently, the same action and effect as those obtained by the light source device 3a according to the first preferred embodiment of the present invention can be obtained by the light source device 3e according to the fifth preferred embodiment of the present invention.

Sometimes, a fluorescent lamp including a tube body having a substantially U shape is used while alternating-current voltages in opposite phases are applied to discharging electrodes provided at both ends of the fluorescent lamp. Also in this case, the current passing through a center section in an axial direction of the tube body (the substantially U-shaped section of the tube body) could be smaller than the currents passing through both the end sections in the axial direction of the tube body. Accordingly, the amount of light the fluorescent lamp emits is smaller at the center section than at the both the ends, which makes the light amount of the fluorescent lamp nonuniform. In order to solve this problem, light sources including the fluorescent lamps including the U-shaped tube bodies will be described.

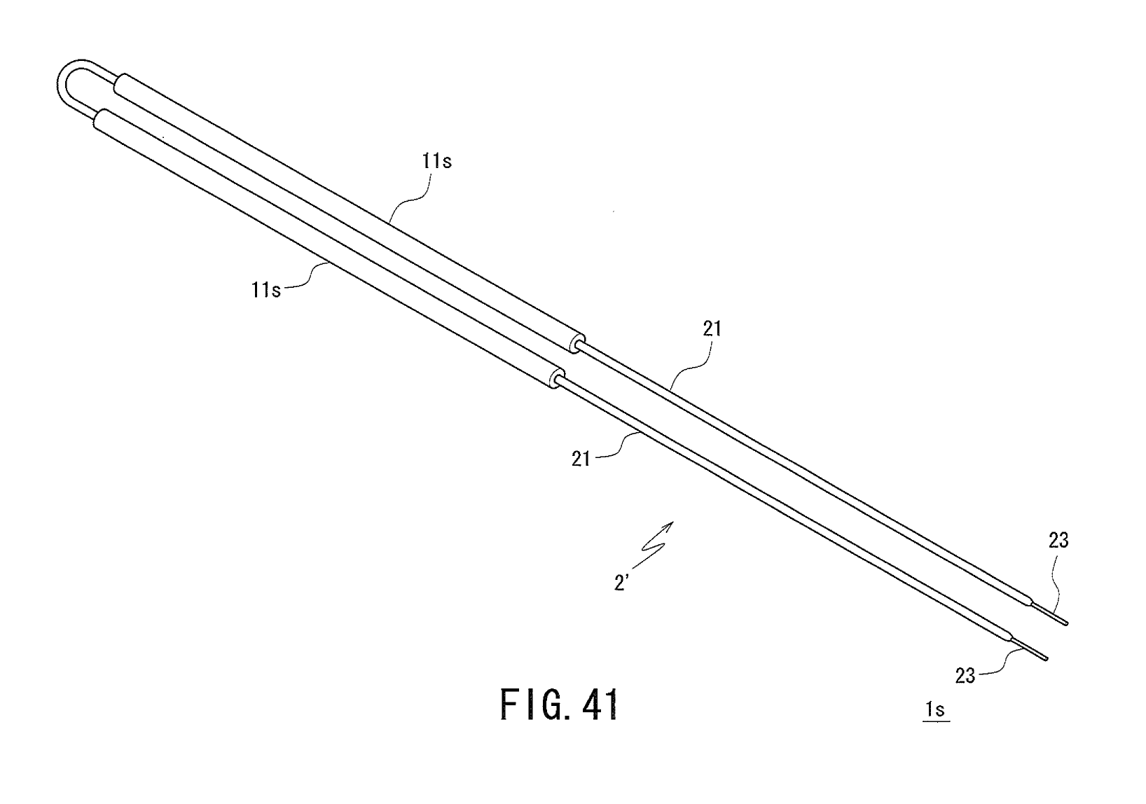

FIG. 41 is an external perspective view showing a schematic configuration of a light source 1s according to a nineteenth preferred embodiment of the present invention. The light source 1s according to the nineteenth preferred embodiment of the present invention includes a fluorescent lamp 2′ that includes a tube body having a substantially U shape and two light guiding members 11s.

Each light guiding member 11s has a same configuration as the light guiding member 11a, 11d, 11g or 11j of the light source 1a, 1d, 1g or 1j according to the first, fourth, seventh or tenth preferred embodiment of the present invention except the length in an axial direction. To be specific, the light guiding member 11s has a linear shape and is substantially round or oval in cross section. The light guiding member 11s includes a through-hole or a groove that has a configuration such that the tube body 21 of the fluorescent lamp 2′ is inserted therein. The length in the axial direction of the light guiding member 11s is shorter than the length in the axial direction of the tube body 21 of the fluorescent lamp 2′ (the length that would be obtained when the tube body 21 is brought into line), and is set based on the length of the section of which the light amount is to be completed. For example, the length in the axial direction of the light guiding member 11s is set to be about one fourth of the length in the axial direction of the tube body 21 (i.e., about half the length of a linear section of the tube body 21).

The two light guiding members 11s are attached to sections close to the center of the tube body 21 (close to the substantially U-shaped section of the tube body 21). In the configuration that each light guiding member 11s has the length that is set to be about one fourth of the length of the tube body 21, a section of a half length from the center (i.e., from the substantially U-shaped section) on the outer surface of the tube body 21 is covered with the light guiding member 11s, while sections of one-fourth lengths from both the ends on the outer surface of the tube body 21 are exposed. With this configuration, when alternating-current voltages in opposite phases are applied to the discharging electrodes at both the ends, the nonuniformity in the light amount can be minimized or eliminated. Therefore, the same actions and effects as those obtained by the light sources 1a and 1p according to the first and sixteenth preferred embodiments of the present invention can be obtained by the light source 1s according to the nineteenth preferred embodiment of the present invention.

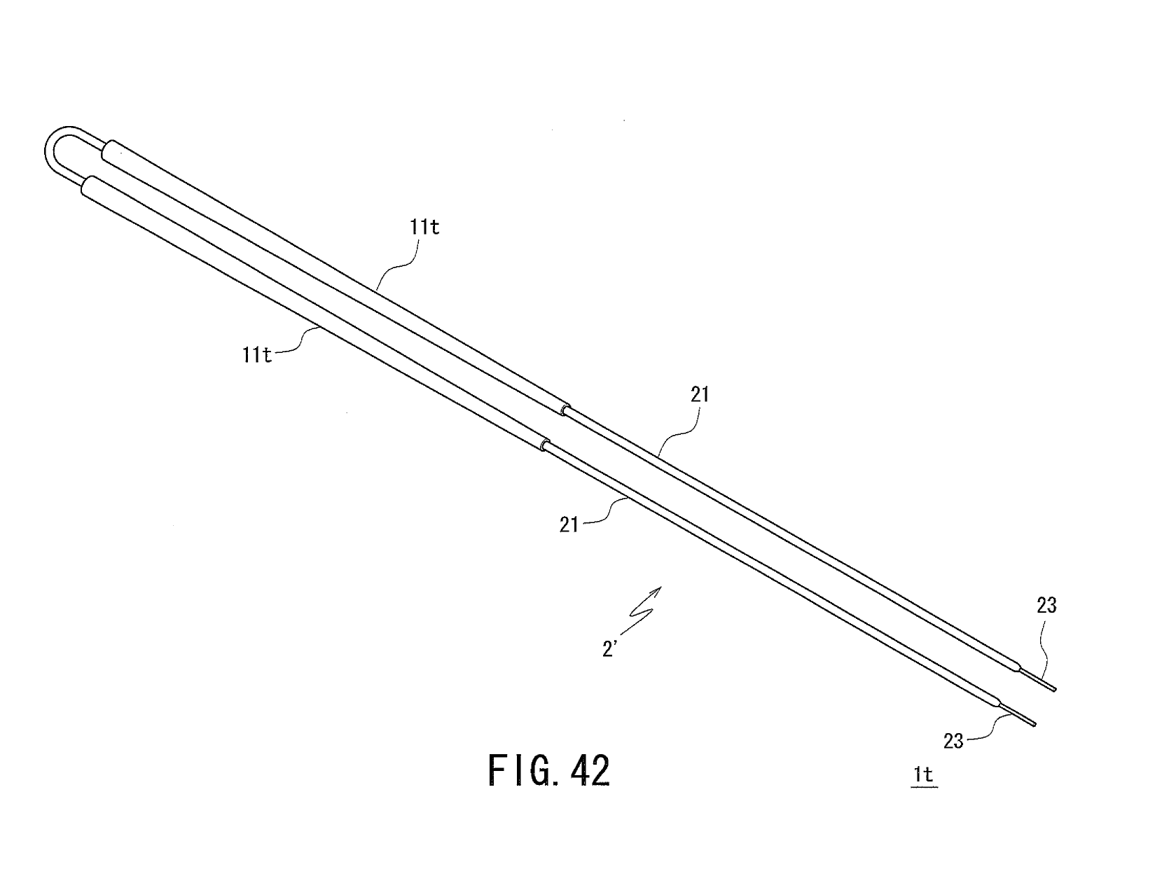

FIG. 42 is an external perspective view showing a schematic configuration of a light source 1t according to a twentieth preferred embodiment of the present invention. The light source 1t according to the twentieth preferred embodiment of the present invention includes a fluorescent lamp 2′ that includes a tube body having a substantially U shape and two light guiding members 11t. Each light guiding member 11t has a same configuration as the light guiding member 11a, 11d, 11g or 11j of the light source 1b, 1e, 1h or 1k according to the second, fifth, eighth or eleventh preferred embodiment of the present invention except the length in an axial direction. To be specific, the light guiding member 11t has a linear shape and is substantially round or oval in cross section. The light guiding member 11t has a tapered shape such that its surface areas per unit length (i.e., the outer diameter) become larger by degrees from one end in the axial direction to the other end (i.e., a substantially cone or elliptic cone shape). The light guiding member 11t includes a through-hole or a groove that has a configuration such that the tube body 21 of the fluorescent lamp 2′ is inserted therein. The length in the axial direction of the light guiding member 11t is shorter than the length in the axial direction of the tube body 21 of the fluorescent lamp 2′, and is set based on the length of the section of which the light amount is to be completed. For example, the length in the axial direction of the light guiding member 11t is set to be about one fourth of the length in the axial direction of the tube body 21 (the length that would be obtained when the tube body 21 is brought into line).

The two light guiding members 11t are attached to sections close to the center of the tube body 21 (close to the substantially U-shaped section of the tube body 21). To be specific, the light guiding members 11t are each attached such that their one ends having larger surface areas per unit length are disposed closer to the substantially U-shaped section of the tube body 21.

In the configuration that each light guiding member 11t has the length that is set to be about one fourth of the length of the tube body 21, a section of a half length from the center (i.e., from the substantially U-shaped section) on the outer surface of the tube body 21 is covered with the light guiding member 11t. With this configuration, when alternating-current voltages in opposite phases are applied to the discharging electrodes at both the ends, the nonuniformity in the light amount can be minimized or eliminated. Therefore, the same actions and effects as those obtained by the light sources 1a and 1q according to the first and seventeenth preferred embodiments of the present invention can be obtained by the light source 1t according to the twentieth preferred embodiment of the present invention.

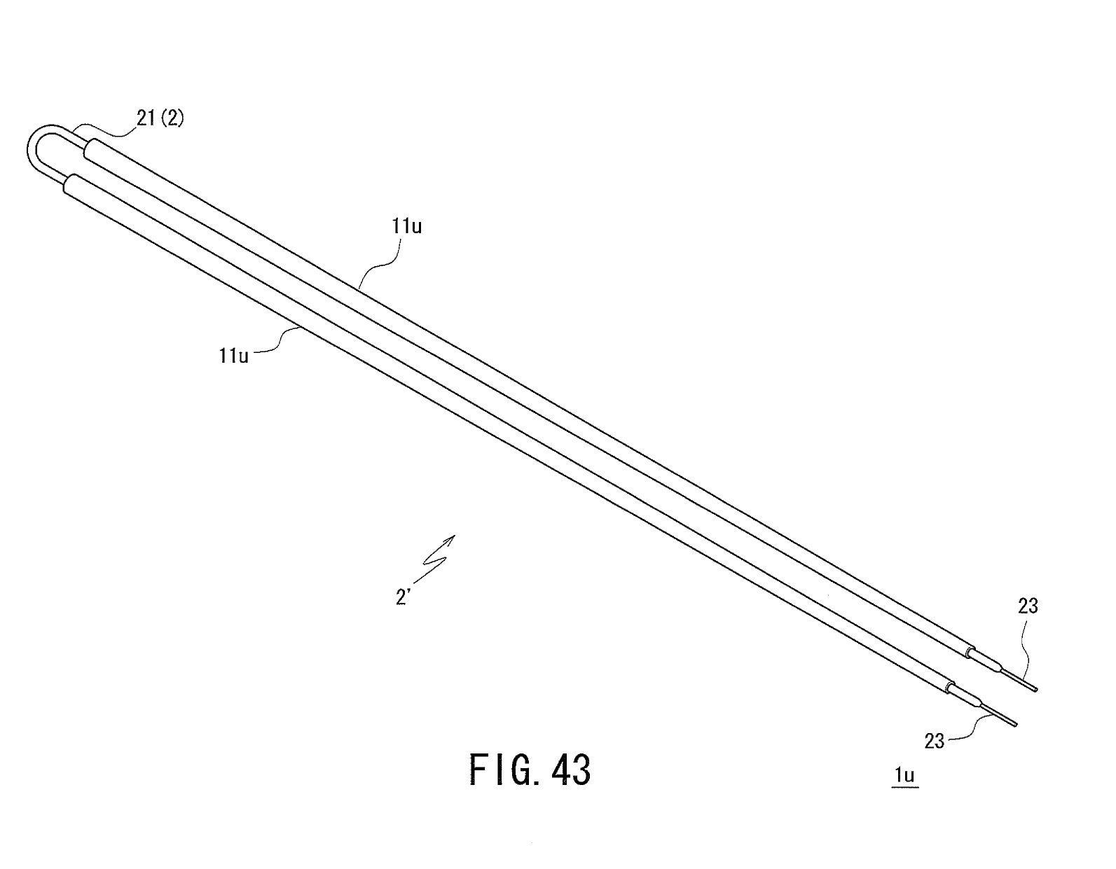

FIG. 43 is an external perspective view showing a schematic configuration of a light source 1u according to a twenty first preferred embodiment of the present invention. The light source 1u according to the twenty first preferred embodiment of the present invention includes a fluorescent lamp 2′ that includes a tube body having a substantially U shape and two light guiding members 11u.

Each light guiding member 11u has a same configuration as the light guiding member 11t of the light source 1t according to the twentieth preferred embodiment of the present invention except the length in an axial direction. To be specific, the light guiding member 11u has a linear shape and is substantially round or oval in cross section. The light guiding member 11u has a tapered shape such that the outer diameter (i.e., surface areas per unit length) becomes larger by degrees from one end to the other end in the axial direction (i.e., a substantially cone or elliptic cone shape). The light guiding member 11u includes a through-hole or a groove that has a configuration such that the tube body 21 of the fluorescent lamp 2′ is inserted therein. The length in the axial direction of the light guiding member 11u is set to be about half the length in the axial direction of the tube body 21 of the fluorescent lamp 2′ (the length that would be obtained when the tube body 21 is brought into line) (in other words, the length is set to be same as the length of a section from one end to the substantially U-shaped section of the tube body 21).

The two light guiding members 11u are attached to the tube body 21. To be specific, the two light guiding members 11u are each attached such that their one ends having larger surface areas per unit length (i.e. a larger diameter) are disposed closer to the substantially U-shaped section of the tube body 21 while the other ends having smaller surface areas per unit length are disposed closer to the ends of the tube body 21.

When the two light guiding members 11u are attached to the tube body 21, linear sections of the tube body (i.e., the sections other than the substantially U-shaped section) are covered throughout their substantial lengths with the light guiding members 11u. With this configuration, when alternating-current voltages in opposite phases are applied to the discharging electrodes at both the ends, the nonuniformity in the light amount can be minimized or eliminated. Therefore, the same actions and effects as those obtained by the light sources 1a and 1r according to the first and eighteenth preferred embodiments of the present invention can be obtained by the light source 1u according to the twenty first preferred embodiment of the present invention. Hence, the length in the axial length of the light guiding member is not limited specifically.

Next, alight source device 3f according to a sixth preferred embodiment of the present invention will be described. The light source device 3f according to the sixth preferred embodiment of the present invention includes the light sources 1s, 1t or 1u according to the nineteenth, twentieth or twenty first preferred embodiment of the present invention. Explanations of some components of the light source device 3f, which are common to components of the light source device 3a, are omitted, providing reference numerals same as the components of the light source device 3a to the corresponding components of the light source device 3f.

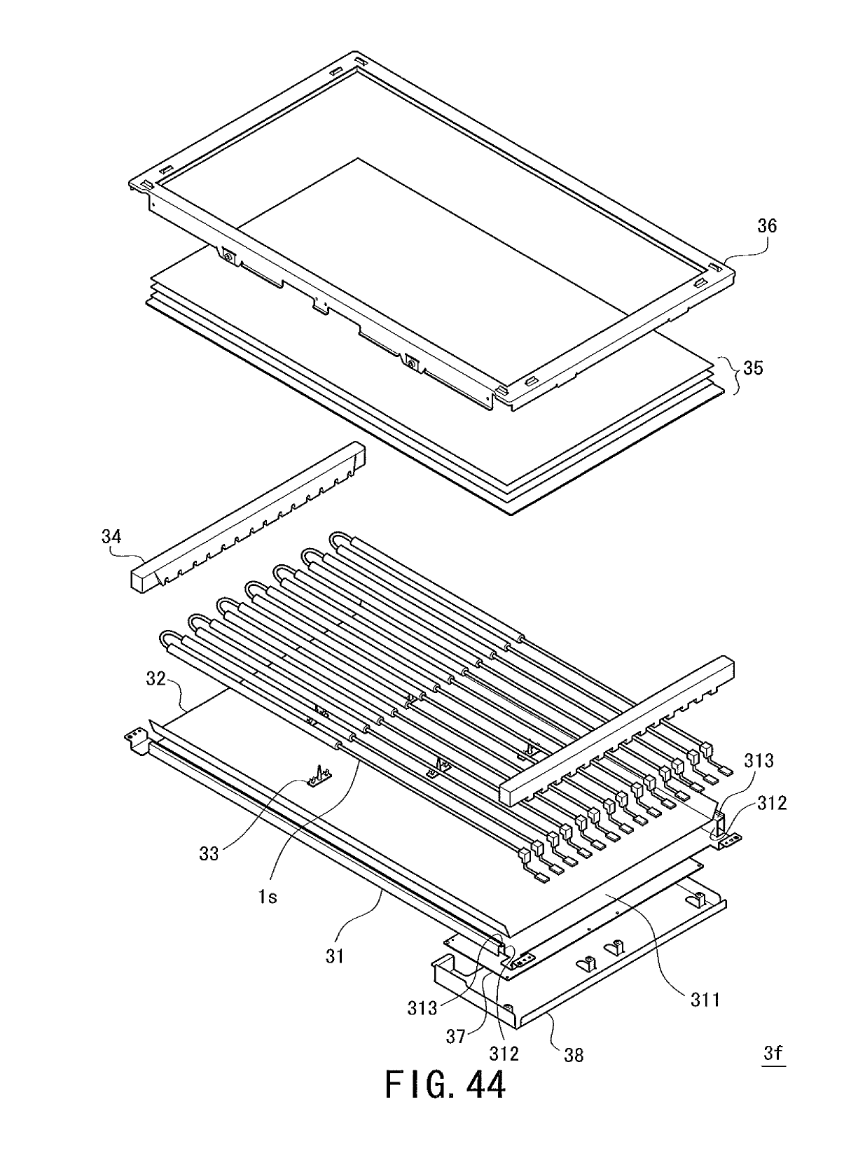

FIG. 44 is an exploded perspective view showing a schematic configuration of the light source device 3f according to the sixth preferred embodiment of the present invention. The light source device 3f according to the sixth preferred embodiment of the present invention includes a chassis 31, a reflection sheet 32, the light sources 1s, 1t or 1u according to the nineteenth, twentieth or twenty first preferred embodiment of the present invention (shown in FIG. 44 are the light sources 1s according to the nineteenth preferred embodiment of the present invention, for example), light source holders 33, side holders 34, optical sheets 35, a frame 36, a light source driving circuit board 37, and alight source driving circuit board cover 38. For the chassis 31, the reflection sheet 32, the light source holders 33, the side holders 34, the optical sheets 35, the frame 36, the light source driving circuit board 37, and the light source driving circuit board cover 38, the same components used in the light source device 3a according to the first preferred embodiment of the present invention are preferably used. The light source driving circuit board 37 is capable of generating alternating-current voltages in opposite phases.

The light source driving circuit board 37 is disposed behind the chassis 31. The light source driving circuit board cover 38 is disposed so as to protect the light source driving circuit board 37. The light source driving circuit board 37 is electrically connected to the discharging electrodes 221 of the light sources 1s, 1t or 1u according to the nineteenth, twentieth or twenty first preferred embodiment of the present invention. To be specific, the light source driving circuit board 37 is electrically connected to the discharging electrodes 221 such that alternating-current voltages in opposite phases are applied to the discharging electrodes at both the ends of the light sources 1s, 1t or 1u according to the nineteenth, twentieth or twenty first preferred embodiment of the present invention.

Consequently, the same action and effect as those obtained by the light source device 3a according to the first preferred embodiment of the present invention can be obtained by the light source device 3f according to the sixth preferred embodiment of the present invention.

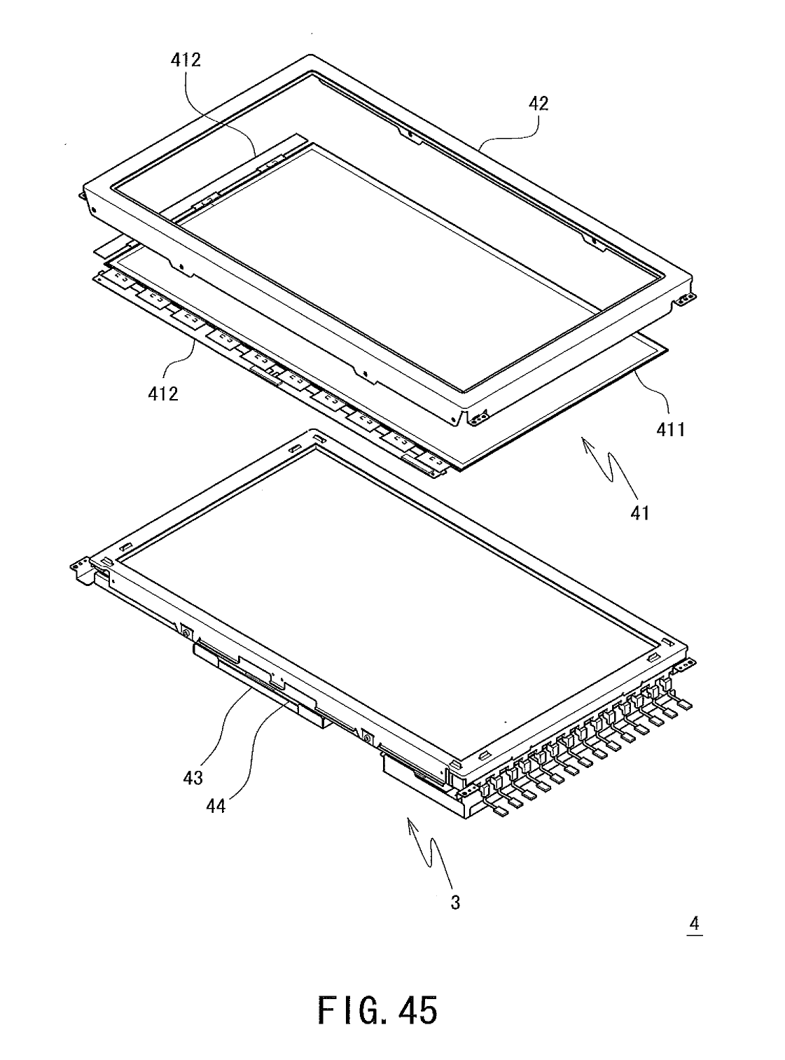

Next, a display device 4 according to a preferred embodiment of the present invention will be described. The display device 4 according to the preferred embodiment of the present invention includes the light source device 3 according to the preferred embodiment of the present invention (i.e., the light source device 3a, 3b, 3c, 3d, 3e or 3f according to one of the first to sixth preferred embodiments of the present invention that includes the light sources 1a, 1b, 1c, 1d, 1e, 1f, 1g, 1h, 1i, 1j, 1k, 1l, 1m, 1n, 1o, 1p, 1q, 1r, 1s, 1t or 1u according to one of the preferred embodiments of the present invention). FIG. 45 is an exploded perspective view showing a schematic configuration of the display device 4 according to the preferred embodiment of the present invention.

The display device 4 includes the light source device 3 according to the preferred embodiment of the present invention, a display panel assembly 41, a bezel 42, a control circuit board 43, and a control circuit board cover 44 as shown in FIG. 45.

The display panel assembly 41 includes a transmissive flat panel display 411, and circuit boards 412 that are attached to the panel display 411 and incorporate driver ICs (or driver SIs) arranged to drive the flat panel display 411. A variety of conventional transmissive or transflective liquid crystal display panels can be used for the flat panel display 411. A generally-used transmissive liquid crystal display panel includes a pair of substrates (e.g., a TFT array substrate and a color filter) that are opposed to each other having a given tiny space therebetween, in which liquid crystals are filled. When the back surface of the liquid crystal display panel is illuminated with the light the light source device emits, the emitted light passes through the liquid crystal display panel to reach the front surface thereof, whereby an image is displayed visible on the front surface of the liquid crystal display panel. Thus, the image display is performed using the light the light source device emits.

The bezel 42 is arranged to support and protect the display panel assembly 41. As shown in FIG. 45, the bezel 42 has a substantially square frame shape with an opening. The bezel 42 may be of a monolithic construction made of a resin material, may be of a multi-component assembled construction made of a resin material, may be of a monolithic construction made of a metal plate that is subjected to press working, or may be of a multi-component assembled construction made of a metal plate that is subjected to press working.

The control circuit board 43 incorporates electronic circuits and/or electric circuits for generating a control signal to drive the flat panel display 411 based on a signal inputted from the outside (e.g., a tuner). A variety of conventional control circuit boards can be used for the control circuit board 43. The control circuit board cover 44 has the shape of a plate, or a tray of low height to cover the control circuit board 43. The control circuit board cover 44 is arranged to protect the control circuit board 43, and prevent unnecessary radiation from the control circuit board 43. The control circuit board cover 44 is made from a conductor such as metal.

Next, a description of assembly of the display device 4 according to the preferred embodiment of the present invention will be provided.

The display panel assembly 41 is disposed in front of the light source device 3 according to the preferred embodiment of the present invention. To be specific, the flat panel display 411 is placed in front of the frame 36, and the circuit boards 412 attached to the flat panel display 411 are disposed on the front surface or the lateral surfaces of the frame 36.

Then, the bezel 42 is attached to the front surfaces of the display panel assembly 41 and the light source device 3, whereby the border portion of the flat panel display 411 is sandwiched between the frame 36 and the bezel 42. Thus, the display panel assembly 41 is held in the display device 4.

The control circuit board 43 is disposed behind the chassis 31 of the light source device 3 according to the preferred embodiment of the present invention. The control circuit board cover 44 is disposed so as to cover the control circuit board 43.

With this configuration, an image is displayed visible on the front surface of the flat panel display 411 by the light the light source device 3 emits. Thus, the light source device 3 according to the preferred embodiment of the present invention is capable of emitting light of which intensity distribution in a plane direction is uniform, which can prevent or minimize luminance unevenness produced in an image the flat panel display 411 displays. Therefore, the display device 4 according to the preferred embodiment of the present invention is capable of performing high-definition image display.

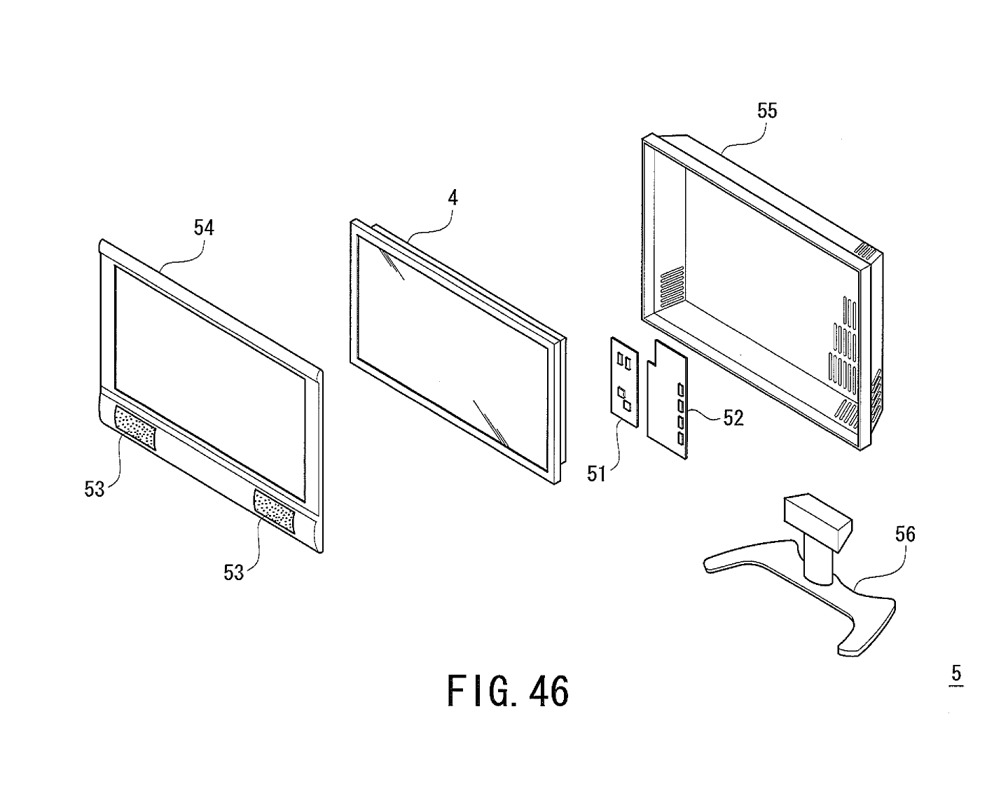

Next, a brief description of a television receiver 5 according to a preferred embodiment of the present invention including the display device 4 according to the preferred embodiment of the present invention will be provided. FIG. 46 is an exploded perspective view showing a schematic configuration of the television receiver 5 according to the preferred embodiment of the present invention including the display device 4 according to the preferred embodiment of the present invention. The television receiver 5 includes the display device 4 according to the preferred embodiment of the present invention, an electric power supply 51, a tuner 52, loudspeaker units 53, a front side cabinet 54, a back side cabinet 55, and a supporting member 56, as shown in FIG. 46.

The electric power supply 51 is arranged to supply electric power to the display device 4 according to the preferred embodiment of the present invention, the tuner 52 and other components. A variety of conventional electric power supplies can be used for the electric power supply 51.

The tuner 52 is arranged to produce an image signal and a sound signal of a given channel based on a received radio wave and a signal inputted from the outside. A conventional terrestrial tuner (analog and/or digital), a BS tuner and a CS tuner may be used for the tuner 52.

The display device 4 according to the preferred embodiment of the present invention is arranged to display an image based on the image signal of the given channel produced by the tuner 52. The loudspeaker units 53 are arranged to produce a sound based on the sound signal produced by the tuner 52. A variety of conventional loudspeaker units such as generally-used speakers may be used for the loudspeaker units 53.

The display device 4 according to the preferred embodiment of the present invention, the electric power supply 51, the tuner 52 and the loudspeaker units 53 are housed between the front side cabinet 54 and the back side cabinet 55, which is supported by the supporting member 56. The television receiver 5 including the display device 4 is not limited to this configuration, and may have a variety of other configurations.

### INDUSTRIAL APPLICABILITY

The foregoing descriptions of the preferred embodiments of the present invention have been presented for purposes of illustration and description with reference to the drawings. However, it is not intended to limit the present invention to the preferred embodiments, and modifications and variations are possible as long as they do not deviate from the principles of the present invention.

For example, shown in the preferred embodiments of the present invention are those configurations that the fluorescent lamps are used as the discharge lamps; however, other kinds of discharge lamps can be used. In addition, shown are the light guiding members having the substantially round or oval shape in cross section; however, the light guiding members may have other shapes such as ellipse. In addition, the lengths of the light guiding members should not be limited specifically. It is essential that the light guiding members have a length such that the light guiding members be attached to the section of which the light amount is to be completed.

1-39. (canceled)

40. A light source that comprises:
a discharge lamp comprising:
a tube body having one of a substantially linear shape and a substantially U shape; and
discharging electrodes disposed at both ends in an axial direction of the tube body; and
a light guiding member that has a substantially transparent color, a length in an axial direction that is substantially same or shorter than a length in the axial direction of the tube body of the discharge lamp, and a linear shape,
wherein the light guiding member is attached on an outer surface of the tube body of the discharge lamp any one of
at a section closer to one end in the axial direction of the tube body of the discharge lamp,
throughout the substantial length of the tube body of the discharge lamp, and
at a center section in the axial direction of the tube body of the discharge lamp.

41. The light source according to claim 40, wherein the light guiding member has one of a substantially round shape in cross section and a substantially oval shape in cross section, and comprises a through-hole inside along the axial direction, wherein the light guiding member is attached on the outer surface of the tube body of the discharge lamp such that the tube body of the discharge lamp is inserted in the through-hole of the light guiding member.

42. The light source according to claim 40, wherein the light guiding member has one of a substantially round shape in cross section and a substantially oval shape in cross section, and comprises a groove on its lateral side along the axial direction, wherein the light guiding member is attached on the outer surface of the tube body of the discharge lamp such that the tube body of the discharge lamp is inserted in the groove of the light guiding member.

43. The light source according to claim 40, wherein the light guiding member has a tapered shape such that surface areas per unit length of the light guiding member become larger by degrees from one end in the axial direction to the other end, wherein the light guiding member is attached on the outer surface of the tube body of the discharge lamp such that the end of the light guiding member that has the larger surface area per unit length is disposed close to the discharging electrode disposed at the one end of the discharge lamp.

44. The light source according to claim 40, wherein the length in the axial direction of the light guiding member is substantially half the length in the axial direction of the tube body of the discharge lamp, wherein the light guiding member is attached on the outer surface at a section from the one end of the tube body of the discharge lamp to a substantial center in the axial direction of the tube body of the discharge lamp.

45. The light source according to claim 40, wherein the discharge lamp comprises a fluorescent lamp.

46. A light source that comprises:
two discharge lamps, each of which comprises:
a tube body having a substantially linear shape; and
discharging electrodes disposed at both ends in an axial direction of each tube body; and
two light guiding members, each of which has a substantially transparent color, a length in an axial direction that is substantially same or shorter than a length in the axial direction of the tube body of each discharge lamp, and a linear shape, wherein the discharging electrodes at one ends of the two discharge lamps are electrically connected to each other, wherein the light guiding members are attached on outer surfaces of the tube bodies of the discharge lamps any one of
at sections closer to the electrically-connected discharging electrodes at the one ends of the tube bodies of the discharge lamps, and
throughout the substantial lengths of the tube bodies of the discharge lamps.

47. The light source according to claim 46, wherein each of the light guiding members has one of a substantially round shape in cross section and a substantially oval shape in cross section, and comprises a through-hole inside along the axial direction, wherein the light guiding members are attached on the outer surfaces of the tube bodies of the discharge lamps such that the tube bodies of the discharge lamps are inserted in the through-holes of the light guiding members.

48. The light source according to claim 46, wherein each of the light guiding members has one of a substantially round shape in cross section and a substantially oval shape in cross section, and comprises a groove on its lateral side along the axial direction, wherein the light guiding members are attached on the outer surfaces of the tube bodies of the discharge lamps such that the tube bodies of the discharge lamps are inserted in the grooves of the light guiding members.

49. The light source according to claim 46, wherein each of the light guiding members has a tapered shape such that surface areas per unit length of each light guiding member become larger by degrees from one end in the axial direction to the other end, wherein the light guiding members are attached on the outer surfaces of the tube bodies of the discharge lamps such that the ends of the light guiding members that have the larger surface areas per unit length are disposed close to the electrically-connected discharging electrodes.

50. The light source according to claim 46, wherein the length in the axial direction of each of the light guiding members is substantially half the length in the axial direction of each of the tube bodies of the discharge lamps, wherein the light guiding members are attached on the outer surfaces at sections from the one ends of the tube bodies of the discharge lamps where the discharging electrodes are electrically connected to each other to substantial centers in the axial directions of the tube bodies of the discharge lamps.

51. The light source according to claim 46, wherein the discharge lamps comprise fluorescent lamps.

52. A light source that comprises:
a discharge lamp comprising:
a tube body having a substantially U shape; and
discharging electrodes disposed at both ends in an axial direction of the tube body; and
two light guiding members, each of which has a substantially transparent color, a length in an axial direction that is half or less than half a length in the axial direction of the tube body of the discharge lamp, and a linear shape,
wherein the light guiding members are attached on an outer surface of the tube body of the discharge lamp at sections closer to a substantially U-shaped section of the tube body of the discharge lamp.

53. The light source according to claim 52, wherein each of the light guiding members has one of a substantially round shape in cross section and a substantially oval shape in cross section, and comprises a through-hole inside along the axial direction, wherein the light guiding members are attached on the outer surface of the tube body of the discharge lamp such that the tube body of the discharge lamp is inserted in the through-holes of the light guiding members.

54. The light source according to claim 52, wherein each of the light guiding members has one of a substantially round shape in cross section and a substantially oval shape in cross section, and comprises a groove on its lateral side along the axial direction, wherein the light guiding members are attached on the outer surface of the tube body of the discharge lamp such that the tube body of the discharge lamp is inserted in the grooves of the light guiding members.

55. The light source according to claim 52, wherein each of the light guiding members has a tapered shape such that surface areas per unit length of each light guiding member become larger by degrees from one end in the axial direction to the other end, wherein the light guiding members are attached to the tube body of the discharge lamp such that the ends of the light guiding members that have the larger surface areas per unit length are disposed close to the substantially U-shaped section of the tube body of the discharge lamp.

56. The light source according to claim 55, wherein the length in the axial direction of each of the light guiding members is substantially half the length in the axial direction of the tube body of the discharge lamp, wherein the light guiding members are attached on the outer surface at sections from the ends of the tube body of the discharge lamp to the substantially U-shaped section of the tube body of the discharge lamp.

57. The light source according to claim 52, wherein the discharge lamp comprises a fluorescent lamp.
